(19) United States
(12) Patent Application Publication
(10) Pub. No.: US 2026/0280792 A1
(43) Pub. Date: Sep. 17, 2026

(54) Downlink Control Channel Monitoring

(71) Applicant: Ofinno, LLC, Reston, VA (US)

(72) Inventors: Ali Cagatay Cirik, Chantilly, VA (US); Hua Zhou, Vienna, VA (US); Esmael Hejazi Dinan, McLean, VA (US); Hyoungsuk Jeon, Centreville, VA (US); Gautham Prasad, Herndon, VA (US); Mohammad Ghadir Khoshkholgh Dashtaki, Reston, VA (US)

(73) Assignee: Ofinno, LLC, Reston, VA (US)

(21) Appl. No.: 19/670,805

(22) Filed: May 7, 2026

Related U.S. Application Data
(63) Continuation of application No. PCT/US2024/058901, filed on Dec. 6, 2024.
(60) Provisional application No. 63/607,187, filed on Dec. 7, 2023.

(51) Int. Cl. H04L 5/00; H04B 7/06; H04L 1/00

(52) U.S. Cl. CPC H04L 5/0044; H04B 7/0626; H04L 1/0061

(57) ABSTRACT

A wireless device monitors physical downlink control channel (PDCCH) candidates, of a search space set with a search space identifier set to zero, at monitoring occasions associated with a first reference signal. The first reference signal is determined based on a downlink control information (DCI) indicating a transmission configuration indication (TCI) state for a control resource set (coreset) with index zero. The TCI state indicates a second reference signal that is quasi co-located with the first reference signal.

### CROSS-REFERENCE TO RELATED APPLICATIONS

This application is a continuation of International Application No. PCT/US2024/058901, filed Dec. 6, 2024, which claims the benefit of U.S. Provisional Application No. 63/607,187, filed Dec. 7, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an example of LTM procedure as per an aspect of an embodiment of the present disclosure.

FIG. 18 illustrates an example of downlink control channel monitoring as per an aspect of an embodiment of the present disclosure.

FIG. 19 illustrates an example flow chart of downlink control channel monitoring as per an aspect of an embodiment of the present disclosure.

FIG. 20 illustrates an example of timing advance as per an aspect of an embodiment of the present disclosure.

FIG. 21 illustrates an example flow chart of timing advance as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect or implement the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

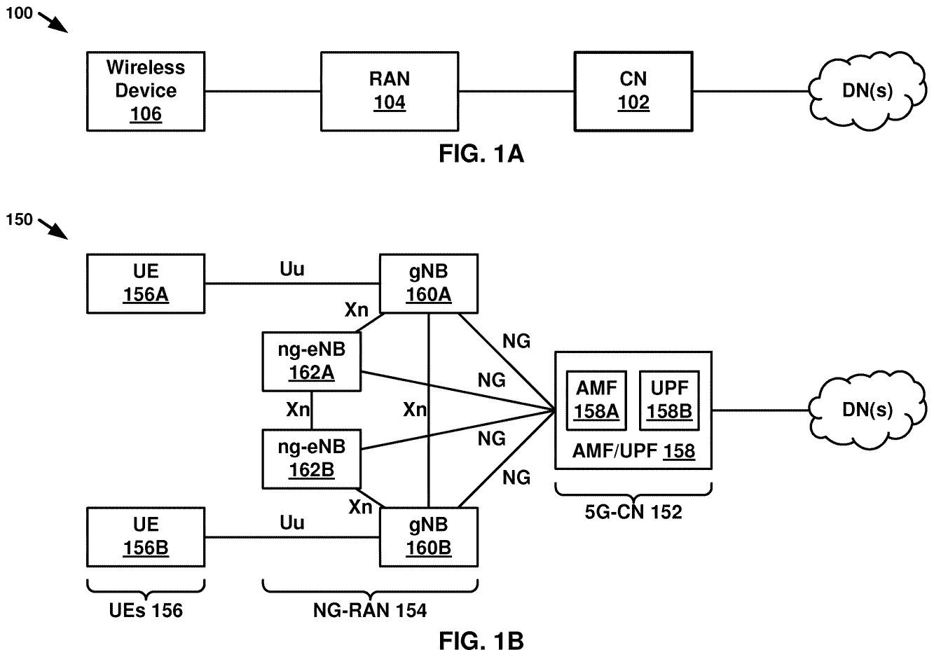

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNS, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

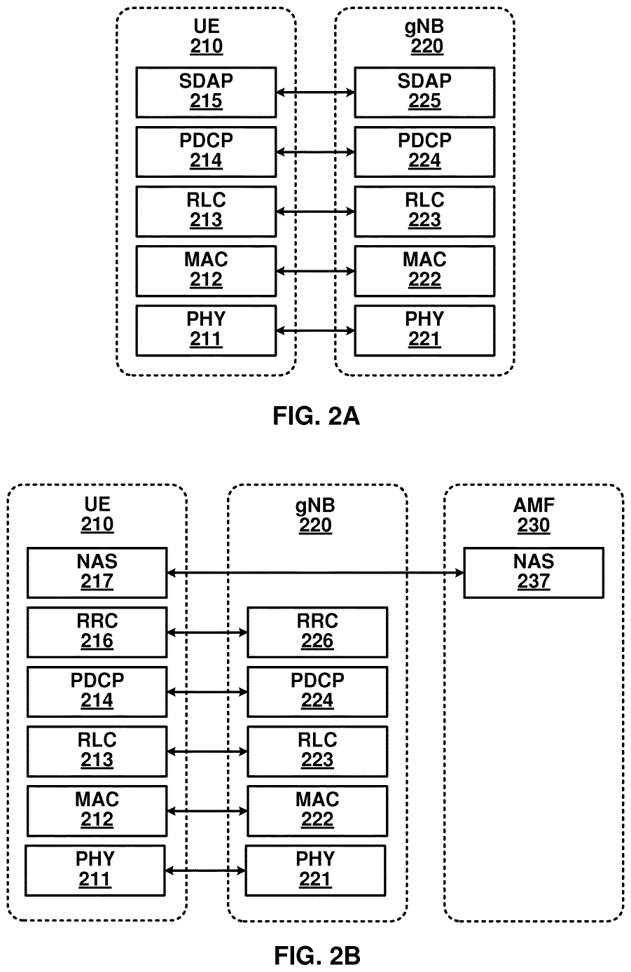

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

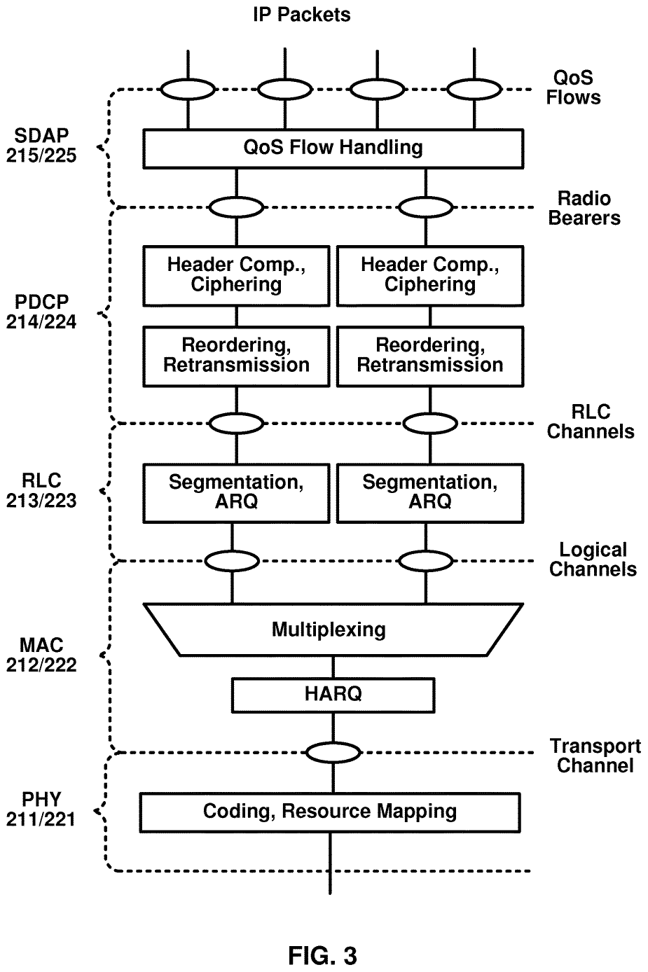

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYS 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

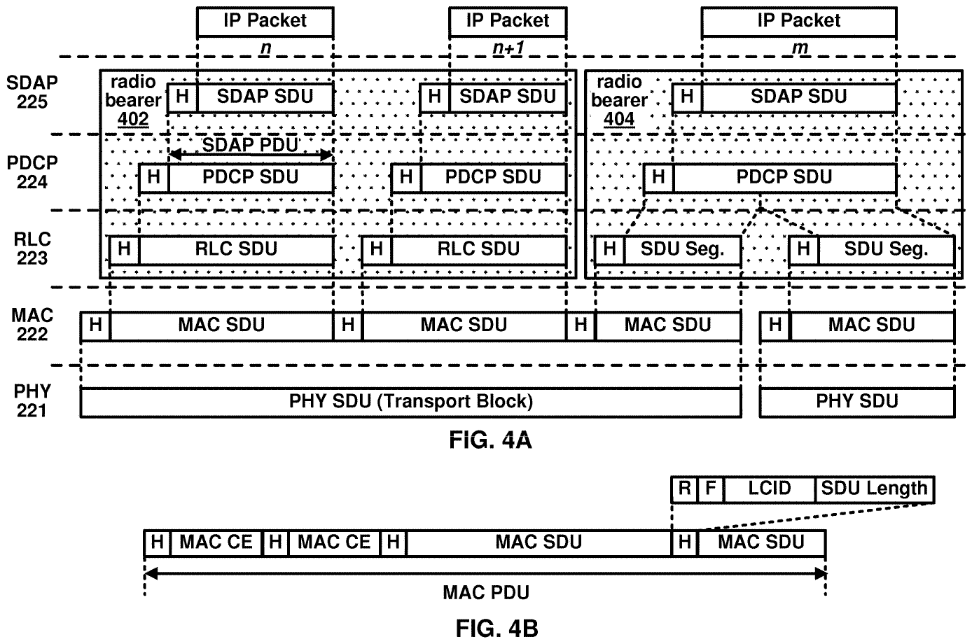

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

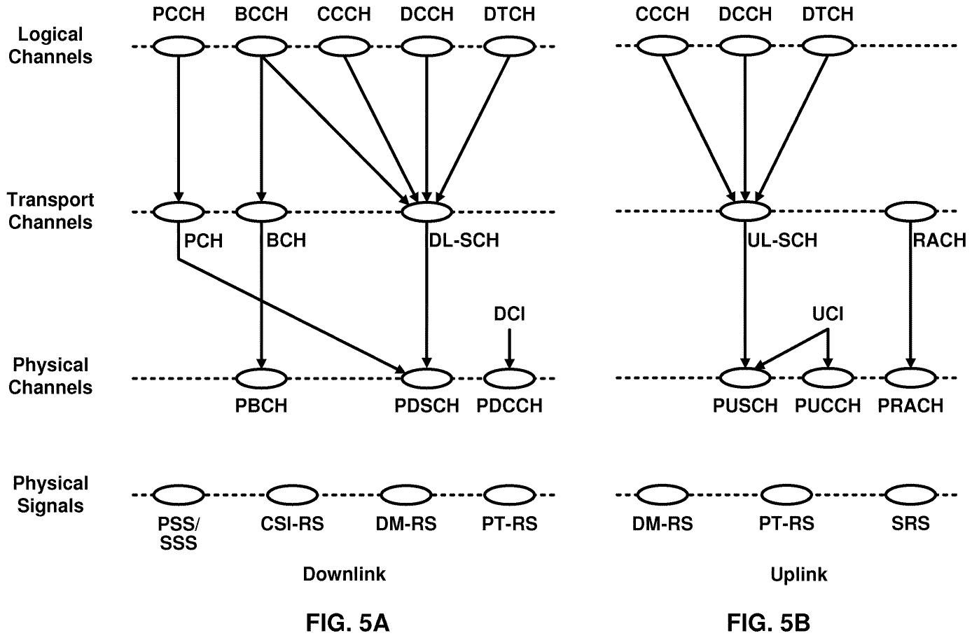

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

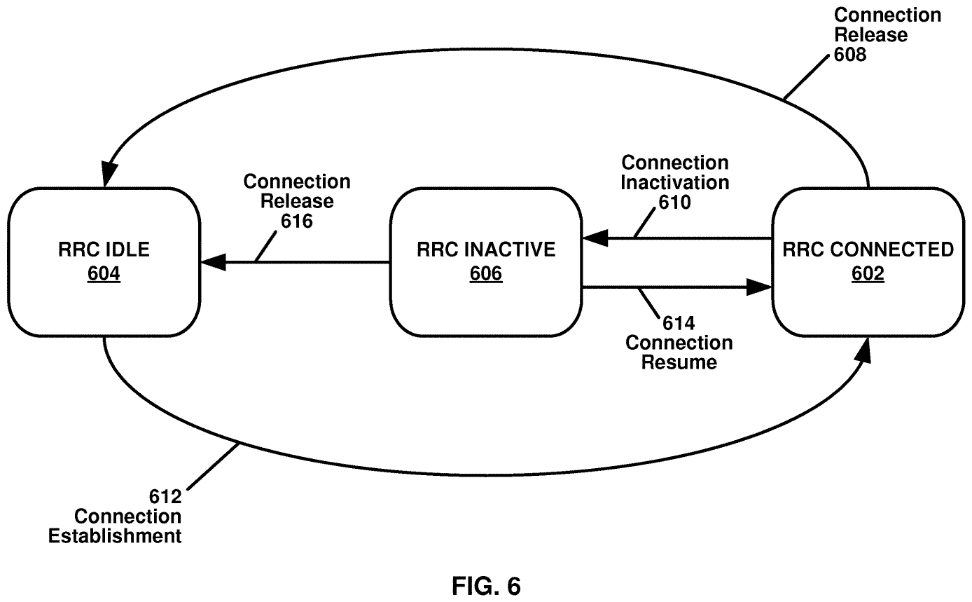

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

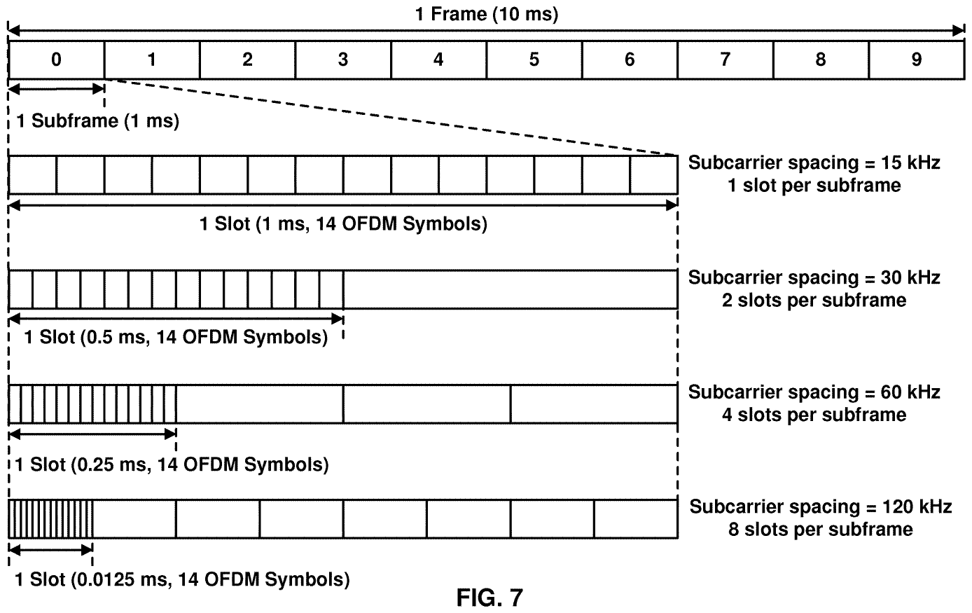

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 KHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 KHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

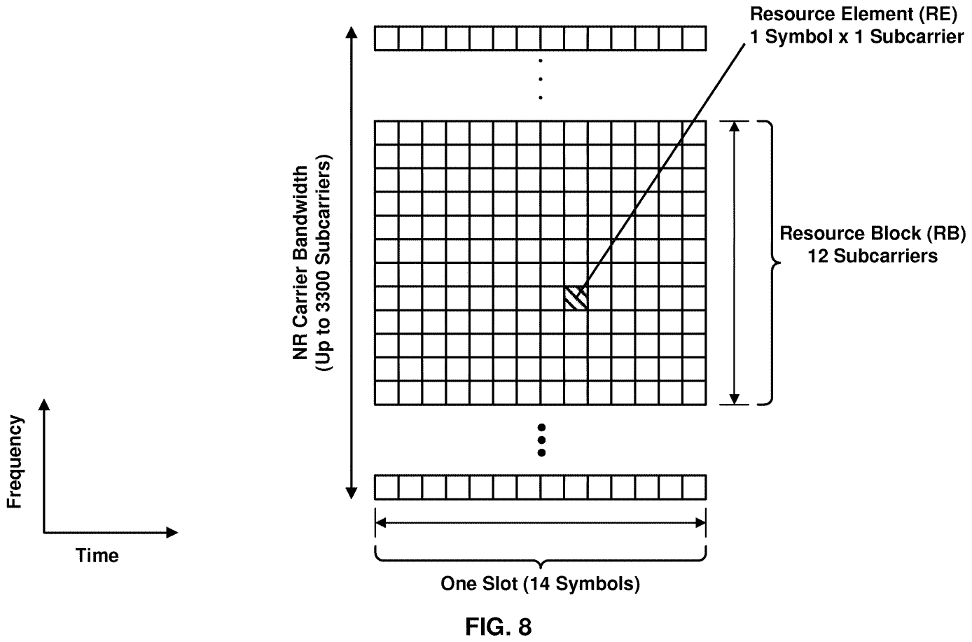

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

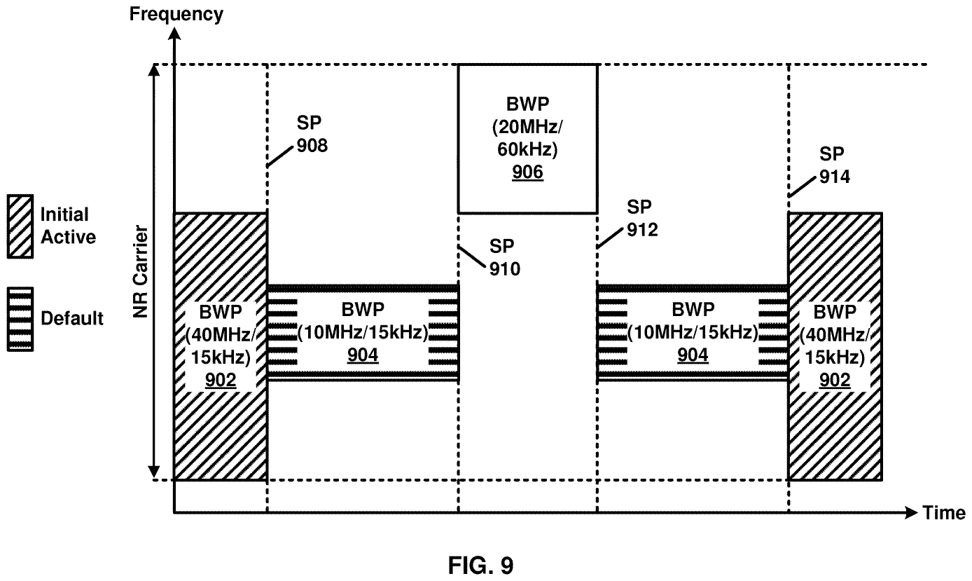

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

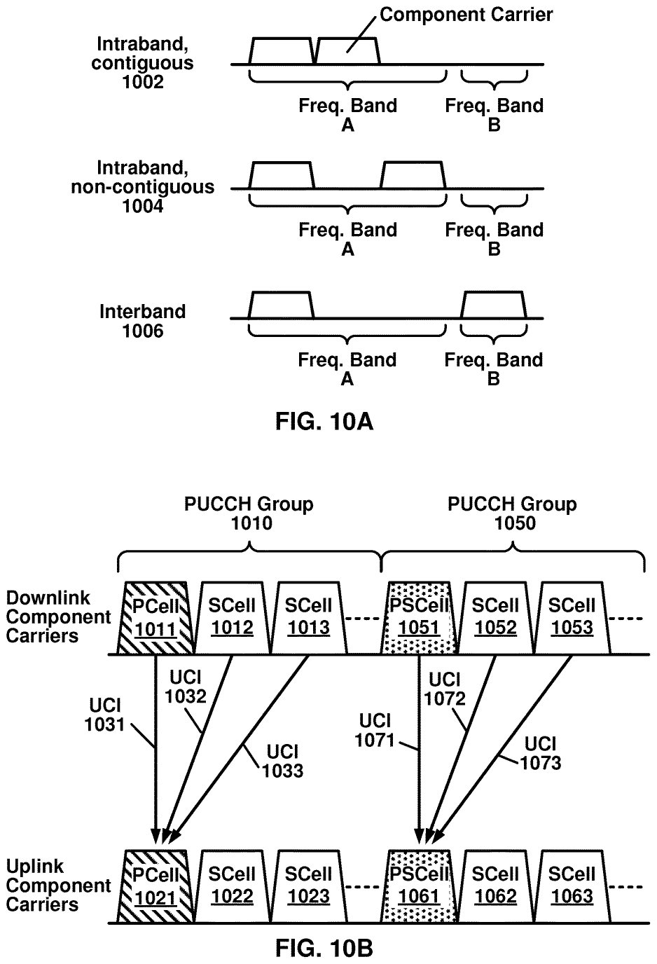

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the u plink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

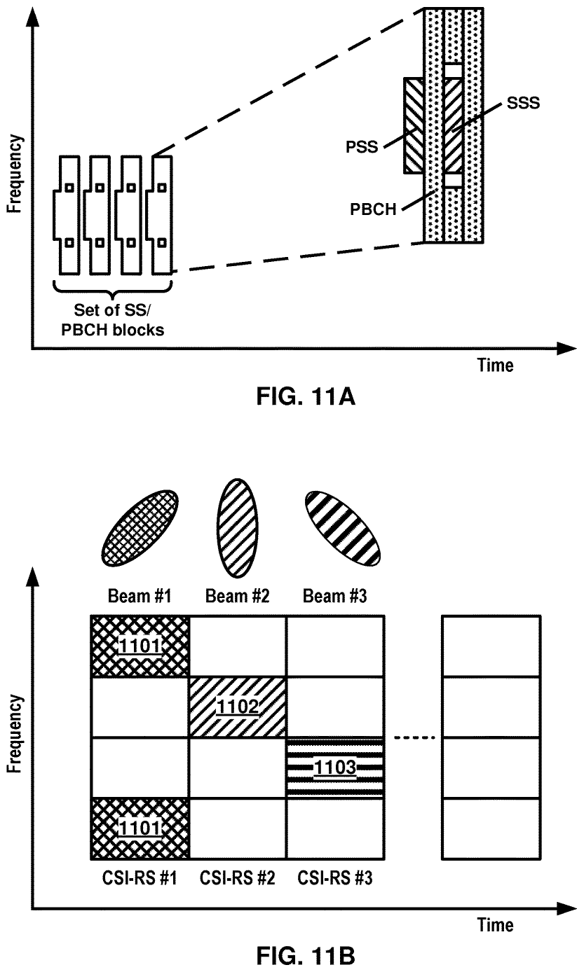

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals.

For example, a beam may be identified by one or more beamformed reference signals. The UE may perform downlink beam measurement based on downlink reference signals (e.g., a channel state information reference signal (CSI-RS) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

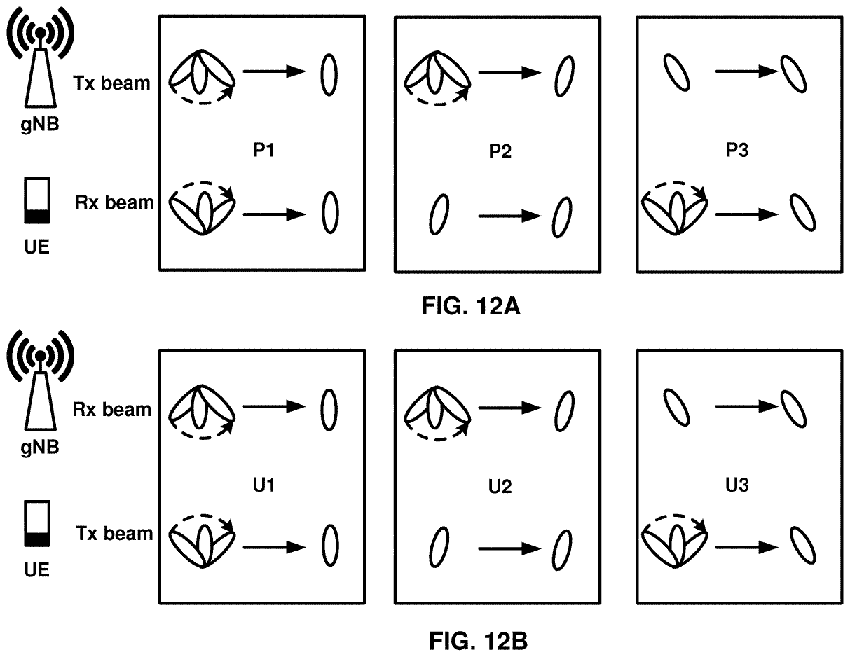

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

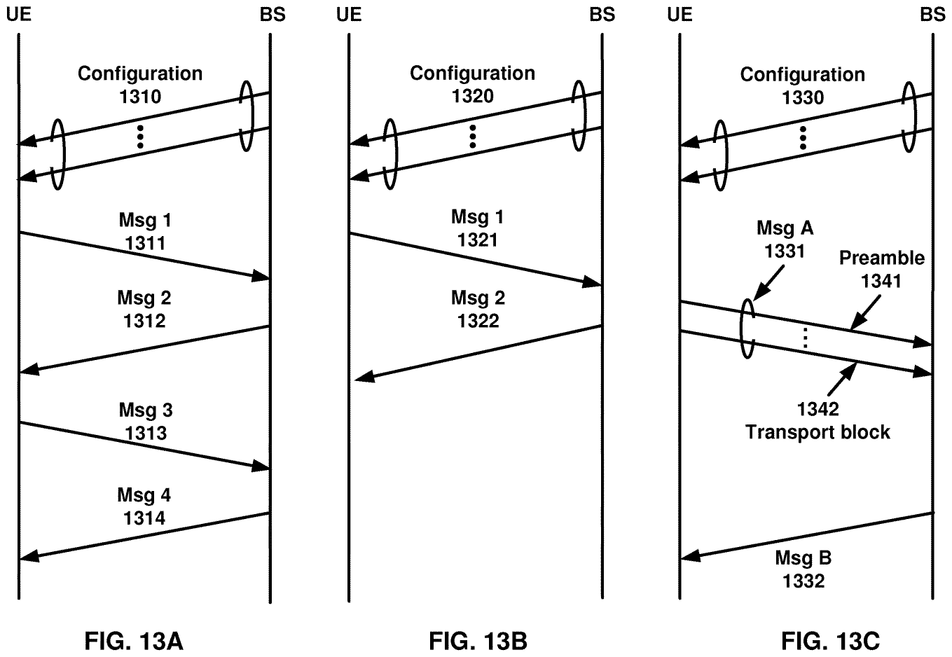

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

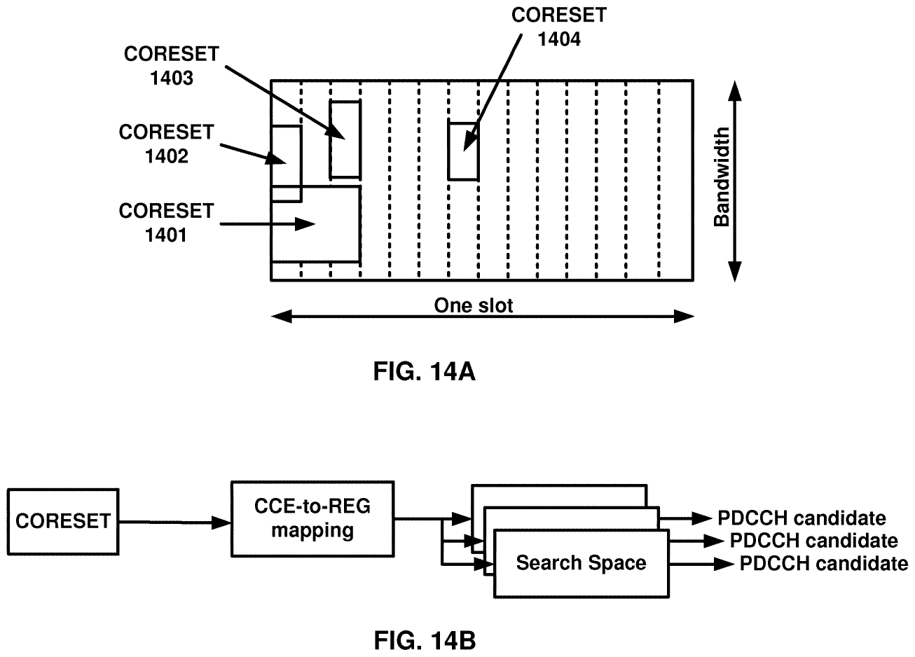

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

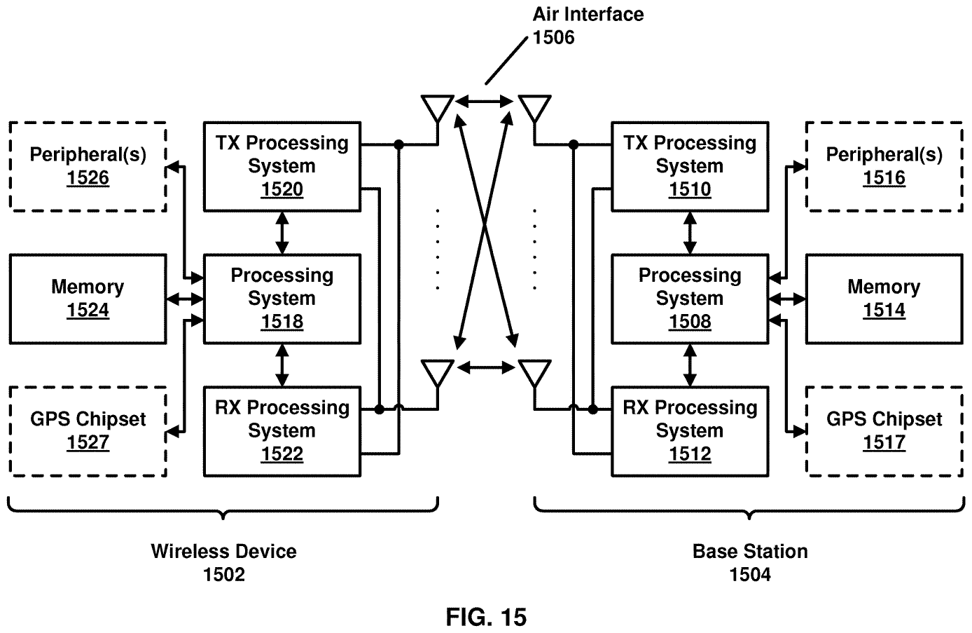

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 maybe associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

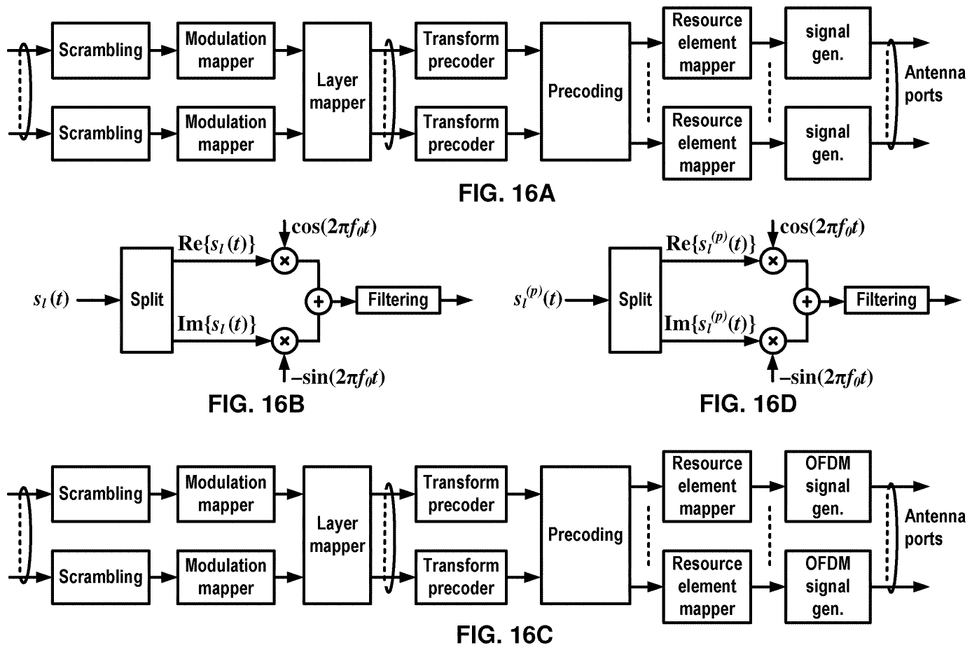

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry (or expiration) of a random access response window timer, the time difference between two time stamps may be used. When a timer is restarted, a process for measurement of time window may be restarted. Other example implementations may be provided to restart a measurement of a time window.

A wireless device may receive one or more messages comprising one or more configuration parameters for a cell. The one or more configuration parameters may indicate a plurality of TCI states (e.g., unified/common/joint TCI states).

The one or more configuration parameters may indicate a search space set with a search space set identifier equal to zero.

The one or more configuration parameters may indicate, for the search space set, a coreset. The coreset and the search space set may be associated (linked/mapped).

The one or more configuration parameters may indicate, for the coreset, a coreset index that is equal to zero.

The wireless device may receive a MAC-CE indicating activation of a TCI state for the coreset. The plurality of TCI states may comprise the TCI state.

The TCI state may comprise/indicate a first reference signal (e.g., CSI-RS) that is quasi co-located with a second reference signal (e.g., SS/PBCH block). In the existing technologies, the wireless device may determine monitoring occasions (e.g., resource blocks, symbols, and the like) of the search space set based on (or using) the second reference signal associated with the TCI state that is indicated by the MAC-CE for the coreset.

In an example, the wireless device may receive an activation command (e.g., DCI, MAC-CE) indicating activation of a subset of TCI states of the plurality of TCI states. The wireless device may receive a DCI indicating a TCI state among the subset of TCI states. The wireless device may apply the TCI state indicated by the DCI to the coreset. The wireless device may apply the TCI state indicated by the DCI to the coreset, for example, based on the one or more configuration parameters comprising a higher layer parameter followUnifiedTCI-State for the coreset. The wireless device may apply the TCI state indicated by the DCI to the coreset, for example, based on the one or more configuration parameters comprising a higher layer parameter apply-IndicatedTCIState set to ‘first’ or ‘second’ for the coreset. The wireless device may apply the TCI state indicated by the DCI to the coreset, for example, based on the one or more configuration parameters comprising a higher layer parameter apply-IndicatedTCIState not set to ‘none’ for the coreset.

In an example, the wireless device may receive a cell switch command (e.g., cell switch command, LTM Cell Switch Command MAC CE) indicating a TCI state for the cell (e.g., a target/candidate/LTM cell). The wireless device may apply the TCI state indicated by the cell switch command to the coreset. The wireless device may apply the TCI state indicated by the cell switch command to the coreset, for example, based on the one or more configuration parameters comprising a higher layer parameter followUnifiedTCI-State for the coreset. The wireless device may apply the TCI state indicated by the cell switch command to the coreset, for example, based on the one or more configuration parameters comprising a higher layer parameter apply-IndicatedTCIState set to ‘first’ or ‘second’ for the coreset. The wireless device may apply the TCI state indicated by the cell switch command to the coreset, for example, based on the one or more configuration parameters comprising a higher layer parameter apply-IndicatedTCIState not set to ‘none’ for the coreset.

The TCI state may comprise/indicate a first reference signal (e.g., CSI-RS) that is quasi co-located with a second reference signal (e.g., SS/PBCH block). In the implementation of the existing technologies, the wireless device may not determine monitoring occasions (e.g., resource blocks, symbols, and the like) of the search space set based on (or using) the second reference signal associated with the TCI state that is indicated by the DCI or the cell switch command. The wireless device may determine monitoring occasions (e.g., resource blocks, symbols, and the like) of the search space set based on (or using) the second reference signal associated with the TCI state that is indicated by the MAC-CE for the coreset. Not determining the monitoring occasions of the search space set based on (or using) the second reference signal associated with the TCI state that is indicated by the DCI or the cell switch command may not be efficient. The base station may transmit the DCI or the cell switch command indicating the TCI state, for example, when the TCI state indicates an optimal transmitting/receiving beam. Not using the TCI state indicated by the DCI or the cell switch command to determine the monitoring occasions may not be efficient leading to reduced data rate and increased error rates.

Example embodiments enhance monitoring occasion determination of the search space set when the wireless device receives the DCI or the cell switch command indicating the TCI state for the coreset.

In an example embodiment, the wireless device may determine monitoring occasions (e.g., resource blocks, symbols, and the like) of the search space set based on (or using) the second reference signal associated with the TCI state that is indicated by the DCI or the cell switch command. This may improve the performance, leading to increased data rate and reduced error rates.

In an example, the one or more configuration parameters may indicate two TAGs for the cell. The two TAGS comprise a first TAG and a second TAG.

In an example, the wireless device may receive a control command (e.g., DCI, MAC-CE) indicating at least two TCI states among/from the plurality of TCI states. The at least two TCI states may comprise a first TCI state and a second TCI state. The first TCI state may be associated with the first TAG. The second TCI state may be associated with the second TAG.

After receiving the one or more configuration parameters indicating the plurality of TCI states and before application of the at least two TCI states among/from the plurality of TCI states, the wireless device may transmit uplink signals (e.g., PUSCH/PUCCH/SRS) using a timing advance value. In the existing technologies, the wireless device may apply the timing advance value used for a Msg3/PUSCH transmission of a random-access procedure (e.g., initial access procedure or reconfiguration with synch procedure).

This may not be efficient when the random-access procedure is a two-step random-access procedure that may not comprise a Msg3/PUSCH transmission. The wireless device may not determine a timing advance value for the uplink signals (e.g., PUSCH/PUCCH/SRS) if the wireless device does not perform a Msg3/PUSCH transmission for the random-access procedure. This may lead to increased interference resulting in reduced data rates.

This may not be efficient for a PUSCH transmission in an RRC inactive state (e.g., for small data transmission) that may not comprise a Msg3/PUSCH transmission. The wireless device may not determine a timing advance value for the uplink signals (e.g., PUSCH/PUCCH/SRS) if the wireless device does not perform a Msg3/PUSCH transmission. This may lead to increased interference resulting in reduced data rates. The wireless device may transmit/perform the PUSCH transmission for a configured uplink grant.

The example embodiments enhance timing advance value determination when there is no Msg3 PUSCH transmission, e.g., for two-step random-access procedures and for a PUSCH transmission in the RRC inactive state.

In an example embodiment, for two-step random-access procedures, after receiving the one or more configuration parameters indicating the plurality of TCI states and before application of the at least two TCI states among/from the plurality of TCI states, the wireless device may transmit uplink signals (e.g., PUSCH/PUCCH/SRS) using a timing advance value determined based on an absolute timing advance command MAC CE.

In an example embodiment, for small-data transmission, after receiving the one or more configuration parameters indicating the plurality of TCI states and before application of the at least two TCI states among/from the plurality of TCI states, the wireless device may transmit uplink signals (e.g., PUSCH/PUCCH/SRS) using a timing advance value used for the PUSCH transmission in the RRC inactive state.

The example embodiments may lead to reduced interference resulting in increased data rates.

A wireless device may be configured with a list of TCI states (e.g., TCI-State) within/by a higher layer parameter PDSCH-Config to decode PDSCH according to a detected PDCCH with DCI intended for the wireless device and a given cell (e.g., a given serving cell, a given non-serving/candidate/target cell). A number of TCI states in the list may depend on a UE capability parameter maxNumberConfiguredTCIstatesPerCC. Each TCI state (e.g., TCI-State) may contain/comprise/include/indicate/have respective parameters for configuring a quasi co-location relationship between one or two downlink reference signals and DM-RS port(s) of a PDSCH, a DM-RS port of a PDCCH, or CSI-RS port(s) of a CSI-RS resource. The quasi co-location relationship may be configured by a higher layer parameter qcl-Type1 for a first downlink reference signal of the one or more downlink reference signals. The quasi co-location relationship may be configured by a higher layer parameter qcl-Type2 for a second downlink reference signal of the one or more downlink reference signals. When two downlink reference signals comprising a first downlink reference signal and a second downlink reference signal are indicated by a TCI state, QCL types of the two downlink reference signals may not be the same, regardless of whether the first downlink reference signal and the second downlink reference signal are the same or different. A quasi co-location type corresponding to a downlink reference signal of the one or more downlink reference signals may be given by a higher layer parameter qcl-Type in a higher layer parameter QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

A wireless device may be configured with a list of TCI states (e.g., up to 128 TCI-State configurations) within/by a higher layer parameter di-OrJointTCI-StateList in PDSCH-Config. A TCI state in the list of TCI states may provide/indicate a reference signal for a quasi co-location for i) DM-RS of a PDSCH, ii) DM-RS of a PDCCH in a BWP/cell, and/or iii) a CSI-RS. A TCI state in the list of TCI states may provide/indicate a reference signals for determining uplink transmission spatial filter for i) a dynamic-grant PUSCH, ii) a configured-grant based PUSCH, iii) a PUCCH resource in a BWP/cell, and/or, iv) an SRS.

A wireless device may receive an activation command (e.g., MAC-CE, DCI) used to map up to a number TCI states and/or pairs of TCI states (e.g., up to 8 TCI states and/or pairs of TCI states), with one TCI state for downlink channels/signals and/or one TCI state for uplink channels/signals, to codepoint(s) of a DCI field ‘Transmission Configuration Indication’ for one cell or for a set of cells/downlink BWPs, and/or up to a number of sets of TCI states (e.g., up to 8 sets of TCI states). Each set of the number of sets may be comprised of up to a number of TCI state(s) for downlink and uplink signals/channels (e.g., up to two TCI state(s), or up to a number of TCI state(s) (e.g., up to two TCI state(s) for downlink channels/signals and up to a number of TCI state(s) (e.g., up to two TCI state(s) for uplink channels/signals to codepoint(s) of a DCI field ‘Transmission Configuration Indication’ for one cell or for a set of cells/downlink BWPs, and if applicable, for one cell or for a set of cells/uplink BWPs. When a set of TCI state IDs are activated, by the activation command, for a set of cells/downlink BWPs and if applicable, for a set of cells/uplink BWPs, where the applicable list of cells may be determined, by the wireless device, by an indicated cell in the activation command, the (same) set of TCI state IDs may be applied by the wireless device to/for all downlink and/or uplink BWPs in the indicated cells (or the applicable list of cells). If the activation command maps TCI-State(s) and/or TCI-UL-State(s) to only one (or to a single) TCI codepoint, the wireless device may apply the (indicated) TCI-State(s) and/or TCI-UL-State(s) to one cell or to a set of cells/downlink BWPs, and if applicable, to one cell or to a set of cells/uplink BWPs once the indicated mapping for the one single TCI codepoint is applied by the wireless device.

When tci-PresentInDCI is set as ‘enabled’ or tci-PresentDCI-1-2 is configured for a CORESET, a wireless device 1) configured with di-OrJointTCI-StateList by one or more configuration parameters (e.g., RRC messages/parameters) and activated with TCI-State by the activation command, or 2) configured with ul-TCI-StateList by one or more configuration parameters (e.g., RRC messages/parameters) and activated with TCI-UL-State by the activation command may receive a DCI format (e.g., DCI format 1_1/1_2) providing/indicating TCI state(s) (e.g., TCI-State(s) and/or TCI-UL-State(s) for a cell or all cells in the same cell list configured by a simultaneous TCI update parameter (e.g., simultaneousU-TCI-UpdateList1, simultaneousU-TCI-UpdateList2, simultaneousU-TCI-UpdateList3, simultaneousU-TCI-UpdateList4). The DCI format may be with or without a downlink assignment. The simultaneous TCI update parameter may be a higher layer parameter (e.g., RRC parameter).

When a wireless device configured with di-OrJointTCI-StateList by one or more configuration parameters (e.g., RRC messages/parameters) transmits an uplink transmission (e.g., a PUCCH transmission, a PUSCH transmission) with a positive HARQ-ACK corresponding to the DCI format indicating the indicated TCI state(s) (e.g., TCI-State(s) and/or TCI-UL-State(s), and if the indicated TCI State(s) is/are different from the previously indicated TCI state(s), the indicated TCI-State(s) may be applied, by the wireless device, starting from a first/starting/earliest slot that is at least a number of symbols (e.g., beamAppTime symbols) after the last symbol of the uplink transmission. The first/starting/earliest slot and the number of symbols may be both determined, by the wireless device, based on an active BWP with the smallest subcarrier spacing among BWP(s) of the cells applying the indicated TCI-State(s) that are active at the end of the uplink transmission carrying/with the positive HARQ-ACK. The number of symbols may be indicated/provided to the wireless device by RRC messages (e.g., one or more configuration parameters).

When a wireless device is configured/indicated, by a base station, with a higher layer parameter di-OrJointTCI-StateList or a higher layer parameter TCI-UL-State and is having two indicated TCI states (or two indicated uplink TCI states) comprising a first indicated TCI state and a second indicated TCI state:
the wireless device having a PUSCH transmission scheduled or activated by a DCI format 0_0 may apply the first indicated TCI state to the PUSCH transmission,
the wireless device configured, by the base station, with a PUSCH transmission corresponding to a Type 1 configured grant may be expected to be configured with a higher layer parameter applyIndicatedTCIState.
If the higher layer parameter applyIndicatedTCIState is set to ‘first’, the wireless device may apply the first indicated TCI state to the PUSCH transmission. The wireless device may apply the first indicated TCI state to each PUSCH transmission occasion of the PUSCH transmission.
If the higher layer parameter applyIndicatedTCIState is set to ‘second’, the wireless device may apply the second indicated TCI state to the PUSCH transmission. The wireless device may apply the second indicated TCI state to each PUSCH transmission occasion of the PUSCH transmission.
If the higher layer parameter applyIndicatedTCIState is set to ‘both’, the wireless device may apply the both of the two indicated TCI states to the PUSCH transmission. If the higher layer parameter applyIndicatedTCIState is set to ‘both’ (or if both of the two indicated TCI states are indicated to be applied for the PUSCH transmission), the wireless device may apply:
   the first indicated TCI state to PUSCH transmission occasion(s) or PUSCH antenna port(s), of the PUSCH transmission, associated with a first SRS resource set for codebook/non-codebook transmission, and
   the second indicated TCI state to PUSCH transmission occasion(s) or PUSCH antenna port(s), of the PUSCH transmission, associated with a second SRS resource set for codebook/non-codebook transmission.
If the wireless device is configured/indicated, by the base station, by a higher layer parameter PDCCH-Config that contains/comprises two different values of a higher layer parameter coresetPoolIndex in different ControlResourceSets, the first indicated TCI state and the second indicated TCI state may be specific to a higher layer parameter coresetPoolIndex with value 0 and a higher layer parameter coresetPoolIndex with value 1, respectively. If the wireless device is configured/indicated, by the base station, by a higher layer parameter PDCCH-Config that contains/comprises two different values of a higher layer parameter coresetPoolIndex in different ControlResourceSets, the higher layer parameter applyIndicatedTCIState may not be set to ‘both’ indicating both of the two indicated TCI states to be applied for the PUSCH transmission.

When two SRS resource sets are configured in a higher layer parameter srs-Resource SetToAddModList or a higher layer parameter srs-ResourceSetToAddModListDCI-0-2 with a higher layer parameter usage in SRS-ResourceSet set to ‘codebook’ or ‘nonCodebook’ and a higher layer parameter enableSTx2PofmDCI is configured and a higher layer parameter PDCCH-Config contains/comprises two different values of coresetPoolIndex in a higher layer parameter ControlResourceSet for the active BWP of a serving cell,
two PUSCHs that are fully/partially overlapping in time domain and are fully/partially/non-overlapping in frequency domain may be dynamically scheduled by UL grant(s) in DCI(s) and/or scheduled by configured grant(s) Type 1 or Type 2,
if dynamically scheduled by UL grant(s) in DCI(s) or activated by DCI(s) for configured grant Type 2, the DCI field SRS Resource Set Indicator may not present in each of PDCCH,
two PUSCHs may be associated to different values of coresetPoolIndex where for configured grant Type 1, the association may be based on a higher layer parameter srs-ResourceSetId in a higher layer parameter rrc-ConfiguredUplink Grant that indicates either the first SRS resource set or the second SRS resource set of the two SRS resource sets with usage ‘codebook’ or ‘nonCodeBook’ in the higher layer parameter srs-ResourceSet ToAddModList or the higher layer parameter srs-ResourceSet ToAddModListDCI-0-2,
the UE may not be expected to be configured with different number of SRS resources in the two SRS resource sets
the UE may expect a higher layer parameter maxNrofPorts in PTRS-UplinkConfig to be configured as one if UL PT-RS is configured.

When a UE is configured with a higher layer parameter dl-OrJointTCI-StateList or TCI-UL-State and two SRS resource sets are configured in a higher layer parameter srs-ResourceSetToAddModList or a higher layer parameter srs-ResourceSetToAddModListDCI-0-2 with a higher layer parameter usage in SRS-ResourceSet set to ‘codebook’ or ‘noncodebook’, and the higher layer parameter multipanelScheme is set to ‘SDMscheme’ or ‘SFNscheme’, and a higher layer parameter rrc-ConfiguredUplinkGrant of a Type 1 configured uplink grant does not contain srs-ResourceIndicator2 or precodingAndNumberOfLayers2, the PUSCH transmission occasion(s) of the Type 1 configured uplink grant may be associated with the first SRS resource set of the two SRS resource sets if the first indicated TCI-State or TCI-UL-State applies to the Type 1 configured uplink grant (e.g., when the higher layer parameter applyIndicatedTCIState=‘first’) and may be associated with the second SRS resource set of the two SRS resource sets if the second indicated TCI-State or TCI-UL-State applies to the Type 1 configured uplink grant (e.g., when the higher layer parameter applyIndicatedTCIState=‘second’).

When a UE is configured with a higher layer parameter di-OrJointTCI-StateList or TCI-UL-State is having two indicated TCI states, and only one SRS resource set is configured in a higher layer parameter srs-ResourceSetToAddModList or a higher layer parameter srs-ResourceSetToAddModListDCI-0-2 with a higher layer parameter usage in SRS-ResourceSet set to ‘codebook’ or ‘noncodebook’, the PUSCH transmission occasion(s) scheduled or activated by DCI format 0_1 or 0_2 may be associated with the first indicated TCI-State or TCI-UL-State or may be associated with the second indicated TCI-State or TCI-UL-State, as indicated by a higher layer parameter applyIndicatedTCIState configured by a higher layer parameter PUSCH-Config. When the higher layer parameter applyIndicatedTCIState is set to ‘first’, the UE may transmit, in/via the PUSCH transmission occasion(s), a PUSCH transmission (or repetitions of a PUSCH transmission) scheduled or activated by DCI format 0_1 or 0_2 using the first indicated TCI-State or TCI-UL-State. When the higher layer parameter applyIndicatedTCIState is set to ‘second’, the UE may transmit, in/via the PUSCH transmission occasion(s), a PUSCH transmission (or repetitions of a PUSCH transmission) scheduled or activated by DCI format 0_1 or 0_2 using the second indicated TCI-State or TCI-UL-State. The higher layer parameter applyIndicatedTCIState may indicate if a UE applies the first or the second “indicated” UL TCI state or joint TCI state for a PUSCH transmission, for example, scheduled or activated by DCI format 0_1 or 0_2. The higher layer parameter applyIndicatedTCIState may indicate if a UE applies the first or the second “indicated” UL TCI state or joint TCI state for a PUSCH transmission scheduled or activated by DCI format 0_1/0_2, for example, when an SRS resource set indicator field is not present (or is absent) in DCI format 0_1/0_2. The higher layer parameter applyIndicatedTCIState may indicate if a UE applies the first or the second “indicated” UL TCI state or joint TCI state for a PUSCH transmission scheduled or activated by DCI format 0_1/0_2, for example, when only one SRS resource set (or a single SRS resource set) is configured in a higher layer parameter srs-ResourceSetToAddModList or a higher layer parameter srs-ResourceSetToAddModListDCI-0-2 with a higher layer parameter usage in SRS-ResourceSet set to ‘codebook’ or ‘noncodebook’

When a UE is configured with a higher layer parameter enableSTx2PofmDCI and a higher later parameter PDCCH-Config contains two different values of coresetPoolIndex in ControlResource Set for the active BWP of a serving cell,
the UE is expected to be configured with two SRS resource sets with a higher layer parameter usage set to ‘codebook’ or ‘nonCodeBook’ in a higher layer parameter srs-ResourceSetToAddModList
If the UE is configured to monitor DCI format 0_2 and there is only one SRS resource set configured by a higher layer parameter srs-ResourceSetToAddModListDCI-0-2 and associated with a higher layer parameter usage set to ‘codebook’ or ‘nonCodeBook’, the UE may monitor only coresetPoolIndex configured with value 0 for detection of DCI format 0_2.

The higher layer parameter enableSTx2PofmDCI may be (or may be interchanbly used with) a higher layer parameter stx2-Panel.

The higher layer parameter enableSTx2PofmDCI may enable PUSCH+PUSCH multiple panel simultaneous uplink transmission in multi-DCI based mTRP system (e.g., each TRP transmits a DCI scheduling a PDSCH/PUSCH/SRS transmission). When the higher layer parameter enableSTx2PofmDCI is configured, two coresetPoolIndex values are configured and two SRS resource sets for codebook or non-codebook are configured, the multi-DCI based STxMP PUSCH+PUSCH may be configured.

When a higher layer parameter multipanelScheme is set to ‘SDMScheme’ and two SRS resource sets are configured/indicated, by a base station, in a higher layer parameter srs-ResourceSetToAddModList or a higher layer parameter srs-ResourceSet ToAddModListDCI-0-2 with a higher layer parameter usage in a higher layer parameter SRS-ResourceSet set to ‘codebook’, two SRIs and two TPMIs may be given/provided/indicated by two SRS resource indicator fields and two Precoding-information-and-number-of-layers fields for/in a DCI format 0_1 and a DCI format 0_2:
When codepoint “10” of SRS Resource Set indicator is indicated in the DCI format 0_1/0_2:
   a first TPMI of the two TPMIs may indicate a transmission precoder to be applied over layers {0 . . . v₁−1}, where v₁ is a number of layers indicated by the first TPMI, that corresponds to an SRS resource selected by a first SRI of the two SRSs when multiple SRS resources are configured for a first SRS resource set or if single SRS resource is configured for the first SRS resource set, and
   a second TPMI of the two TPMIs may indicate a transmission precoder to be applied over layers {v₁ . . . v₂+v₁−1}, where v₂ is a number of layers indicated by the second TPMI, that corresponds to an SRS resource selected by a second SRI of the two SRIs when multiple SRS resources are configured for a second SRS resource set or if single SRS resource is configured for the second SRS resource set, v₁≤maxRankSdm and v₂≤maxRankSdm or maxRankSdmDCI-0-2 and maxRankSdm or maxRankSdmDCI-0-2 may define the maximum number of layers applied over the first SRS resource set and the second SRS resource sets, separately.
When codepoint “00” or “01” of SRS Resource Set indicator is indicated in the DCI format 0_1/0_2, the second SRI and second TPMI may be reserved, and the first TPMI may indicate a precoder to be applied over layers {0 . . . v−1}, where v≤maxRank, where maxRank may define the maximum number of layers.
Codepoint “11” of SRS Resource Set indicator in the DCI format 0_1/0_2 may be reserved.
For one or two TPMIs, the transmission precoder may be selected from an uplink codebook that has a number of antenna ports equal to a higher layer parameter nrofSRS-Ports in a higher layer parameter SRS-Config for the indicated SRI(s). When two TPMIs are indicated, the UE may expect that the precoder indicated by the first TPMI and the precoder indicated by the second TPMI are mapped to different PUSCH antenna ports.
When two SRIs are indicated, the wireless device may expect that the number of SRS antenna ports associated with two indicated SRIs is the same. When the wireless device is configured/indicated with a higher layer parameter txConfig set to ‘codebook’, the wireless device may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. When two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, the wireless device may not be expected to be configured with a different number of SRS resources in the two SRS resource sets.

When a higher layer parameter multipanelScheme is set to ‘SFNScheme’ and two SRS resource sets are configured/indicated, by a base station, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, two SRIs and two TPMIs may be given/provided/indicated by two SRS resource indicator fields and two Precoding-information-and-number-of-layers fields for/in a DCI format 0_1 and a DCI format 0_2:
When codepoint “10” of SRS Resource Set indicator is indicated in the DCI format 0_1/0_2:
   a first TPMI of the two TPMIs may indicate a transmission precoder to be applied over layers {0 . . . v−1}, and a second TPMI of the two TPMIs may indicate a transmission precoder to be applied over layers {0 . . . v−1}, where v≤maxRankSfn or maxRankSfnDCI-0-2 and maxRankSfn or maxRankSfnDCI-0-2 may define the maximum number of layers applied over the first SRS resource set and the second SRS resource sets, separately.
When codepoint “00” or “01” of SRS Resource Set indicator is indicated in the DCI format 0_1/0_2, the second SRI and second TPMI may be reserved, and the first TPMI may indicate a precoder to be applied over layers {0 . . . v−1}, where v≤maxRank, where maxRank may define the maximum number of layers.
Codepoint “11” of SRS Resource Set indicator in the DCI format 0_1/0_2 may be reserved.
For one or two TPMIs, the transmission precoder may be selected from an uplink codebook that has a number of antenna ports equal to a higher layer parameter nrofSRS-Ports in a higher layer parameter SRS-Config for the indicated SRI(s). When two TPMIs are indicated, the UE may expect that the precoder indicated by the first TPMI and the precoder indicated by the second TPMI are mapped to different PUSCH antenna ports.
When two SRIs are indicated, the wireless device may expect that the number of SRS antenna ports associated with two indicated SRIs is the same. When the wireless device is configured/indicated with a higher layer parameter txConfig set to ‘codebook’, the wireless device may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. When two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, the wireless device may not be expected to be configured with a different number of SRS resources in the two SRS resource sets.

When a higher layer parameter multipanelScheme is set to ‘SDMScheme’ and two SRS resource sets are configured/indicated, by a base station, in a higher layer parameter srs-Resource Set ToAddModList or a higher layer parameter srs-ResourceSet ToAddModListDCI-0-2 with a higher layer parameter usage in a higher layer parameter SRS-ResourceSet set to ‘nonCodebook’, two SRIs may be given/provided/indicated by two SRS resource indicator fields for/in a DCI format 0_1 and a DCI format 0_2:
When codepoint “10” of SRS Resource Set indicator is indicated in the DCI format 0_1/0_2:
   a first SRI of the two SRIs may indicate resource(s) to be associated with layers {0 . . . v₁−1}, where v₁ is a number of layers indicated by the first SRI and a second SRI of the two SRIs may indicate resource(s) to be associated with layers {v₁ . . . v₂+v₁−1}, v₁≤Lₘₐₓ and v₂≤Lₘₐₓ. The UE may expect that SRS resource(s) indicated by the first SRI and SRS resource(s) indicated by the second SRI are corresponding to different PUSCH antenna ports.
   When codepoint “00” or “01” of SRS Resource Set indicator is indicated in the DCI format 0_1/0_2, the second SRI may be reserved, and the first SRI may indicate resource(s) associated with layers {0 . . . v−1}, where v≤Lₘₐₓ.

When a higher layer parameter multipanelScheme is set to ‘SFNScheme’ and two SRS resource sets are configured/indicated, by a base station, in a higher layer parameter srs-ResourceSetToAddModList or a higher layer parameter srs-ResourceSet ToAddModListDCI-0-2 with a higher layer parameter usage in a higher layer parameter SRS-ResourceSet set to ‘nonCodebook’, two SRIs may be given/provided/indicated by two SRS resource indicator fields for/in a DCI format 0_1 and a DCI format 0_2:
When codepoint “10” of SRS Resource Set indicator is indicated in the DCI format 0_1/0_2:
a first SRI of the two SRIs may indicate resource(s) to be associated with layers {0 . . . v−1} and a second SRI of the two SRIs may indicate resource(s) to be associated with layers {0 . . . v−1}, v≤Lₘₐₓ. The UE may expect that SRS resource(s) indicated by the first SRI and SRS resource(s) indicated by the second SRI are corresponding to different PUSCH antenna ports.
When codepoint “00” or “01” of SRS Resource Set indicator is indicated in the DCI format 0_1/0_2, the second SRI may be reserved, and the first SRI may indicate resource(s) associated with layers {0 . . . v−1}, where v≤Lₘₐₓ. When two SRIs are indicated, the wireless device may expect that the number of SRS antenna ports associated with two indicated SRIs to be the same.
When the wireless device is configured/indicated with a higher layer parameter txConfig set to ‘nonCodebook’, the wireless device may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. When two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘nonCodebook’, the wireless device may not be expected to be configured with a different number of SRS resources in the two SRS resource sets.

When a wireless device is configured/indicated, by a base station, with a higher layer parameter di-OrJointTCI-StateList or a higher layer parameter TCI-UL-State and is having two indicated TCI states (or two indicated joint/uplink TCI states) comprising a first indicated TCI state and a second indicated TCI state, and two SRS resource sets are configured/indicated, by the base station, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’ or ‘nonCodebook’, for a PUSCH repetition Type A or Type B, or for a PUSCH transmission when the higher layer parameter multipanelScheme is set to ‘SDMscheme’ or ‘SFNscheme’, the association of the first indicated TCI state and the second indicated TCI state to PUSCH transmission occasions or to corresponding PUSCH antenna ports may be determined as follows:
if a DCI format 0_1 or a DCI format 0_2 indicates codepoint “00” or “01” for an SRS resource set indicator, the first indicated TCI state or second indicated TCI state may be applied, by the wireless device, to all PUSCH transmission occasions, respectively.
if a DCI format 0_1 or a DCI format 0_2 indicates codepoint “10” or “11” for an SRS resource set indicator, and the higher layer parameter multipanelScheme is not configured,
the first indicated TCI state may be applied, by the wireless device, to PUSCH transmission occasion(s) associated with a first SRS resource set of the two SRS resource sets and the second indicated TCI state may be applied to PUSCH transmission occasion(s) associated with a second SRS resource set of the SRS resource sets, where the association of PUSCH transmission occasions to the two SRS resource sets may be determined based on whether a higher layer parameter cyclicMapping or a higher layer parameter sequentialMapping in a higher layer parameter PUSCH-Config is enabled.
if a DCI format 0_1 or a DCI format 0_2 indicates codepoint “10” for an SRS resource set indicator and the higher layer parameters multipanelScheme is configured and set to ‘SDMscheme’ or ‘SFNscheme’,
the first indicated TCI state may be applied, by the wireless device, to first PUSCH antenna port(s), of a PUSCH transmission occasion, associated with the first SRS resource set, and the second indicated TCI state may be applied, by the wireless device, to second PUSCH antenna port(s), of the PUSCH transmission occasion, associated with the second SRS resource set. The first PUSCH antenna port(s) and the second PUSCH antenna port(s) may be the same or different.

For a CORESET other than a CORESET with index 0,
if a wireless device has not been provided/indicated a configuration of TCI state(s) by a higher layer parameter tci-StatesPDCCH-ToAddList and a higher layer parameter tci-StatesPDCCH-ToReleaseList for the CORESET, or has been provided/indicated an initial configuration of more than one TCI states for the CORESET by a higher layer parameter tci-StatesPDCCH-ToAddList and a higher layer parameter tci-StatesPDCCH-ToReleaseList and has not received a MAC CE activation command activating (or indicating activation) for one of the more than one TCI states, the wireless device may assume that a DM-RS antenna port associated with PDCCH receptions in the CORESET is quasi co-located with an SS/PBCH block the wireless device identified during an initial access procedure, or for a most recent configured grant PUSCH transmission in an RRC inactive state for a same HARQ process;
if a wireless device has been provided/indicated a configuration of more than one TCI states by a higher layer parameter tci-StatesPDCCH-ToAddList and a higher layer parameter tci-StatesPDCCH-ToReleaseList for the CORESET as part of a reconfiguration with sync procedure and has not received a MAC CE activation command for one of the more than one TCI states, the wireless device may assume that DM-RS antenna port associated with PDCCH receptions in/via the CORESET is quasi co-located with a SS/PBCH block or a CSI-RS resource the wireless device identified during a random access procedure initiated by the reconfiguration with sync procedure.

For a CORESET with index 0,
if a wireless device is provided/indicated with a TCI state and indicated/configured with a higher layer parameter followUnifiedTCI-State for the CORESET, the wireless device may assume that a DM-RS antenna port for PDCCH receptions in the CORESET and a DM-RS antenna port for PDSCH receptions scheduled by DCI formats provided by the PDCCH receptions in the CORESET are quasi co-located with reference signal(s) provided/indicated by the indicated TCI state,
else if the wireless device is provided/indicated/configured with a higher layer parameter dl-OrJointTCI-StateList and is indicated a first TCI state and a second TCI state, and provided/indicated/configured with a higher layer parameter apply-IndicatedTCIState for the CORESET:
   if the higher layer parameter apply-IndicatedTCIState=‘first’, the wireless device may assume that a DM-RS antenna port for PDCCH receptions in the CORESET is quasi co-located with reference signal(s) provided/indicated by the first TCI state,
   if the higher layer parameter apply-IndicatedTCIState=‘second’, the wireless device may assume that a DM-RS antenna port for PDCCH receptions in the CORESET is quasi co-located with reference signal(s) provided/indicated by the second TCI state,
   if the higher layer parameter apply-IndicatedTCIState=‘both’, the wireless device may assume that a DM-RS antenna port for PDCCH receptions in the CORESET is quasi co-located with reference signals provided/indicated by the first TCI state and the second TCI state.
else, the wireless device may assume that a DM-RS antenna port for PDCCH receptions in the CORESET is quasi co-located with
   reference signal(s) provided/indicated/configured by a TCI state that is indicated by a MAC CE activation command for the CORESET, if any, or
   a SS/PBCH block the wireless device identified during a most recent random access procedure that is not initiated by a PDCCH order that triggers a contention-free random access procedure, if no MAC CE activation command indicating a TCI state for the CORESET is received after the most recent random access procedure, or a SS/PBCH block the wireless device identified during a most recent configured grant PUSCH transmission for a small data transmission (SDT).

For a CORESET other than a CORESET with index 0, if a wireless device is provided/configured/indicated a single TCI state for the CORESET, or if the wireless device receives a MAC CE activation command (activating or indication activation) for one or two of the provided/configured TCI states for the CORESET, the wireless device may assume that a DM-RS antenna port associated with PDCCH receptions in/via the CORESET is quasi co-located with the one or more DL RSs configured by the TCI states (e.g., the single TCI state or the one or two TCI states). For a CORESET with index 0, the wireless device may expect that a CSI-RS configured with qcl-Type set to ‘typeD’ in a TCI state indicated by a MAC CE activation command for the CORESET is provided by a SS/PBCH block.

If a wireless device is provided/indicated a TCI-State in a higher layer parameter dl-OrJointTCI-StateList:
a DM-RS antenna port for PDCCH receptions in a CORESET, other than a CORESET with index 0, associated only with USS sets and/or Type3-PDCCH CSS sets may be quasi co-located with reference signal(s) provided/indicated by the indicated TCI-State; and
a DM-RS antenna port for PDSCH receptions scheduled by DCI formats provided by PDCCH receptions in the CORESET may be quasi co-located with reference signal(s) provided/indicated by the indicated TCI-State.

If a wireless device is provided/indicated/configured with a higher layer parameter followUnifiedTCI-State for a CORESET, other than a CORESET with index 0, associated at least with CSS sets other than Type3-PDCCH CSS sets:
a DM-RS antenna port for PDCCH receptions in the CORESET may be quasi co-located with reference signal(s) provided/indicated by the indicated TCI-State; and
a DM-RS antenna port for PDSCH receptions scheduled by DCI formats provided by PDCCH receptions in the CORESET may be quasi co-located with reference signal(s) provided/indicated by the indicated TCI-State.

If a wireless device is provided/configured/indicated with a higher layer parameter di-OrJointTCI-StateList and is indicated a first TCI state and a second TCI state, and is provided/indicated/configured with a higher layer parameter apply-IndicatedTCIState for a CORESET, other than a CORESET with index 0,
if the CORESET is associated only with USS sets and/or Type3-PDCCH CSS sets
if the higher layer parameter apply-IndicatedTCIState=‘first’, the wireless device may assume that a DM-RS antenna port for PDCCH receptions in the CORESET is quasi co-located with reference signal(s) provided/indicated by the first TCI state,
if the higher layer parameter apply-IndicatedTCIState=‘second’, the wireless device may assume that a DM-RS antenna port for PDCCH receptions in the CORESET is quasi co-located with reference signal(s) provided/indicated by the second TCI state,
if the higher layer parameter apply-IndicatedTCIState=‘both’, the wireless device may assume that a DM-RS antenna port for PDCCH receptions in the CORESET is quasi co-located with reference signals provided/indicated by the first TCI state and the second TCI state.
if the CORESET is associated at least with CSS sets other than Type3-PDCCH CSS sets,
if the higher layer parameter apply-IndicatedTCIState=‘first’, the wireless device may assume that a DM-RS antenna port for PDCCH receptions in the CORESET is quasi co-located with reference signal(s) provided/indicated by the first TCI state,
if the higher layer parameter apply-IndicatedTCIState=‘second’, the wireless device may assume that a DM-RS antenna port for PDCCH receptions in the CORESET is quasi co-located with reference signal(s) provided/indicated by the second TCI state,
if the higher layer parameter apply-IndicatedTCIState=‘both’, the wireless device may assume that a DM-RS antenna port for PDCCH receptions in the CORESET is quasi co-located with reference signals provided/indicated by the first TCI state and the second TCI state,
if the higher layer parameter apply-IndicatedTCIState=‘none’, the wireless device may assume that a DM-RS antenna port for PDCCH receptions in the CORESET is quasi co-located with reference signal(s) provided/indicated/configured by a TCI state indicated by a MAC CE activation command for the CORESET

If a wireless device is provided/configured/indicated with a higher layer parameter di-OrJointTCI-StateList and
is not provided/configured/indicated with a higher layer parameter coresetPoolIndex or is provided/configured/indicated with a higher layer parameter coresetPoolIndex with a value of 0 for first CORESETs on an active DL BWP of a serving cell,
is provided/configured/indicated with a higher layer parameter coresetPoolIndex with a value of 1 for second CORESETs on the active DL BWP of the serving cells, and
for the first and second CORESETs that do not include a CORESET with index 0, and a) are associated only with USS sets and/or Type3-PDCCH CSS sets, or b) are associated with CSS sets other than Type3-PDCCH CSS sets and provided/configured/indicated with a higher layer parameter followUnifiedTCI-State,
the wireless device may assume that DM-RS antenna ports for PDCCH receptions in the first CORESETs and second CORESETs, and DM-RS antenna ports for PDSCH receptions scheduled by DCI formats provided by PDCCH receptions in the first CORESETs and second CORESETs, are quasi co-located with reference signals provided by indicated TCI state specific to the first CORESETs (or coresetPoolIndex=0) and second CORESETs (or coresetPoolIndex=1), respectively,
the wireless device may transmit PUSCH scheduled by DCI formats provided by PDCCH receptions in the first CORESETs and second CORESETs using a spatial domain filter corresponding to TCI state or TCI UL state specific to the first CORESETs (or coresetPoolIndex=0) and second CORESETs (or coresetPoolIndex=1), respectively.

If a wireless device is provided/indicated/configured with two coresetPoolIndex values 0 and 1 for first CORESETs and second CORESETs, or is not provided/indicated/configured coresetPoolIndex value for first CORESETs and is provided/indicated/configured coresetPoolIndex value of 1 for second CORESETs, respectively, the wireless device may receive a MAC CE command activating TCI states for the first CORESETs or the second CORESETs. The MAC-CE command activating TCI states for the first CORESETs or the second CORESETs may include/comprise coresetPoolIndex value 0 or coresetPoolIndex value 1, respectively.

If the wireless device is provided/indicated/configured with a higher layer parameter SSB_MTC_AdditionalPCI, the activated TCI states for the first CORESETs and/or the second CORESETs are for a physical cell identifier/index (PCI) (e.g., physCellId) from a higher layer parameter ServingCellConfigCommon and the activated TCI states for either the first CORESETs or the second CORESETs can be for a PCI (e.g., physCellId) from a higher layer parameter additionalPCI. The PCI from the higher layer parameter ServingCellConfigCommon may be different from the PCI from the higher layer parameter additionalPCI.

The higher layer parameter apply-IndicatedTCIState of a CORESET may indicate, for PDCCH reception on the CORESET, if wireless device applies the first (indicated) joint/downlink TCI state, the second (indicated) joint/downlink TCI state, both the first (indicated) joint/downlink TCI state and the second (indicated) joint/downlink TCI state, or none of the first (indicated) joint/downlink TCI state and the second (indicated) joint/downlink TCI state.

The higher layer parameter apply-IndicatedTCIState may be absent, for example, if the higher layer parameter followUnifiedTCI-State is present/configured or if more than one value for the coresetPoolIndex is configured in controlResourceSet for the same bandwidth part (BWP).

The higher layer parameter apply-IndicatedTCIState of a CORESET with index zero (e.g., CORESET #0) may indicate, for PDCCH reception on/in/via the CORESET, if wireless device applies the first (indicated) joint/downlink TCI state, the second (indicated) joint/downlink TCI state, both the first (indicated) joint/downlink TCI state and the second (indicated) joint/downlink TCI state, or none of the first (indicated) joint/downlink TCI state and the second (indicated) joint/downlink TCI state.

A wireless device may be provided/indicated/configured a value N_{TA,offset} of a timing advance offset for a serving cell by a higher layer parameter n-TimingAdvanceOffset for a serving cell.

If for the serving cell the wireless device is provided/indicated/configured two coresetPoolIndex values 0 and 1 for first CORESETs and second CORESETs, or is not provided/indicated/configured coresetPoolIndex value for first CORESETs and is provided/indicated/configured coresetPoolIndex value of 1 for second CORESETs, the wireless device may be provided/indicated/configured a first N_{TA,offset} value by a higher layer parameter n-TimingAdvanceOffset for transmissions with a first spatial filter associated with first TCI state for the first CORESETs, and a second N_{TA,offset} value by a higher layer parameter n-TimingAdvanceOffset2 for transmissions with a second spatial filter associated with a second TCI state for the second CORESETs.

A wireless device may can be provided/indicated/configured a second N_{TA,offset} value for transmissions with a second spatial domain filter corresponding to a second TCI state or to a second SS/PBCH block receptions associated with a PCI (e.g., physCellId) different from a PCI (e.g., physCellId) for the serving cell in addition to a first N_{TA,offset} value for transmissions with a first spatial domain filter corresponding to first TCI state or to a first SS/PBCH block reception associated with a PCI (e.g., physCellId) for the serving cell. The first N_{TA,offset} value and the second N_{TA,offset} value may correspond to a first TAG and a second TAG indicated in respective MAC RARs. The first TAG and the second TAG may have an association indicated by a higher layer parameter tag-Id-ptr with a first joint/uplink TCI state and a second joint/uplink TCI state provided/indicated/configured by a higher layer parameter dl-OrJointTCI-StateListlul-TCI-State-List. If the wireless device is not provided/indicated/configured a higher layer parameter n-TimingAdvanceOffset for a serving cell, the wireless device may determine a default value N_{TA,offset} of the timing advance offset for the serving cell.

The one or more configuration parameters may indicate, for a joint/uplink TCI state, a TAG among the first TAG and the second TAG. The one or more configuration parameters may comprise a higher layer parameter tag-Id-ptr of/for the TCI state. A value of the higher layer parameter tag-Id-ptr may indicate the TAG, among the first TAG and the second TAG, associated with the TCI state. For example, a first value (e.g., 0) of the higher layer parameter tag-Id-ptr may indicate, for the TCI state, the first TAG indicated by a higher layer parameter tag-Id. A second value (e.g., 1) of the higher layer parameter tag-Id-ptr may indicate, for the TCI state, the second TAG indicated by a higher layer parameter tag2-Id. The higher layer parameter tag-Id-ptr may refer to a TAG of the serving cell where the TCI state is applied by the wireless device.

If a wireless device operates with two TAGs on an active UL BWP of a serving cell, the wireless device may expect that a difference between a first downlink timing associated with a first TAG and a second downlink timing associated with a second TAG is not larger than a CP length for the active UL BWP unless the wireless device indicates, to a base station or a network, a higher layer parameter larger-thanCP-capability.

The one or more configuration parameters may indicate one or more timing advance groups (TAGs). The one or more TAGS may comprise (or be associated with) one or more cells. Each TAG of the one or more TAGS may comprise respective cell(s) of the one or more cells. The one or more configuration parameters may indicate, for each cell of the one or more cells, a respective TAG of the one or more TAGS.

The wireless device may receive a timing advance command (e.g., in a random access response or in an absolute timing advance command MAC CE or a timing advance command MAC CE) for a TAG of the one or more TAGs. The timing advance command may, for example, comprise a field (e.g., TAG ID) indicating/identifying the TAG. The wireless device may, for example, receive the timing advance command via a cell associated with the TAG. The TAG may comprise at least one cell that comprise the cell. The one or more cells may comprise the at least one cell that comprise the cell. The wireless device may adjust/determine an uplink timing for uplink transmissions (e.g., PUCCH/PUSCH/SRS transmissions) on/via each cell of the at least one cell in the TAG, for example, based on the timing advance command. The wireless device may adjust/determine the uplink timing for the uplink transmissions on/via each cell of the at least one cell in the TAG, for example, based on a value (or a default value) of a timing advance offset (e.g., N_{TA,offset}). In an example, the value (or the default value) of the timing advance offset may be the same for each cell of the at least one cell in the TAG. In an example, the uplink timing may be the same for each cell of the at least one cell in the TAG. In an example, the uplink timing of the uplink transmissions (e.g., PUCCH/PUSCH/SRS transmission) may be the same for each cell of the at least one cell.

For a subcarrier spacing (SCS) of 2^{μ}·15 kHz, a timing advance command, received by the wireless device, for a TAG of the one or more TAGS may indicate a change of an uplink timing relative to the current uplink timing for the TAG in multiples of 16·64·T_{c}/2^{μ}.

The wireless device may receive a timing advance command (e.g., T_{A}) for a TAG of the one or more TAGS.

In an example, a random-access response or in an absolute timing advance command MAC CE may indicate/comprise the timing advance command. The wireless device may receive the timing advance command in the random-access response or in the absolute timing advance command MAC CE. The timing advance command may indicate a timing advance value (e.g., N_{TA}) by an index value (e.g., T_{A}=0, 1, 2, . . . , 3846). The wireless device may determine/calculate/adjust an amount/quantity of the timing advance value (or the time alignment) for/of the TAG with SCS of 2^{μ}·15 KHz as N_{TA}=T_{A}·16·64/2^{μ}. The timing advance value may be relative to a SCS of a starting/earliest/first uplink transmission from the wireless device after the reception of the random-access response or the absolute timing advance command MAC CE.

In an example, a timing advance command MAC CE may indicate/comprise the timing advance command. The wireless device may receive the timing advance command in the . . . MAC CE. The timing advance command may indicate adjustment of a current timing advance value, N_{TA} old, to a new timing advance value, N_{TA_new}, by an index value (e.g., T_{A}=0, 1, 2 . . . , 63). For a SCS of 2^{μ}·15 kHz, the wireless device may determine the new timing advance value as N_{TA_new}=N_{TA_old}+(T_{A}−31)·16·64/2^{μ}.

Each cell of the at least one cell in the TAG may have/comprise (or be indicated/configured, by the one or more configuration parameters, with) respective uplink carrier(s) (e.g., NUL and/or SUL). For example, a first cell of the at least one cell may comprise a first uplink carrier (e.g., NUL). A second cell of the at least one cell may comprise a second uplink carrier (e.g., SUL). A third cell of the at least one cell may comprise the first uplink carrier (e.g., NUL) and the second uplink carrier (e.g., SUL). The wireless device may be active in (or may activate) a plurality of uplink BWPs for/of one or more uplink carriers of the at least one cell in the TAG. The wireless device may be active in (or may activate) a respective uplink BWP, of the plurality of uplink BWPs, of the one or more uplink carriers of each cell of the at least one cell. The TAG may comprise the plurality of uplink BWPs of the at least one cell. The timing advance command (or a value in (or indicated by) the timing advance command) may be relative to the largest SCS of/among the plurality of uplink BWPs. The new timing advance value (e.g., N_{TA_new}) for an uplink BWP, of the plurality of uplink BWPs, with a lower SCS may be rounded, by the wireless device, to align with the timing advance granularity for the uplink BWP with the lower SCS.

Adjustment of the timing advance value (e.g., N_{TA}) by a positive or a negative amount may indicate advancing or delaying an uplink transmission timing for the TAG by a corresponding amount, respectively.

The wireless device may receive a timing advance command for a TAG of the one or more TAGS. The TAG may comprise at least one cell of the one or more cells. The wireless device may receive, in/on/via an uplink time slot n, the timing advance command. The wireless device may adjust an uplink transmission timing based on the timing advance command. The wireless device may apply adjustment of the uplink transmission timing from beginning of a second uplink time slot. The wireless device may apply the adjustment of the uplink transmission timing for transmission of an uplink signal (e.g., PUSCH/PUSCH/SRS transmission). The wireless device may apply the adjustment of the uplink transmission timing for transmission of the uplink signal via a cell of the at least one cell (or via an uplink carrier of a cell of the at least one cell). The transmission of the uplink signal may not comprise, for example, a PUSCH transmission scheduled by a RAR uplink grant or a fallbackRAR uplink grant. The transmission of the uplink signal may not comprise, for example, a PUCCH transmission with HARQ-ACK information in response to a successRAR. The wireless device may apply the adjustment of the uplink transmission timing for uplink transmissions via the at least one cell. The wireless device may determine the second uplink time slot as the uplink time slot n+k+1+2^{μ}·K_{offset} where

$$k = ⌈ {N}_{slot}^{subframe , μ} \cdot ( {N}_{T , 1} + {N}_{T , 2} + {N}_{TA , max} + 0.5 ) / {T}_{sf} ⌉ .$$

For example, N_{T,1} may be a time duration in msec of N₁ symbols corresponding to a PDSCH processing time for UE processing capability 1 when additional PDSCH DM-RS is configured (or is indicated by the one or more configuration parameters). For example, N_{T,2} may be a time duration in msec of N₂ symbols corresponding to a PUSCH preparation time for UE processing capability 1. For example, N_{TA,max} may be a maximum timing advance value in msec that can be provided by a T_{A} command field of 12 bits. For example,

$${N}_{slot}^{subframe , μ}$$

may be a number of slots per subframe. For example, T_{sf} may be a subframe duration of 1 msec. For example, K_{offset}=K_{cell,offset}−K_{UE,offset}. In an example, the one or more configuration parameters may indicate the K_{cell,offset} (e.g., provided by K_{offset} in ServingCellConfigCommon). In an example, the one or more configuration parameters may not indicate a value for K_{cell,offset} (e.g., K_{offset} is absent in ServingCellConfigCommon). The wireless device may determine a default value for K_{cell,offset}=0 based on the one or more configuration parameters not indicating a value for K_{cell,offset}. For example, the wireless device may receive a MAC CE command indicating the K_{UE,offset}. For example, the wireless device may not receive a MAC CE command indicating a value for K_{UE,offset}. The wireless device may determine a default value for K_{UE,offset}=0 based on not receiving a MAC CE command indicating a value for K_{UE,offset}. The wireless device may determine N₁ and N₂ with respect to the minimum SCS among the SCSs of all configured uplink BWPs for all uplink carriers of the at least one cell in the TAG and of all configured downlink BWPs for the corresponding downlink carriers (or for the at least one cell). For μ=0, the wireless device may determine/assume N_{1,0}=14. The wireless device may determine the uplink time slot n and

$${N}_{slot}^{subframe , μ}$$

with respect to the minimum SCS among the SCSs of all configured uplink BWPs for all uplink carriers of the at least one cell in the TAG. The wireless device may determine N_{TA,max} with respect to the minimum SCS among the SCSs of all configured uplink BWPs for all uplink carriers of the at least one cell in the TAG and for all configured initial uplink BWPs indicated by the one or more configuration parameters (e.g., provided by initialUplinkBWP). The uplink time slot n may be the last slot among uplink slot(s) overlapping with the slot(s) of a PDSCH reception assuming T_{TA}=0, where the PDSCH reception indicates/comprises/provides the timing advance command.

The wireless device may change an active uplink BWP of a cell of the at least one cell in the TAG. The wireless device may activate (or switch to a new uplink BWP of the cell) based on the changing the active uplink BWP. The wireless device may change the active uplink BWP between a first time of a reception of the timing advance command and a second time of applying the adjustment of the uplink transmission timing. Based on the changing the active uplink BWP between the first time and the second time, the wireless device may determine a value of the timing advance command (or a timing advance value) based on a SCS of the new active UL BWP. The wireless device may change the active uplink BWP after the second time. The wireless device may determine/assume a same absolute value for the timing advance command (or the same absolute timing advance value) before and after the change of the active uplink BWP.

A wireless device may receive, e.g., from a base station, one or more messages comprising one or more configuration parameters (e.g., RRC configuration parameters, RRC reconfiguration parameters). The one or more configuration parameters comprise one or more cell group configuration parameters (e.g., provided by MAC-CellGroupConfig). The one or more cell group configuration parameters may comprise a TAG configuration (e.g., tag-Config). The TAG configuration may be used, by the wireless device and/or the base station, to configure parameters for a time-alignment group. The TAG configuration may indicate one or more TAGS. A maximum number of the one or more TAGS (e.g., maxNrofTAGs) may be equal to a value (e.g., 4, 5, 6, 7, 8, and the like).

The TAG configuration may indicate one or more TAG indexes/identifiers (e.g., TAG-Id) for the one or more TAGs. The TAG configuration may indicate a respective TAG index/identifier of the one or more TAG indexes/identifiers for each TAG of the one or more TAGS. Each TAG of the one or more TAGs may be identified by/with a respective TAG index (e.g., 0, 1, . . . , maxNrofTAGs−1) of the one or more TAG indexes. A TAG index of a TAG of the one or more TAGs may indicate the TAG of a cell (e.g., SpCell, SCell). A TAG index of a TAG of the one or more TAGS may indicate the TAG within the scope of a cell group (e.g., MCG, SCG). The one or more TAG indexes may comprise the TAG index.

The TAG configuration may indicate one or more time alignment timers (e.g., TimeAlignmentTimer) for the one or more TAGS. The TAG configuration may indicate a respective time alignment timer of the one or more time alignment timers for each TAG of the one or more TAGS. Each TAG of the one or more TAGS may be associated with (or correspond to) a respective time alignment timer of the one or more time alignment timers. Value of a time alignment timer of the one or more time alignment timers may be in ms (e.g., 500 ms, 750 ms, . . . , 5120 ms, 10240 ms, or infinity). A time alignment timer of a TAG may indicate/control how long cell(s) in (or belonging to or associated with or corresponding to) the TAG are uplink time aligned. The one or more time alignment timers may comprise the time alignment timer. The one or more TAGS may comprise the TAG.

The one or more configuration parameters may indicate, for a cell, a TAG index/identifier (e.g., tag-Id) of the one or more TAG indexes. The TAG index may indicate/identify a first TAG of the one or more TAGS. The one or more configuration parameters may comprise one or more serving cell configuration parameters (e.g., ServingCellConfig) of the cell. The one or more serving cell configuration parameters of the cell may comprise/indicate the TAG index indicating/identifying the first TAG. The cell may belong to (or may be associated with or may correspond to) the first TAG, for example, based on the one or more configuration parameters indicating, for the cell, the TAG index indicating/identifying the first TAG. The first TAG may comprise (or may be associated with or may correspond to) the cell, for example, based on the one or more configuration parameters indicating, for the cell, the TAG index indicating/identifying the first TAG.

The one or more configuration parameters may indicate, for a cell, a second TAG index/identifier (e.g., tag2-Id) of the one or more TAG indexes. The second TAG index may indicate/identify a second TAG of the one or more TAGs. The one or more configuration parameters may comprise one or more serving cell configuration parameters (e.g., ServingCellConfig) of the cell. The one or more serving cell configuration parameters of the cell may comprise/indicate the second TAG index indicating/identifying the second TAG. The cell may belong to (or may be associated with or may correspond to) the second TAG, for example, based on the one or more configuration parameters indicating, for the cell, the second TAG index indicating/identifying the second TAG. The second TAG may comprise (or may be associated with or may correspond to) the cell, for example, based on the one or more configuration parameters indicating, for the cell, the second TAG index indicating/identifying the second TAG.

Throughout this specification, unless otherwise noted, the size of various fields in the time domain may be expressed in time units T_{c}=1/(Δfₘₐₓ·N_{f}) where Δfₘₐₓ=480·10³ Hz and N_{f}=4096. The constant κ=Tₛ/T_{c}=64 where Tₛ=1/(Δf_{ref}·N_{f,ref}), Δf_{ref}=15·10³ Hz and N_{f,ref}=2048.

Multiple OFDM numerologies may be supported by a wireless device. A subcarrier spacing (e.g., p) and the cyclic prefix for a downlink BWP or an uplink BWP may be obtained by the wireless device from the higher-layer (e.g., RRC or one or more configuration) parameters subcarrierSpacing and cyclicPrefix, respectively.

For subcarrier spacing configuration μ (e.g., μ=0, 1, 2, 3, . . . ), slots may be numbered

$${n}_{s}^{μ} ∈ \{ 0 , … , {N}_{slot}^{subframe , μ} - 1 \}$$

in increasing order within a subframe and

$${n}_{s , f}^{μ} ∈ \{ 0 , … , {N}_{slot}^{frame , μ} - 1 \}$$

in increasing order within a frame. There may be

$${N}_{symb}^{slot}$$

consecutive OFDM symbols in a slot where

$${N}_{symb}^{slot}$$

may be based/depend on the cyclic prefix (e.g., normal or extended cyclic prefix). The start of slot

$${n}_{s}^{μ}$$

in a surname may be aligned in time with a start of OFDM symbol

$${n}_{s}^{μ} {N}_{symb}^{slot}$$

in the same subframe.

A transmission (e.g., a downlink transmission, an uplink transmission, and a sidelink transmission) may be organized into frames with T_{f}=(ΔfₘₐₓN_{f}/100)·T_{c}=10 ms duration. A frame may comprise (or consist of) ten subframes of T_{sf}=(ΔfₘₐₓN_{f}/1000)·T_{c}=1 ms duration. A number of consecutive OFDM symbols per subframe may be

$${N}_{slot}^{subframe , μ} = {N}_{symb}^{slot} {N}_{slot}^{subframe , μ} .$$

Each frame may be divided into two equally-sized half-frames of five subframes each with half-frame 0 consisting of subframes 0-4 and half-frame 1 consisting of subframes 5-9.

There may be one set of frames in the uplink and one set of frames in the downlink on a carrier.

Uplink frame number i for transmission from a wireless device may start

$${T}_{TA} = ( {N}_{TA} + {N}_{TA , offset} + {N}_{TA , adj}^{common} + {N}_{TA , adj}^{UE} ) {T}_{c}$$

before the start of the corresponding downlink frame at the wireless device, where
N_{TA} may be a timing advance (or a timing advance value) between downlink and uplink, and N_{TA,offset} may be a fixed offset used to calculate the timing advance. For example, for msgA transmission on PUSCH, N_{TA}=0 may be used by the wireless device.

$${N}_{TA , adj}^{common}$$

may be derived/determined, by the wireless device, from (or indicated to the wireless device by) higher-layer (or RRC or one or more configuration) parameters TACommon, TACommonDrift, and TACommonDrift Variation if configured, otherwise

$${N}_{TA , adj}^{common} = 0. {N}_{TA , adj}^{common}$$

may a network-controlled timing correction.

$${N}_{TA , adj}^{UE}$$

may be computed/determined by the wireless device based on satellite-ephemeris-related higher-layers (e.g., RRC or one or more configuration) parameters if configured, otherwise

$${N}_{TA , adj}^{UE} = 0. {N}_{TA , adj}^{UE}$$

may be a UE-derived timing correction.

In RRC_CONNECTED, a base station may maintain the timing advance to keep a layer 1 (L1) of a wireless device synchronized. Serving cells having/with uplink to which the same timing advance applies and using the same timing reference cell may be grouped, by the bases station, in a TAG of one or more TAGS. Each TAG of the one or more TAGs may contain/comprise at least one serving cell configured with uplink. The mapping of each serving cell to a (respective) TAG may be configured/indicated by RRC configuration parameters (e.g., tag-Id).

For a primary TAG (pTAG), the wireless device may use the PCell as timing reference, except with shared spectrum channel access where an SCell can also be used in certain cases. In a secondary TAG (sTAG), the wireless device may use any of the activated SCells of this TAG (or the sTAG) as a timing reference cell.

Timing advance updates may be signaled/indicated by the base station to the wireless device via MAC CE commands. Based on receiving the MAC CE commands, the wireless device may start or restart a TAG-specific timer (e.g., time alignment timer). The TAG-specific timer may indicate whether the L1 of the wireless device is synchronised or not. For example, when the TAG-specific timer is running, the L1 may be (considered) synchronised. When the TAG-specific timer is not running, the L1 may be (considered) non-synchronised. When the L1 is non-synchronised, the wireless device may transmit/perform an uplink transmission through/via MSG1/MSGA. When the L1 is non-synchronised, the wireless device may not transmit/perform an uplink transmission through/via PUSCH/PUCCH/SRS.

For an inter-cell multi-DCI multi-TRP operation and an intra-cell multi-DCI multi-TRP operation, two TAGs with associated two TAG IDs may be configured per a serving cell. Each TAG of the two TAGs may be associated with a respective TAG ID of the two TAG IDs. Each uplink/joint TCI state may be associated with a respective TAG ID of the two TAG IDs. The wireless device may apply a timing advance of a TAG ID associated with an uplink/joint TCI state utilized for uplink transmission(s).

When two TAG IDs are configured for a serving cell, a TAG for which the timing advance command is applied, by the wireless device, may be indicated in a random access response message or in a MSGB.

When two TAG IDs are configured for a PCell, both TAGs may be regarded as primary TAG.

If a wireless device is configured/indicated by a higher layer parameter PDCCH-Config that contains/comprises CORESETS with two different values of coresetPoolIndex for an active downlink BWP of a serving cell, or if a wireless device is configured with a higher layer parameter SSB-MTC-AddtionalPCI and with a higher layer parameter PDCCH-Config that contains/comprises two different values of coresetPoolIndex in a higher layer parameter ControlResourceSet, and if the wireless device is configured with two TAGs and is configured with a higher layer parameter dl-OrJointTCI-StateList or a higher layer parameter TCI-UL-State for a serving cell, each TCI-State or TCI-UL-State may be associated with a respective TAG of the two TAGs of the serving cell for determining timing adjustment for a corresponding uplink transmission. The UE may not expect that TCI-states or TCI-UL-States associated with one coresetPoolIndex to correspond to two TAGs, except if reported by a UE capability.

When a wireless device receives a timing advance command in a random access response message for a serving cell configured with two TAGs or in a MSGB for an SpCell configured with two TAGs, the wireless device may:
if the Random Access Preamble was not selected by the wireless device among the contention-based Random Access Preamble:
apply the Timing Advance Command for a TAG indicated in the received Random Access Response message or MSGB;
start or restart a timeAlignmentTimer associated with the TAG indicated in the received Random Access Response message or MSGB.
else if a timeAlignmentTimer associated with the TAG indicated in the received Random Access Response message or MSGB is not running:
apply the timing advance command for the TAG;
start a timeAlignmentTimer associated with the TAG;
when a Contention Resolution is considered not successful:
stop a timeAlignmentTimer associated with the TAG.
else:
ignore the received timing advance command.

When a wireless device receives an absolute timing advance command MAC CE indicating a timing advance command in response to a MSGA transmission including C-RNTI MAC CE, for an SpCell configured with two TAGS, the wireless device may:
Apply the timing advance command for a PTAG indicated in the absolute timing advance command MAC CE;
start or restart a timeAlignmentTimer associated with the PTAG.

A wireless device may not perform any uplink transmission except the Random Access Preamble and MSGA transmission on a serving cell using TCI state(s) associated with a TAG for which the timeAlignmentTimer is not running.

A wireless device may be indicated/provided/configured, by a higher layer parameter LTM-Config, candidate cells and SS/PBCH blocks per candidate cell for the wireless device to obtain synchronization and measure corresponding L1-RSRPs. A MAC CE command may activate TCI states, provided/configured/indicated by a higher layer parameter LTM-Candidate-TCI-State or/and LTM-Candidate-TCI-UL-State, associated with SS/PBCH blocks or TRS of corresponding candidate cells. The wireless device may be provided/indicated/configured configurations by a higher layer parameter LTM-CSI-ReportConfigToAddModList for reporting L1-RSRP measurements that include a number of candidate cells and a number of SS/PBCH blocks per candidate cell from the number of candidate cells.

A wireless device may be provided/indicated, by a MAC CE in a PDSCH reception on/via/in a serving cell, a TCI-State and/or TCI-UL-State in/from a higher layer parameter LTM-dl-OrJointTCI-State ToAddModList and/or a higher layer parameter LTM-ul-TCI-ToAddModList. The TCI-State and/or the TCI-UL-State may indicate a unified TCI state for applicable receptions or transmissions on a candidate cell from the number of candidate cells. The wireless device may apply the TCI-State and/or the TCI-UL-State, if indicated by the MAC CE, from a first slot that is a number of slots after the last symbol of a PUCCH or PUSCH with HARQ-ACK information for the PDSCH providing/indicating/carrying the MAC CE. If the MAC CE triggers a PRACH transmission, the wireless device may apply the TCI-State for receptions on/via the candidate cell, and may apply a spatial domain filter corresponding to the TCI-State or the TCI-UL-State for transmissions on/via the candidate cell, that are after the completion of a random access procedure associated with the PRACH transmission on the candidate cell and before a new TCI state is indicated for the candidate cell.

For an uplink grant configured for configured grant Type 1 for LTM cell switch, when there is an on-going RACH-less LTM cell switch procedure, for each valid configured uplink grant, a wireless device may:
if an SSB corresponding to the configured UL grant has the same SSB index as the SSB associated with the TCI state indicated by an LTM Cell Switch Command MAC CE (or a cell switch command):
select the SSB associated with the TCI state indicated by the LTM Cell Switch Command MAC CE.
indicate the SSB index to a lower layer (e.g., physical layer);
consider the configured uplink grant as valid.
else:
consider the configured uplink grant as not valid.

A base station (e.g., a network) may instruct a wireless device to perform an LTM cell switch procedure by sending an LTM Cell Switch Command MAC CE. The LTM Cell Switch Command MAC CE may indicate a TCI state.

When the wireless device receives the LTM Cell Switch Command MAC CE, the wireless device may consider an SSB associated with (or corresponding to) to the indicated TCI state as the one used for a configured uplink grant selection for the initial uplink transmission towards/to/via the candidate cell for a RACH-less LTM cell switch.

The LTM Cell Switch Command MAC CE may comprise a TCI state identifier/index (e.g., TCI state ID, UL TCI state ID) indicating/identifying a TCI state. The TCI state identifier/index may indicate and/or activate the TCI state for the candidate cell (or the LTM target cell). The LTM Cell Switch Command MAC CE may comprise a target configuration identifier indicating the candidate cell.

A L1/L2 Triggered Mobility may be a cell switch procedure that the network (or the base station) triggers via MAC CE based on L1 measurements.

In a Layer 1 (L1)/Layer 2 (L2) triggered mobility (LTM) procedure, a base station may receive L1 measurement report(s) from a wireless device. Based on the L1 measurement report(s), the base station may change a serving cell of the wireless device to a target cell (or a candidate cell or an LTM candidate cell) by sending/transmitting a cell switch command signaled via a MAC CE (e.g., LTM Cell Switch Command MAC CE). The cell switch command may indicate an LTM candidate cell configuration that the base station previously prepared and sent/transmitted/provided to the wireless device through RRC signalling. Based on receiving the cell switch command, the wireless device may switch to the target cell. The LTM procedure may be used to reduce the mobility latency.

The cell switch command may trigger a cell switch by including a candidate configuration index of the target cell. The wireless device may switch to the target cell and may apply the configuration indicated by candidate configuration index.

The base station may request, by/through a PDCCH order or through UE-based TA measurement, the wireless device to perform early timing advance (TA) acquisition of a candidate cell before a cell switch. The early TA acquisition may be triggered by PDCCH order and/or through UE-based TA measurement.

In the UE-based TA measurement, the wireless device may derive a TA value of a candidate cell based on receiving/reception (Rx) timing difference between a current serving cell and the candidate cell as well as TA value for the current serving cell.

The base station may indicate in the cell switch command whether the wireless device accesses the target cell with a RA procedure if a TA value is not provided/included in the cell switch command, or with a PUSCH transmission using a TA value indicated in the cell switch command. For an RACH-less LTM, the wireless device may either monitor PDCCH for dynamic scheduling from the target cell upon LTM cell switch, or may select a configured grant occasion associated with the beam indicated in the cell switch command.

A supervision timer may be used to detect failure of a cell switch of the LTM procedure. For example, the LTM procedure may fail if the supervision timer expires. The wireless device may initiate an RRC connection reestablishment procedure based on ean expiry of the supervision timer.

The cell switch command may be conveyed in a MAC CE. The cell switching command may include/comprise/contain the necessary information to perform the LTM cell switch.

The LTM procedure may support, for example, intra-gNB-DU. The LTM procedure may support, for example intra-gNB-CU inter-gNB-DU mobility. The LTM procedure may support inter-frequency mobility, including mobility to inter-frequency cell that is not a current serving cell. The following scenarios may be supported:
PCell change in non-CA scenario,
PCell change in carrier aggregation (CA) scenario,
Dual connectivity scenario, at least for the PSCell change without MN involvement case, i.e. intra-SN PSCell change.

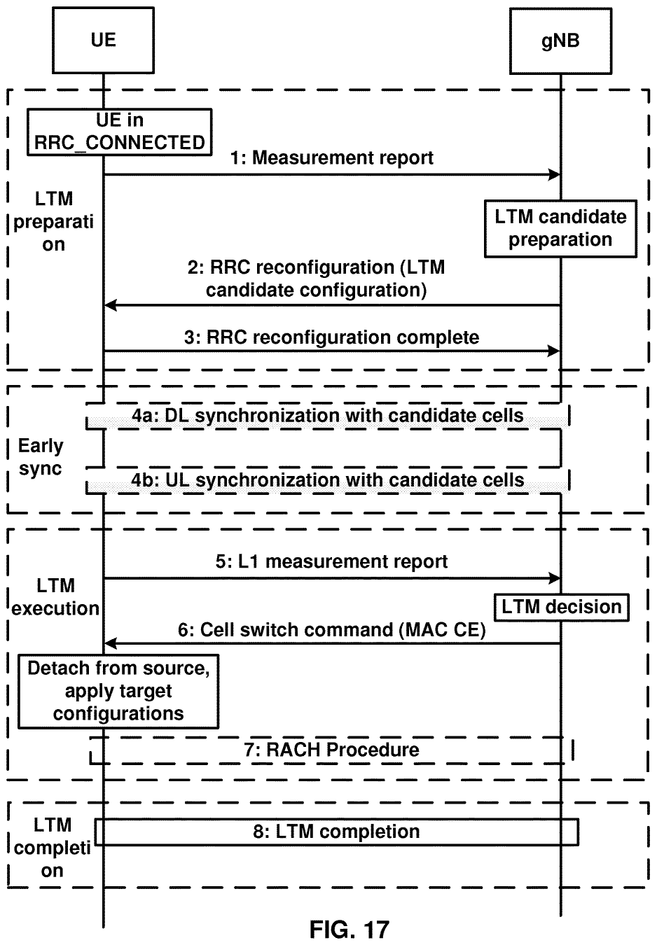

FIG. 17 illustrates an example of LTM procedure as per an aspect of an embodiment of the present disclosure.

The procedure for LTM may be as follows:
1. The wireless device (e.g., UE) may send a MeasurementReport message to the base station (e.g., gNB). The base station may decide to configure LTM and may initiate candidate cell(s) preparation.
2. The base station may transmit an RRCReconfiguration message, to the wireless device, including/comprising LTM candidate cell configuration(s) of one or multiple candidate cells.
3. The wireless device may store the LTM candidate cell configuration(s) and may transmit an RRCReconfiguration Complete message to the base station
4a. The wireless device may perform downlink (DL) synchronization with candidate cell(s) before receiving a cell switch command.
4b. The wireless device may performs early TA acquisition with candidate cell(s) requested by the base station before receiving the cell switch command. This may be done via contention-free random-access (CFRA) triggered by a PDCCH order from the source cell, following which the wireless device sends preamble towards the indicated candidate cell. In order to minimize the data interruption of the source cell due to the CFRA towards the candidate cell(s), the wireless device may not receive RAR for the purpose of TA value acquisition and the TA value of the candidate cell is indicated in the cell switch command. The wireless device may not maintain the TA timer for the candidate cell and may rely on network implementation to guarantee the TA validity.
5. The wireless device may perform L1 measurements on the configured candidate cell(s), and may transmit lower-layer measurement reports to the base station.
6. The base station may decide to execute cell switch to a target cell, and may transmit a MAC CE triggering cell switch by including the candidate configuration index of the target cell. The wireless device may switch to the target cell and may apply the configuration indicated by candidate configuration index.
7. The wireless device may perform a random access procedure towards the target cell, if wireless device does not have valid TA of the target cell.
8. The wireless device may complete the LTM cell switch procedure, for example, by sending RRCReconfiguration Complete message to target cell. If the wireless device has performed a random-access procedure in step 7, the wireless device may consider that LTM execution is successfully completed when the random access procedure is successfully completed. For RACH-less LTM, the wireless device may consider that LTM execution is successfully completed when the wireless device determines that the network has successfully received its first uplink (UL) data.

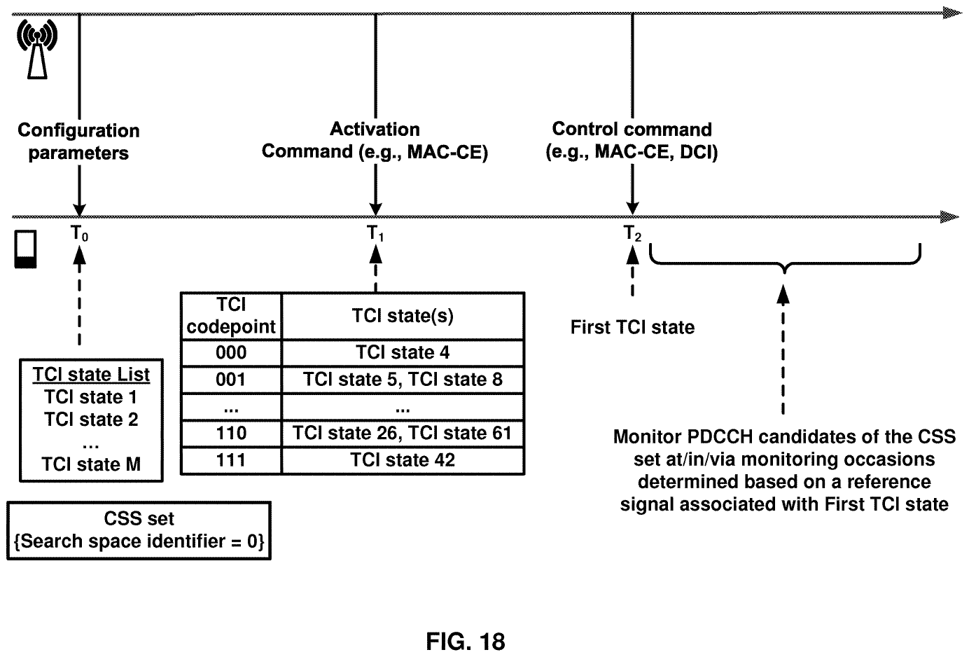

FIG. 18 illustrates an example of downlink control channel monitoring as per an aspect of an embodiment of the present disclosure.

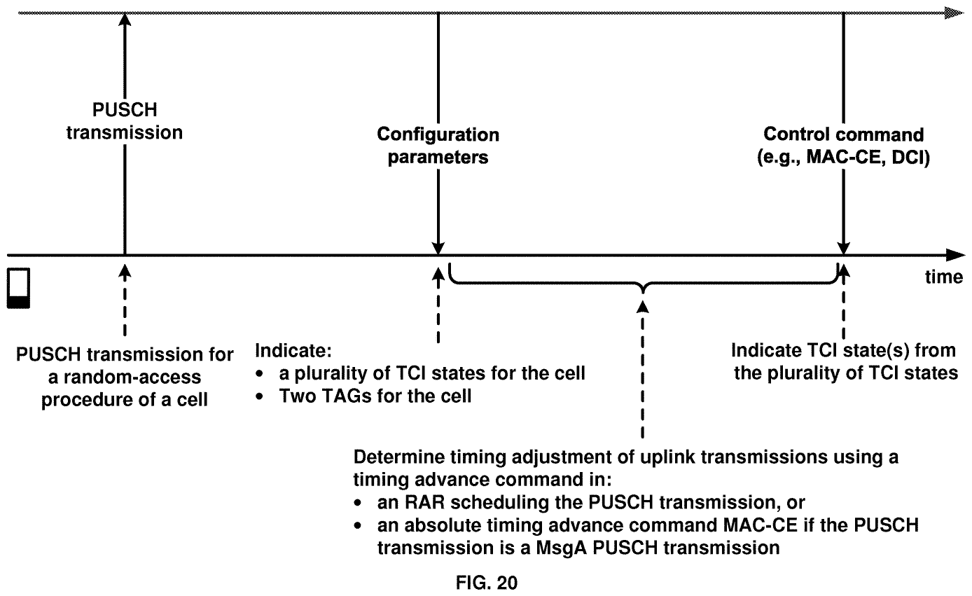

FIG. 20 illustrates an example of timing advance as per an aspect of an embodiment of the present disclosure.

In an example, a wireless device may receive one or more messages. In an example, the wireless device may receive the one or more messages from a base station. In an example, the wireless device may receive the one or more messages from a relay node. In an example, the wireless device may receive the one or more messages from another wireless device (e.g., TRP, vehicle, remote radio head, and the like). The one or more messages may comprise one or more configuration parameters (e.g., Configuration parameters at time TO in FIG. 18 and FIG. 20). In an example, the one or more configuration parameters may be RRC configuration parameter(s). In an example, the one or more configuration parameters may be RRC reconfiguration parameter(s).

In an example, the one or more configuration parameters may be for one or more cells.

The one or more cells may comprise a cell. The cell may be, for example, a serving cell. In an example, at least one configuration parameter of the one or more configuration parameters may be for the cell. In an example, the cell may be a primary cell (PCell). In an example, the cell may be a secondary cell (SCell). The cell may be a secondary cell configured with PUCCH (e.g., PUCCH SCell).

In an example, the cell may be a special Cell (SpCell). For dual connectivity (DC) operation, the SpCell may refer to (or indicate) the PCell of the MCG or the PSCell of the SCG, otherwise the SpCell may refer to (or indicate) the PCell.

In an example, the cell may be a primary SCG cell (PSCell). For dual connectivity operation, the wireless device may, for example, perform a random-access procedure via the PSCell when performing the Reconfiguration with Sync procedure.

In an example, the cell may be a non-serving cell (e.g., a neighbor cell). The cell may be a layer 1/layer 2 triggered mobility (LTM) candidate cell. The cell may be a candidate cell for an LTM procedure. The cell may be a target cell for an LTM procedure. The cell may be an LTM target cell. The cell may be an LTM candidate cell.

In an example, the cell may be an unlicensed cell, e.g., operating in an unlicensed band. In an example, the cell may be a licensed cell, e.g., operating in a licensed band. In an example, the cell may operate in a first frequency range (FR1). The FR1 may, for example, comprise frequency bands below 6 GHZ. In an example, the cell may operate in a second frequency range (FR2). The FR2 may, for example, comprise frequency bands from 24 GHz to 52.6 GHZ. In an example, the cell may operate in a third frequency range (FR3). The FR3 may, for example, comprise frequency bands from 52.6 GHz to 71 GHz. The FR3 may, for example, comprise frequency bands starting from (or above) 52.6 GHZ.

In an example, the wireless device may perform uplink transmissions (e.g., PUSCH, PUCCH, PUCCH) via/of the cell in a first time and in a first frequency. The wireless device may perform downlink receptions (e.g., PDCCH, PDSCH) via/of the cell in a second time and in a second frequency. In an example, the cell may operate in a time-division duplex (TDD) mode. In the TDD mode, the first frequency and the second frequency may be the same. In the TDD mode, the first time and the second time may be different. In an example, the cell may operate in a frequency-division duplex (FDD) mode. In the FDD mode, the first frequency and the second frequency may be different. In the FDD mode, the first time and the second time may be the same.

In an example, the wireless device may be in an RRC connected mode. In an example, the wireless device may be in an RRC idle mode. In an example, the wireless device may be in an RRC inactive mode.

In an example, the cell may comprise a plurality of BWPs. The plurality of BWPs may comprise one or more uplink BWPs comprising an uplink BWP of the cell. The plurality of BWPs may comprise one or more downlink BWPs comprising a downlink BWP of the cell.

In an example, a BWP of the plurality of BWPs may be in one of an active state and an inactive state. In an example, in the active state of a downlink BWP of the one or more downlink BWPs, the wireless device may monitor a downlink channel/signal (e.g., PDCCH, DCI, CSI-RS, PDSCH) on/for/via the downlink BWP. In an example, in the active state of a downlink BWP of the one or more downlink BWPs, the wireless device may receive a PDSCH on/via/for the downlink BWP. In an example, in the inactive state of a downlink BWP of the one or more downlink BWPs, the wireless device may not monitor a downlink channel/signal (e.g., PDCCH, DCI, CSI-RS, PDSCH) on/via/for the downlink BWP. In the inactive state of a downlink BWP of the one or more downlink BWPs, the wireless device may stop monitoring (or receiving) a downlink channel/signal (e.g., PDCCH, DCI, CSI-RS, PDSCH) on/via/for the downlink BWP. In an example, in the inactive state of a downlink BWP of the one or more downlink BWPs, the wireless device may not receive a PDSCH on/via/for the downlink BWP. In the inactive state of a downlink BWP of the one or more downlink BWPs, the wireless device may stop receiving a PDSCH on/via/for the downlink BWP.

In an example, in the active state of an uplink BWP of the one or more uplink BWPs, the wireless device may transmit an uplink signal/channel (e.g., PUCCH, preamble, PUSCH, PRACH, PUCCH, etc) on/via the uplink BWP. In an example, in the inactive state of an uplink BWP of the one or more uplink BWPs, the wireless device may not transmit an uplink signal/channel (e.g., PUCCH, preamble, PUSCH, PRACH, PUCCH, etc) on/via the uplink BWP.

In an example, the wireless device may activate the downlink BWP of the one or more downlink BWPs of the cell. In an example, the activating the downlink BWP may comprise setting (or switching to) the downlink BWP as an active downlink BWP of the cell. In an example, the activating the downlink BWP may comprise setting the downlink BWP in the active state. In an example, the activating the downlink BWP may comprise switching the downlink BWP from the inactive state to the active state.

In an example, the wireless device may activate the uplink BWP of the one or more uplink BWPs of the cell. In an example, the activating the uplink BWP may comprise that the wireless device sets (or switches to) the uplink BWP as an active uplink BWP of the cell. In an example, the activating the uplink BWP may comprise setting the uplink BWP in the active state. In an example, the activating the uplink BWP may comprise switching the uplink BWP from the inactive state to the active state.

In an example, the one or more configuration parameters may be for the (active) downlink BWP of the cell. In an example, at least one configuration parameter of the one or more configuration parameters may be for the downlink BWP of the cell.

In an example, the one or more configuration parameters may be for the (active) uplink BWP of the cell. In an example, at least one configuration parameter of the one or more configuration parameters may be for the uplink BWP of the cell.

The one or more configuration parameters may indicate a subcarrier spacing (or a numerology) for the downlink BWP.

The one or more configuration parameters may indicate a subcarrier spacing (or a numerology) for the uplink BWP.

A value of the subcarrier spacing (of the downlink BWP and/or the uplink BWP) may be/indicate, for example, 15 kHz (mu=0). A value of the subcarrier spacing may be/indicate, for example, 30 kHz (mu=1). A value of the subcarrier spacing may be/indicate, for example, 60 kHz (mu=2). A value of the subcarrier spacing may be/indicate, for example, 120 kHz (mu=3). A value of the subcarrier spacing may be/indicate, for example, 240 kHz (mu=4). A value of the subcarrier spacing may be/indicate, for example, 480 kHz (mu=5). A value of the subcarrier spacing may be/indicate, for example, 960 kHz (mu=6). For example, 480 kHz may be valid/applicable in FR3. For example, 960 kHz may be valid/applicable in FR3. For example, 240 KHz may be valid/applicable in FR3. For example, 120 KHz may be valid/applicable in FR3.

The one or more configuration parameters may indicate a plurality of TCI states for the cell. The one or more configuration parameter may comprise a TCI state list parameter (e.g., provided by a higher layer (e.g., RRC) parameter dl-OrJoint-TCIStateList) indicating a TCI state list (e.g., TCI state list in FIG. 18). The TCI state list may comprise the plurality of TCI states. The one or more configuration parameters may comprise one or more PDSCH configuration parameters (e.g., PDSCH-Config), for example, comprising the TCI state list parameter that indicates the plurality of TCI states. For example, in FIG. 18, the plurality of TCI states in the TCI state list are TCI state 1, . . . , TCI state M. For example, in FIG. 18, the plurality of TCI states are ‘a plurality of cells for the cell’.

The one or more configuration parameters may indicate, for the plurality of TCI states, a plurality of TCI state indexes/identifiers/identities (e.g., TCI-StateId). The one or more configuration parameters may indicate, for each TCI state of the plurality of TCI states, a respective TCI state index of the plurality of TCI state indexes. Each TCI state of the plurality of TCI states may be indicated/identified by a respective TCI state index of the plurality of TCI state indexes. For example, the one or more configuration parameters may indicate, for a first TCI state of the plurality of TCI states, a first TCI state index of the plurality of TCI state indexes. The one or more configuration parameters may indicate, for a second TCI state of the plurality of TCI states, a second TCI state index of the plurality of TCI state indexes.

The one or more configuration parameters may indicate the plurality of TCI states that indicate a unified TCI state for the cell.

The one or more configuration parameters may comprise the one or more PDSCH configuration parameters, for example, for/of a downlink BWP (e.g., an active downlink BWP) of the cell. The one or more configuration parameters indicate the plurality of TCI states for the downlink BWP of the cell.

The one or more configuration parameters may comprise the one or more PDSCH configuration parameters, for example, for a second downlink BWP of a second cell. The one or more cells may comprise the second cell. The one or more configuration parameters indicate the plurality of TCI states for the second downlink BWP of the second cell. The one or more configuration parameters may comprise, for/of the downlink BWP of the cell, a reference unified TCI state list parameter (e.g., unifiedTCI-StateRef) indicating the second downlink BWP of the second cell. The reference unified TCI state list parameter may comprise a BWP index (e.g., BWP-Id) identifying/indicating the second downlink BWP. The reference unified TCI state list parameter may comprise a cell index (e.g., ServCellIndex) identifying/indicating the second cell. The second downlink BWP of the second cell may be a reference BWP of a reference cell for the downlink BWP of the cell. The downlink BWP of the cell may be a target BWP of a target cell. The one or more PDSCH configuration parameters of the downlink BWP of the cell may not comprise a higher layer (e.g., RRC) parameter di-OrJoint-TCIStateList, for example, based on the one or more configuration parameters comprising, for the downlink BWP of the cell, the reference unified TCI state list parameter.

The one or more configuration parameters may comprise a unified-TCI-state-type parameter (e.g., unifiedtci-State Type). The one or more configuration parameters may comprise one or more serving cell parameters (e.g., ServingCellConfig) comprising the unified-TCI-state-type parameter. The unified-TCI-state-type parameter may indicate the unified TCI state type of the cell.

For example, unified-TCI-state-type parameter may be set to “Joint”. The wireless device may use/apply the plurality of TCI states (e.g., provided/indicated by dl-OrJoint-TCIStateList) for both uplink transmissions (e.g., PUSCH/PUCCH/SRS transmissions) of/via the cell and downlink receptions (e.g., PDCCH/PDSCH/CSI-RS receptions) of/via the cell, for example, based on the one or more configuration parameters comprising the unified-TCI-state-type parameter set to “Joint”. The plurality of TCI states may be, for example, a plurality of joint TCI states.

For example, unified-TCI-state-type parameter may be set to “Separate”. The wireless device may use/apply the plurality of TCI states (e.g., provided/indicated by a higher layer parameter dl-OrJoint-TCIStateList) for downlink receptions (e.g., PDCCH/PDSCH/CSI-RS receptions) of/via the cell, for example, based on the one or more configuration parameters comprising the unified-TCI-state-type parameter set to “Separate”. The wireless device may not use/apply the plurality of TCI states for uplink transmissions (e.g., PUSCH/PUCCH/SRS transmissions) of/via the cell, for example, based on the one or more configuration parameters comprising the unified-TCI-state-type parameter set to “Separate”. The plurality of TCI states may be, for example, a plurality of downlink TCI states.

The one or more configuration parameters may indicate a second plurality of TCI states. The one or more configuration parameters may comprise an uplink TCI state list parameter (e.g., provided/indicated by a higher layer parameter ul-TCI-StateList) indicating an uplink TCI state list. The uplink TCI state list may comprise the second plurality of TCI states. The one or more configuration parameters may comprise one or more uplink BWP configuration parameters comprising the uplink TCI state list parameter that indicates the second plurality of TCI states. For example, in FIG. 18, the second plurality of TCI states are TCI state 1, . . . , TCI state M.

The one or more configuration parameters may comprise the one or more uplink BWP configuration parameters, for example, for an uplink BWP (e.g., an active uplink BWP) of the cell. The one or more configuration parameters indicate the second plurality of TCI states for the uplink BWP of the cell.

The one or more configuration parameters may comprise the one or more uplink BWP configuration parameters, for example, for a second uplink BWP of a second cell. The one or more configuration parameters indicate the second plurality of TCI states for the second uplink BWP of the second cell. The one or more configuration parameters may comprise, for the uplink BWP of the cell, a reference unified TCI state list parameter (e.g., unifiedtci-State Type) indicating the second uplink BWP of the second cell. The reference unified TCI state list parameter may comprise a BWP index (e.g., BWP-Id) identifying/indicating the second uplink BWP. The reference unified TCI state list parameter may comprise a cell index (e.g., ServCellIndex) identifying/indicating the second cell. The second uplink BWP of the second cell may be a reference BWP of a reference cell for the uplink BWP of the cell. The uplink BWP of the cell may be a target BWP of a target cell. The one or more uplink BWP configuration parameters of the uplink BWP of the cell may not comprise a higher layer (e.g., RRC) parameter ul-TCI-StateList, for example, based on the one or more configuration parameters comprising, for the uplink BWP of the cell, the reference unified TCI state list parameter.

The wireless device may use/apply the second plurality of TCI states for uplink transmissions (e.g., PUSCH/PUCCH/SRS transmissions) of/via the cell, for example, based on the one or more configuration parameters comprising the unified-TCI-state-type parameter set to “Separate”. The wireless device may not use/apply the second plurality of TCI states for downlink receptions (e.g., PDCCH/PDSCH/CSI-RS receptions) of/via the cell, for example, based on the one or more configuration parameters comprising the unified-TCI-state-type parameter set to “Separate”. The second plurality of TCI states may be, for example, a plurality of uplink TCI states.

In an example, the wireless device may use, for downlink receptions via the downlink BWP of the cell, the plurality of TCI states, for example based on the one or more configuration parameters indicating the plurality of TCI states for the downlink BWP of the cell.

In an example, the wireless device may use, for uplink transmissions receptions via the uplink BWP of the cell, the plurality of TCI states, for example based on the one or more configuration parameters indicating the plurality of TCI states for the downlink BWP of the cell.

In an example, the wireless device may use, for downlink receptions via the downlink BWP of the cell, the plurality of TCI states of the second downlink BWP of the second cell, for example, based on the reference unified TCI state list parameter indicating, for the downlink BWP of the cell, the second downlink BWP of the second cell.

In an example, the wireless device may use, for uplink transmissions receptions via the uplink BWP of the cell, the plurality of TCI states of the second downlink BWP of the second cell, for example, based on the reference unified TCI state list parameter indicating, for the downlink BWP of the cell, the second downlink BWP of the second cell.

In an example, the wireless device may use, for uplink transmissions receptions via the uplink BWP of the cell, the second plurality of TCI states, for example based on the one or more configuration parameters indicating the second plurality of TCI states for the uplink BWP of the cell.

In an example, the wireless device may use, for uplink transmissions receptions via the uplink BWP of the cell, the second plurality of TCI states of the second uplink BWP of the second cell, for example, based on the reference unified TCI state list parameter indicating, for the uplink BWP of the cell, the second uplink BWP of the second cell.

The cell may be served by a plurality of TRPs comprising a first TRP and a second TRP. The wireless device may be served by the plurality of TRPs via the cell.

The wireless device may receive, via the cell, a first downlink reception (e.g., PDSCH, PDCCH, CSI-RS) from the first TRP. The first TRP may transmit, to the wireless device, the first downlink reception. The wireless device may receive, via the cell, a second downlink reception (e.g., PDSCH, PDCCH, CSI-RS) from the second TRP. The second TRP may transmit, to the wireless device, the second downlink reception.

The wireless device may transmit, via the cell, a first uplink transmission (e.g., PUSCH, PUCCH, SRS) to the first TRP. The first TRP may receive, from the wireless device, the first uplink transmission. The wireless device may transmit, via the cell, a second uplink transmission (e.g., PUSCH, PUCCH, SRS) to the second TRP. The second TRP may receive, from the wireless device, the second uplink transmission.

In an example, the wireless device may receive one or more activation commands (e.g., MAC-CE, DCI, RRC, one or more control commands, one or more downlink control commands/messages, one or more control commands/messages, Unified TCI States Activation/Deactivation MAC CE, Enhanced Unified TCI States

Activation/Deactivation MAC CE, The Enhanced Unified TCI States Activation/Deactivation MAC-CE for Joint TCI State Mode, Enhanced Unified TCI States Activation/Deactivation MAC-CE for Separate TCI State Mode and the like at time T1 in FIG. 18).

The one or more activation commands may be an activation command (or a single activation command or one activation command, Activation command in FIG. 18), for example, when the one or more configuration parameters do not indicate two different values of coreset pool index for coreset(s) in the downlink BWP of the cell. The one or more configuration parameters may not comprise one or more PDCCH configuration parameters (e.g., PDCCH-Config) that contain/comprise two different values of a higher layer parameter CORESETPoolIndex in different coresets (e.g., ControlResourceSets) of the downlink BWP of the cell.

The one or more activation commands may be at least two activation commands, for example, when the one or more configuration parameters indicate two different values of coreset pool index for coreset(s) in the downlink BWP of the cell. The one or more configuration parameters may comprise one or more PDCCH configuration parameters (e.g., PDCCH-Config) that contain/comprise two different values of a higher layer parameter CORESETPoolIndex in different coresets (e.g., ControlResourceSets) of the downlink BWP of the cell. The at least two activation commands may comprise a first activation command and a second activation command.

For example, the one or more activation commands may indicate activation of a subset of TCI states of the plurality of TCI states (e.g., DLorJoint-TCIStateList). The subset of TCI states may be, for example, a subset of joint TCI states of the plurality of joint TCI states. The subset of TCI states may be, for example, a subset of downlink TCI states of the plurality of downlink TCI states.

For example, the one or more activation commands may indicate activation of a subset of TCI states of the second plurality of TCI states (e.g., ul-TCI-StateList). The subset of TCI states may be, for example, a subset of uplink TCI states of the plurality of uplink TCI states.

When the one or more configuration parameters comprise one or more PDCCH configuration parameters (e.g., PDCCH-Config) that contain/comprise two different values of a higher layer parameter CORESETPoolIndex in different coresets (e.g., ControlResourceSets), the subset of TCI states may comprise one or more first TCI states associated with a first coreset pool index (e.g., CoresetPoolIndex=0) and one or more second TCI states associated with a second coreset pool index (e.g., CoresetPoolIndex=1). For example, the first activation command of the one or more activation commands may indicate activation of the one or more first TCI states for the first coreset pool index (e.g., CoresetPoolIndex=0). The first activation command may comprise a field set to the first coreset pool index. The one or more first TCI states may be for (or associated) with the first TRP. The second activation command of the one or more activation commands may indicate activation of the one or more second TCI states for the second coreset pool index (e.g., CoresetPoolIndex=1). The second activation command may comprise a field set to the second coreset pool index. The one or more second TCI states may be for (or associated) with the second TRP.

The base station may activate and/or deactivate the subset of TCI states, for example, by sending/transmitting the one or more activation commands.

The wireless device may map the subset of TCI states to one or more TCI codepoints of/for the cell. The one or more activation commands may indicate mapping of the subset of TCI states to the one or more TCI codepoints. The wireless device may map respective TCI state(s) of the subset of TCI states to a respective TCI codepoint of the one or more TCI codepoints. The one or more TCI codepoints may indicate/comprise the subset of TCI states. Each TCI codepoint of the one or more TCI codepoints may indicate (or may be mapped to) respective TCI state(s) of the subset of TCI states. Each TCI codepoint of the one or more TCI codepoints may indicate/comprise (or be mapped to) one or more TCI states.

For example, in FIG. 18, the one or more TCI codepoints are TCI codepoint 000, TCI codepoint 001, . . . , TCI codepoint 110, and TCI codepoint 111. The subset of TCI states are TCI state 4, TCI state 5, TCI state 8, . . . , TCI state 26, TCI state 61, and TCI state 42. TCI codepoint 000 may comprise/indicate (or may be mapped to) TCI state 4. TCI codepoint 001 may comprise/indicate (or may be mapped to) TCI state 5 and TCI state 8. TCI codepoint 110 may comprise/indicate (or may be mapped to) TCI state 26 and TCI state 61. TCI codepoint 111 may comprise/indicate (or may be mapped to) TCI state 42. For example, TCI codepoint 000 and TCI codepoint 111 indicate a single TCI state (e.g., a single joint TCI state, a single downlink TCI state, a single uplink TCI state, and the like). TCI codepoint 001 and TCI codepoint 110 indicate two TCI states (e.g., two joint TCI states, two uplink TCI states, two downlink TCI states, and the like).

When the one or more configuration parameters comprise one or more PDCCH configuration parameters (e.g., PDCCH-Config) that contain/comprise two different values of a higher layer parameter CORESETPoolIndex in different coresets (e.g., ControlResourceSets), the wireless device may map the one or more first TCI states to one or more first TCI codepoints. The one or more TCI codepoints may comprise the one or more first TCI codepoints. The first activation command may indicate mapping of the one or more first TCI states to the one or more first TCI codepoints. The wireless device may map each TCI state of the one or more first TCI states to a respective TCI codepoint of the one or more first TCI codepoints. The one or more first TCI codepoints may indicate/comprise the one or more first TCI states. Each TCI codepoint of the one or more first TCI codepoints may indicate (or may be mapped to) respective TCI state of the one or more first TCI states. Each TCI codepoint of the one or more first TCI codepoints may indicate/comprise (or be mapped to) one TCI state.

In an example, the one or more first TCI states may be TCI state 4, TCI state 5, TCI state 26, and TCI state 49. The one or more first TCI codepoints may/be comprise a first TCI codepoint (e.g., TCI codepoint 000), a second TCI codepoint (e.g., TCI codepoint 001), a third TCI codepoint (e.g., TCI codepoint 010), and a fourth TCI codepoint (e.g., TCI codepoint 011). The first TCI codepoint (e.g., TCI codepoint 000) may comprise/indicate the TCI state 4. The second TCI codepoint (e.g., TCI codepoint 001) may comprise/indicate the TCI state 5. The third TCI codepoint (e.g., TCI codepoint 010) may comprise/indicate TCI state 26. The fourth TCI codepoint (e.g., TCI codepoint 011) may comprise/indicate the TCI state 49. For example, each TCI codepoint of the one or more first TCI codepoints may indicate a single TCI state (e.g., one joint TCI state, one uplink TCI state, one downlink TCI state, and the like).

When the one or more configuration parameters comprise one or more PDCCH configuration parameters (e.g., PDCCH-Config) that contain/comprise two different values of a higher layer parameter CORESETPoolIndex in different coresets (e.g., ControlResourceSets), the wireless device may map the one or more second TCI states to one or more second TCI codepoints. The one or more TCI codepoints may comprise the one or more second TCI codepoints. The second activation command may indicate mapping of the one or more second TCI states to the one or more second TCI codepoints. The wireless device may map each TCI state of the one or more second TCI states to a respective TCI codepoint of the one or more second TCI codepoints. The one or more second TCI codepoints may indicate/comprise the one or more second TCI states. Each TCI codepoint of the one or more second TCI codepoints may indicate (or may be mapped to) respective TCI state of the one or more second TCI states. Each TCI codepoint of the one or more second TCI codepoints may indicate/comprise (or be mapped to) one TCI state.

In an example, the one or more second TCI states may be TCI state 8, TCI state 14, TCI state 33, and TCI state 61. The one or more second TCI codepoints may/be comprise a first TCI codepoint (e.g., TCI codepoint 000), a second TCI codepoint (e.g., TCI codepoint 001), a third TCI codepoint (e.g., TCI codepoint 010), and a fourth TCI codepoint (e.g., TCI codepoint 011). The first TCI codepoint (e.g., TCI codepoint 000) may comprise/indicate the TCI state 8. The second TCI codepoint (e.g., TCI codepoint 001) may comprise/indicate the TCI state 14. The third TCI codepoint (e.g., TCI codepoint 010) may comprise/indicate TCI state 33. The fourth TCI codepoint (e.g., TCI codepoint 011) may comprise/indicate the TCI state 61. For example, each TCI codepoint of the one or more second TCI codepoints may indicate a single TCI state (e.g., one joint TCI state, one uplink TCI state, one downlink TCI state, and the like).

The activation command (e.g., Activation command in FIG. 18) indicating activation of the subset of TCI states of the plurality of TCI states may comprise a plurality of fields.

For example, in FIG. 18, TCI codepoint 000 may comprise/indicate TCI state 4. TCI state 4 may be mapped to TCI codepoint 000. TCI codepoint 001 may comprise/indicate TCI state 5 and TCI state 8. TCI state 5 and TCI state 8 may be mapped to the second TCI codepoint (e.g., TCI codepoint 001), and so on.

In an example, the activation command may comprise a TCI state index/identifier/identity (e.g., TCI state ID1,1) of TCI state 5 and a TCI state index/identifier/identity (e.g., TCI state ID1,2) of TCI state 8. TCI state 5 may be the first TCI state and TCI state 8 may be the second TCI state, for example, based on the TCI state index/identifier/identity (e.g., TCI state ID1,1) of TCI state 5 occurring/being/positioned in a lower octet in the activation command than the TCI state index/identifier/identity (e.g., TCI state ID1,2) of TCI state 8. For example, Octet 4 of the activation command may comprise the TCI state index/identifier/identity (e.g., TCI state ID1,1) of TCI state 5 and Octet 5 of the activation command may comprise the TCI state index/identifier/identity (e.g., TCI state ID1,2) of TCI state 8.

In an example, the activation command may comprise a TCI state index/identifier/identity (e.g., TCI state ID1,1) of TCI state 8 and a TCI state index/identifier/identity (e.g., TCI state ID1,2) of TCI state 5. TCI state 8 may be the first TCI state and TCI state 5 may be the second TCI state, for example, based on the TCI state index/identifier/identity (e.g., TCI state ID1,1) of TCI state 8 occurring/being/positioned in a lower octet in the activation command than the TCI state index/identifier/identity (e.g., TCI state ID1,2) of TCI state 5. For example, Octet 4 of the activation command may comprise the TCI state index/identifier/identity (e.g., TCI state ID1,1) of TCI state 8 and Octet 5 of the activation command may comprise the TCI state index/identifier/identity (e.g., TCI state ID1,2) of TCI state 5.

For example, in FIG. 18, TCI codepoint 110 may comprise/indicate TCI state 26 and TCI state 61. TCI state 26 and TCI state 61 may be mapped to TCI codepoint 110.

In an example, the activation command may comprise a TCI state index/identifier/identity (e.g., TCI state ID7,1) of TCI state 26 and a TCI state index/identifier/identity (e.g., TCI state ID7,2) of TCI state 61. TCI state 26 may be the first TCI state and TCI state 61 may be the second TCI state, for example, based on the TCI state index/identifier/identity (e.g., TCI state ID7,1) of TCI state 26 occurring/being/positioned in a lower octet in the activation command than the TCI state index/identifier/identity (e.g., TCI state ID7,2) of TCI state 61. For example, Octet 6 of the activation command may comprise the TCI state index/identifier/identity (e.g., TCI state ID7,1) of TCI state 26 and Octet 7 of the activation command may comprise the TCI state index/identifier/identity (e.g., TCI state ID7,2) of TCI state 61.

In an example, the activation command may comprise a TCI state index/identifier/identity (e.g., TCI state ID7,1) of TCI state 61 and a TCI state index/identifier/identity (e.g., TCI state ID7,2) of TCI state 26. TCI state 61 may be the first TCI state and TCI state 26 may be the second TCI state, for example, based on the TCI state index/identifier/identity (e.g., TCI state ID7,1) of the TCI state 61 occurring/being/positioned in a lower octet in the activation command than the TCI state index/identifier/identity (e.g., TCI state ID7,2) of TCI state 26. For example, Octet 6 of the activation command may comprise the TCI state index/identifier/identity (e.g., TCI state ID7,1) of TCI state 61 and Octet 7 of the activation command may comprise the TCI state index/identifier/identity (e.g., TCI state ID7,2) of TCI state 26.

The first activation command may comprise a plurality of fields.

A field (e.g., Coreset pool index) of the plurality of fields of the first activation command may be/comprise a coreset pool index. When the field is set/equal to zero (e.g., CoresetPoolIndex=0), the first activation command may indicate/activate the one or more first TCI states for the first coreset pool index that is equal to zero. The one or more first TCI states may be associated with (or may correspond to) the first coreset pool index that is equal to zero. The wireless device may receive downlink receptions associated with the first coreset pool index, for example, based on the one or more first TCI states. The wireless device may transmit uplink transmissions associated with the first coreset pool index, for example, based on the one or more first TCI states.

The second activation command may comprise a plurality of fields.

A field (e.g., Coreset pool index) of the plurality of fields of the second activation command may be/comprise a coreset pool index. When the field is set/equal to one (e.g., CoresetPoolIndex=1), the second activation command may indicate/activate the one or more second TCI states for the second coreset pool index that is equal to one. The one or more second TCI states may be associated with (or may correspond to) the second coreset pool index that is equal to one. The wireless device may receive downlink receptions associated with the second coreset pool index, for example, based on the one or more second TCI states. The wireless device may transmit uplink transmissions associated with the second coreset pool index, for example, based on the one or more second TCI states.

The wireless device may receive one or more control commands (e.g., Control command at time T2 in FIG. 18).

In an example, the one or more control commands may be a control command (or a single control command or one control command). The one or more control commands may be a control command (e.g., Control command in FIG. 18 and FIG. 20), for example, when the one or more configuration parameters do not indicate two different values of coreset pool index for coreset(s) in the downlink BWP of the cell. The one or more configuration parameters may not comprise one or more PDCCH configuration parameters (e.g., PDCCH-Config) that contain/comprise two different values of a higher layer parameter CORESETPoolIndex in different coresets (e.g., ControlResourceSets) of the downlink BWP of the cell.

The control command may be, for example, a MAC-CE. The control command may be, for example, a DCI (e.g., DCI format 1_2/1_2). The control command may be, for example, a downlink control command/message (e.g., activation command).

In an example, the control command (e.g., Control command in FIG. 18 and FIG. 20) may indicate, for the cell, a first TCI state (e.g., First TCI state in FIG. 18) of the subset of TCI states. The control command may indicate, for the cell, the first TCI state among/from the plurality of TCI states. The wireless device may have the first TCI state for the cell, for example, based on the control command indicating, for the cell, the first TCI state.

In an example, the control command may indicate, for downlink receptions (e.g., PDCCH, PDSCH, CSI-RS) via the cell, the first TCI state.

In an example, the control command may indicate, for uplink transmissions (e.g., PUCCH, PUSCH, SRS) via the cell, the first TCI state.

In an example, the control command may indicate, for both uplink transmissions (e.g., PUCCH, PUSCH, SRS) via the cell and downlink receptions (e.g., PDCCH, PDSCH, CSI-RS) via the cell, the first TCI state.

In an example, a number of the one or more TCI codepoints may be equal to one (e.g., a single TCI codepoint). The single TCI codepoint may indicate the first TCI state. The control command indicating the first TCI state may be the activation command activating the subset of TCI states (e.g., Activation command in FIG. 18 is the same as Control command in FIG. 18 and FIG. 20), for example, based on the number of the one or more TCI codepoints being equal to one. The first TCI state may be the subset of TCI states, for example, based on the number of the one or more TCI codepoints being equal to one. The activation command may indicate the first TCI state based on the number of the one or more TCI codepoints being equal to one. The control command may be, for example, a MAC-CE.

In an example, a number of the one or more TCI codepoints may be more than one. The control command indicating the first TCI state may be different from the activation command activating the subset of TCI states, for example, based on the number of the one or more TCI codepoints being more than one. The wireless device may receive the control command after receiving the activation command. The control command may be, for example, a DCI (e.g., DCI format 1_1/1_2/1_3). The control command (e.g., DCI format 1_1/1_2/1_3) may comprise a TCI field indicating the first TCI state. A value of the TCI field (e.g., ‘111’) may be equal to a TCI codepoint (e.g., TCI codepoint 111 in FIG. 18), of the one or more TCI codepoints, indicating the first TCI state (e.g., TCI state 42 in FIG. 18). The control command may indicate, for the TCI field, the TCI codepoint. The first TCI state may be mapped to the TCI codepoint.

In an example, the control command (e.g., Control command in FIG. 18 and FIG. 20) may indicate, for the cell, at least two TCI states of the subset of TCI states. The control command may indicate, for the cell, the at least two TCI states among/from the plurality of TCI states. The at least two TCI states may comprise a first TCI state (e.g., First TCI state in FIG. 18) and a second TCI state. The first TCI state may be for (or associated with) the first TRP. The second TCI state may be for (or associated with) the second TRP. In an example, the one or more configuration parameters may comprise the TCI state list parameter (e.g., dl-OrJointTCI-StateList) for/of the cell. The wireless device may have the at least two TCI states for the cell, for example, based on the control command indicating, for the cell, the at least two TCI states. The at least two TCI states are two TCI states in FIG. 20.

In an example, the control command may indicate, for downlink receptions (e.g., PDCCH, PDSCH, CSI-RS) via the cell, the at least two TCI states.

In an example, the control command may indicate, for uplink transmissions (e.g., PUCCH, PUSCH, SRS) via the cell, the at least two TCI states.

In an example, the control command may indicate, for both uplink transmissions (e.g., PUCCH, PUSCH, SRS) via the cell and downlink receptions (e.g., PDCCH, PDSCH, CSI-RS) via the cell, the at least two TCI states.

In an example, a number of the one or more TCI codepoints may be equal to one (e.g., a single TCI codepoint). The single TCI codepoint may indicate the at least two TCI states. The control command indicating the at least two TCI states may be the activation command activating the subset of TCI states (e.g., Activation command in FIG. 18 is the same as Control command in FIG. 18 and FIG. 20), for example, based on the number of the one or more TCI codepoints being equal to one. The at least two TCI states may be the subset of TCI states, for example, based on the number of the one or more TCI codepoints being equal to one. The activation command may indicate the at least two TCI states based on the number of the one or more TCI codepoints being equal to one. The control command may be, for example, a MAC-CE.

In an example, a number of the one or more TCI codepoints may be more than one. The control command indicating the at least two TCI states may be different from the activation command activating the subset of TCI states, for example, based on the number of the one or more TCI codepoints being more than one. The wireless device may receive the control command after receiving the activation command. The control command may be, for example, a DCI (e.g., DCI format 1_1/1_2/1_3). The control command (e.g., DCI format 1_1/1_2/1_3) may comprise a TCI field indicating the at least two TCI states. A value of the TCI field (e.g., ‘110’) may be equal to a TCI codepoint (e.g., TCI codepoint 110 in FIG. 18), of the one or more TCI codepoints, indicating the at least two TCI states (e.g., TCI state 26 and TCI state 61 in FIG. 18). The control command may indicate, for the TCI field, the TCI codepoint. The at least two TCI states may be mapped to the TCI codepoint. In FIG. 18, the first TCI state of the at least two TCI states may be TCI state 26 and the second TCI state of the at least two TCI states may be TCI state 61.

The wireless device may transmit an uplink transmission (e.g., PUCCH/PUSCH transmission) with a positive HARQ-ACK (e.g., ACK) for (or corresponding to) the control command indicating the at least two TCI states. The wireless device may apply the at least two TCI states for the downlink receptions and/or the uplink transmissions via the cell, for example, starting from a first/initial/earliest/starting time slot that a number of symbols (e.g., beamApptime) after a last/ending symbol of the uplink transmission. In an example, the one or more configuration parameters may indicate the number of symbols. An application time of the at least two TCI states may be the first/initial/earliest/starting time slot that the number of symbols (e.g., beamApptime) after the last/ending symbol of the uplink transmission. The wireless device may start applying the at least two TCI states for the downlink receptions and/or the uplink transmissions via the cell, for example, starting from the application time. The wireless device may not apply the at least two TCI states for downlink receptions and/or uplink transmissions via the cell, for example, before the application time. The wireless device may apply previous/old TCI state(s) for downlink receptions and/or uplink transmissions via the cell, for example, before the application time.

In an example, the one or more control commands may be at least two control commands. The one or more control commands may be at least two control commands, for example, when the one or more configuration parameters indicate two different values of coreset pool index for coreset(s) in the downlink BWP of the cell. The one or more configuration parameters may comprise one or more PDCCH configuration parameters (e.g., PDCCH-Config) that contain/comprise two different values of a higher layer parameter CORESETPoolIndex in different coresets (e.g., ControlResourceSets) of the downlink BWP of the cell. The at least two control commands may comprise a first control command and a control command.

The first control command may be, for example, a first MAC-CE. The first control command may be, for example, a first DCI (e.g., DCI format 1_1, DCI format 1_2). The first control command may be, for example, a first downlink control command (e.g., activation command). The second control command may be, for example, a second MAC-CE. The second control command may be, for example, a second DCI (e.g., DCI format 1_1, DCI format 1_2). The second control command may be, for example, a second downlink control command (e.g., activation command).

The one or more control commands (or the at least two control commands) may indicate at least two TCI states of the subset of TCI states. The at least two TCI states may comprise a first TCI state and a second TCI state. The first control command may indicate the first TCI state of the at least two TCI states. The one or more first TCI states associated with the first coreset pool index may comprise the first TCI state. The first TCI state may be associated with (or may be specific with or may be of) a higher layer parameter coresetPoolIndex with value 0. The first TCI state may be for (or associated with) the first TRP. The second control command may indicate the second TCI state of the at least two TCI states. The one or more second TCI states associated with the second coreset pool index may comprise the second TCI state. The second TCI state may be associated with (or may be specific with or may be of) a higher layer parameter coresetPoolIndex with value 1. The second TCI state may be for (or associated with) the second TRP.

In an example, a number of the one or more first TCI codepoints may be equal to one (e.g., a single TCI codepoint). The single TCI codepoint may indicate the first TCI state. The first control command indicating the first TCI state may be the first activation command activating the one or more first TCI states based on the number of the one or more first TCI codepoints being equal to one. The first TCI state may be the one or more first TCI states based on the number of the one or more first TCI codepoints being equal to one. The first activation command may indicate the first TCI state based on the number of the one or more first TCI codepoints being equal to one.

In an example, a number of the one or more first TCI codepoints may be more than one. The first control command indicating the first TCI state may be different from the first activation command activating the one or more first TCI states based on the number of the one or more first TCI codepoints being more than one. The wireless device may receive the first control command after receiving the first activation command. The first control command (e.g., DCI) may comprise a TCI field indicating the first TCI state. A value of the TCI field may be equal to a first TCI codepoint, of the one or more first TCI codepoints, indicating the first TCI state. The first TCI state may be mapped to the first TCI codepoint.

In an example, a number of the one or more second TCI codepoints may be equal to one (e.g., a single TCI codepoint). The single TCI codepoint may indicate the second TCI state. The second control command indicating the second TCI state may be the second activation command activating the one or more second TCI states based on the number of the one or more second TCI codepoints being equal to one. The second TCI state may be the one or more second TCI states based on the number of the one or more second TCI codepoints being equal to one. The second activation command may indicate the second TCI state based on the number of the one or more second TCI codepoints being equal to one.

In an example, a number of the one or more second TCI codepoints may be more than one. The second control command indicating the second TCI state may be different from the second activation command activating the one or more second TCI states based on the number of the one or more second TCI codepoints being more than one. The wireless device may receive the second control command after receiving the second activation command. The second control command (e.g., DCI) may comprise a TCI field indicating the second TCI state. A value of the TCI field may be equal to a second TCI codepoint, of the one or more second TCI codepoints, indicating the second TCI state. The second TCI state may be mapped to the second TCI codepoint.

The one or more configuration parameters may comprise one or more LTM configuration parameters. The one or more LTM configuration parameters may indicate a list of candidate cell configurations (e.g., Itm-CandidateToAddModList).

The one or more LTM configuration parameters may indicate, for each candidate cell configuration in the list of candidate cell configurations, a respective LTM candidate index/identifier (e.g., Itm-CandidateId). For example, the one or more LTM configuration parameters may indicate, for a first candidate cell configuration in the list of candidate cell configurations, a first LTM candidate index/identifier. The first LTM candidate index/identifier may indicate the first candidate cell configuration (e.g., LTM candidate cell configuration). The one or more LTM configuration parameters may indicate, for a second candidate cell configuration in the list of candidate cell configurations, a second LTM candidate index/identifier. The second LTM candidate index/identifier may indicate the second candidate cell configuration (e.g., LTM candidate cell configuration).

The one or more LTM configuration parameters may indicate, for each candidate cell configuration in the list of candidate cell configurations, a respective RRC reconfiguration message used to configure of/corresponding an LTM candidate cell.

In an example, the control command may be a LTM Cell Switch Command MAC CE. The control command may indicate a cell switching to the cell (e.g., the candidate cell, the LTM candidate cell), for example, for an LTM switch (or an LTM procedure). The base station may indicate the wireless device to perform cell switch in/for the LTM procedure by sending/transmitting the control command (e.g., LTM Cell Switch Command MAC CE). The wireless device may receive, in a PDSCH reception via/on a serving cell, the control command indicating the cell switching.

The control command (e.g., LTM Cell Switch Command MAC CE or cell switch command) may comprise a plurality of fields.

A first field of the plurality of fields may comprise an LTM candidate index/identifier (e.g., Itm-CandidateId) indicating/identifying a candidate cell configuration (e.g., LTM candidate cell configuration) in the list of candidate cell configurations. The LTM candidate index/identifier may indicate/identify the candidate cell configuration (e.g., RRC reconfiguration) to be applied by the wireless device for the cell switching to the cell (e.g., for the LTM switch).

A second field of the plurality of fields may indicate a first TCI state. The plurality of TCI states (e.g., DLorJoint-TCIStateList) may comprise the first TCI state. The control command (e.g., LTM Cell Switch Command MAC CE) may comprise a first TCI state identifier/index indicating/identifying the first TCI state. The plurality of TCI state indexes/identifiers/identities may comprise the first TCI state identifier/index. The control command (e.g., LTM Cell Switch Command MAC CE) may indicate/activate the first TCI state for the cell (or for the LTM target cell).

In an example, the control command may indicate, for downlink receptions (e.g., PDCCH, PDSCH, CSI-RS) via the cell, the first TCI state.

In an example, the control command may indicate, for uplink transmissions (e.g., PUCCH, PUSCH, SRS) via the cell, the first TCI state.

In an example, the control command may indicate, for both uplink transmissions (e.g., PUCCH, PUSCH, SRS) via the cell and downlink receptions (e.g., PDCCH, PDSCH, CSI-RS) via the cell, the first TCI state.

The first TCI state may be, for example, a first joint TCI state. The first TCI state may be, for example, a first downlink TCI state.

The at least two TCI states may be, for example, at least two joint TCI states. The first TCI state may be, for example, a first joint TCI state. The second TCI state may be, for example, a second joint TCI state.

The at least two TCI states may be, for example, at least two downlink TCI states. The first TCI state may be, for example, a first downlink TCI state. The second TCI state may be, for example, a second downlink TCI state.

The at least two TCI states may be, for example, at least two uplink TCI states. The first TCI state may be, for example, a first uplink TCI state. The second TCI state may be, for example, a second uplink TCI state.

The first TCI state may comprise/indicate a first reference signal (e.g., CSI-RS, SSB/PBCH block, DM-RS, SRS, and the like). The first TCI state may comprise/indicate a first quasi co-location type (e.g., QCL TypeA, QCL TypeB, QCL TypeC, QCL TypeD).

The second TCI state may comprise/indicate a second reference signal (e.g., CSI-RS, SSB/PBCH block, DM-RS, SRS, and the like). The second TCI state may comprise/indicate a second quasi co-location type (e.g., QCL TypeA, QCL TypeB, QCL TypeC, QCL TypeD).

In an example, the one or more configuration parameters may indicate one or more control resource sets (coresets). The one or more configuration parameters may indicate the one or more coresets for the downlink BWP (or the active downlink BWP) of the cell. The downlink BWP may comprise the one or more coresets.

In an example, the one or more configuration parameters may indicate one or more coreset indexes/identifiers/indicators (e.g., provided by a higher layer parameter ControlResourceSetId) for the one or more coresets. In an example, each coreset of the one or more coresets may be identified/indicated by a respective coreset index of the one or more coreset indexes. In an example, a first coreset of the one or more coresets may be identified by a first coreset index of the one or more coreset indexes. A second coreset of the one or more coresets may be identified by a second coreset index of the one or more coreset indexes.

The one or more configuration parameters may indicate, for the downlink BWP of the cell, a plurality of search space sets (e.g., by a higher layer parameter SearchSpace). For example, the one or more configuration parameters may indicate, for the cell, a plurality of search space sets (e.g., by a higher layer parameter SearchSpace).

The one or more configuration parameters may indicate a plurality of search space set indexes/identifiers (e.g., provided by a higher layer parameter searchSpaceId) for the plurality of search space sets. In an example, each search space set of the plurality of search space sets may be identified/indicated by a respective search space set index of the plurality of search space set indexes. In an example, a first search space set of the plurality of search space sets may be identified by a first search space set index of the plurality of search space set indexes. In an example, a second search space set of the plurality of search space sets may be identified by a second search space set index of the plurality of search space set indexes.

In an example, a search space set of the plurality of search space sets may be associated with (or linked to) a coreset of the one or more coresets. In an example, the one or more configuration parameters may indicate the coreset (or a coreset index of the coreset) for the search space set (e.g., provided by a higher layer parameter controlResourceSetId in the higher layer parameter SearchSpace). In an example, the association (or the linkage) may be one-to-one. The association being one-to-one may comprise the search space set associated with (or linked to) the coreset not being associated (or linked to) a second coreset that is different from the coreset. The one or more coresets may comprise the second coreset.

In an example, the wireless device may monitor, for a DCI, PDCCH transmissions/receptions in/via a coreset of the one or more coresets. The monitoring, for the DCI, the PDCCH transmissions/receptions in the coreset may comprise monitoring, for the DCI, PDCCH candidate(s) in PDCCH monitoring occasion(s) for/of (or associated with) a search space set associated with (or linked to) the coreset. The plurality of search space sets may comprise the search space set. In an example, based on the search space set being associated with (or linked to) the coreset, the wireless device may monitor, for a DCI, PDCCH candidate(s) in PDCCH monitoring occasion(s) for/of the search space set in the coreset. In an example, based on the search space set being associated with (or linked to) the coreset, the wireless device may monitor, for a DCI, PDCCH transmissions/receptions for the search space set in the coreset.

The wireless device may monitor, for DCI, downlink control channels in/via a coreset of the one or more coresets. The monitoring, for the DCI, the downlink control channels in the coreset may comprise monitoring, for the DCI, one or more PDCCH candidates in one or more PDCCH monitoring occasions for/of one or more search space sets associated with the coreset. The plurality of search space sets may comprise the one or more search space sets. The wireless device may monitor, for the DCI, respective PDCCH candidate(s) of the one or more PDCCH candidates in each PDCCH monitoring occasion of the one or more PDCCH monitoring occasions. The one or more configuration parameters may indicate, for the one or more search space sets, the one or more PDCCH candidates. The one or more configuration parameters may indicate, for each search space set of the one or more search space sets, respective PDCCH candidate(s) of the one or more PDCCH candidates. The wireless device may determine the one or more PDCCH monitoring occasions of the one or more search space sets based on one or more search space set configuration parameters (e.g., IE SearchSpace) of the one or more configuration parameters. The one or more search space set configuration parameters may indicate one or more PDCCH monitoring periodicities (e.g., monitoringSlotPeriodicityAndOffset) for the one or more search space sets. The one or more search space set configuration parameters may indicate a respective PDCCH monitoring periodicity of the one or more PDCCH monitoring periodicities for each search space set of the one or more search space sets. The wireless device may determine the one or more PDCCH monitoring occasions, for example, based on the one or more PDCCH monitoring periodicities. The one or more search space set configuration parameters may indicate PDCCH monitoring symbols (e.g., monitoringSymbolsWithinSlot) for the one or more search space sets. The one or more search space set configuration parameters may indicate respective PDCCH monitoring symbol(s) of the PDCCH monitoring symbols (e.g., monitoringSymbolsWithinSlot) for each search space set of the one or more search space sets. The wireless device may determine the one or more PDCCH monitoring occasions, for example, based on the PDCCH monitoring symbols.

In an example, the one or more configuration parameters may indicate the one or more coreset indexes for the plurality of search space sets (e.g., provided by a higher layer parameter controlResourceSetId in the higher layer parameter SearchSpace). In an example, each search space set of the plurality of search space sets may be associated with (or linked to) a respective coreset of the one or more coresets. In an example, the one or more configuration parameters may indicate, for the first search space set, the first coreset index of the first coreset. The one or more configuration parameters may indicate the first coreset index of the first coreset in a coreset index field (e.g., provided by a higher layer parameter controlResourceSetId in the higher layer parameter SearchSpace) of the first search space set. Based on the one or more configuration parameters indicating the first coreset index of the first coreset for the first search space set, the first search space set may be associated with (or linked to) the first coreset. In an example, the one or more configuration parameters may indicate, for the second search space set, the first coreset index of the first coreset. The one or more configuration parameters may indicate the first coreset index of the first coreset in a coreset index field (e.g., provided by a higher layer parameter controlResourceSetId in the higher layer parameter SearchSpace) of the second search space set. Based on the one or more configuration parameters indicating the first coreset index of the first coreset for the second search space set, the second search space set may be associated with (or linked to) the first coreset. In an example, the one or more configuration parameters may indicate the second coreset index of the second coreset for the first search space set. Based on the one or more configuration parameters indicating the second coreset index of the second coreset for the first search space set, the first search space set may be associated with (or linked to) the second coreset. In an example, the one or more configuration parameters may indicate the second coreset index of the second coreset for the second search space set. Based on the one or more configuration parameters indicating the second coreset index of the second coreset for the second search space set, the second search space set may be associated with (or linked to) the second coreset.

In an example, one or more first search space sets of the plurality of search space sets may be common search space (CSS) set(s). The one or more configuration parameters may comprise, for the one or more first search space sets, a search space type parameter (e.g., searchSpaceType) that is equal/set to ‘CSS’ (or ‘common’). The one or more configuration parameters may comprise, for each search space set of the one or more first search space sets, a search space type parameter that is equal/set to ‘CSS’. The one or more configuration parameters may comprise, for each search space set of the one or more first search space sets, a respective search space type parameter that is equal/set to ‘CSS’.

The CSS set(s) may comprise a Type0-PDCCH CSS set (configured by pdcch-ConfigSIB1 in MIB or by search SpaceSIB1 in PDCCH-ConfigCommon or by searchSpaceZero in PDCCH-ConfigCommon). The wireless device may monitor, for a DCI format with CRC scrambled by a SI-RNTI, PDCCH transmissions/receptions in the Type0-PDCCH CSS set.

The CSS set(s) may comprise a Type0A-PDCCH CSS set (configured by search SpaceOtherSystemInformation in PDCCH-ConfigCommon). The wireless device may monitor, for a DCI format with CRC scrambled by a SI-RNTI, PDCCH transmissions/receptions in the Type0A-PDCCH CSS set.

The CSS set(s) may comprise a Type1-PDCCH CSS set (configured by ra-SearchSpace in PDCCH-ConfigCommon). The wireless device may monitor, for a DCI format with CRC scrambled by a RA-RNTI, MsgB-RNTI, or a TC-RNTI, PDCCH transmissions/receptions in the Type1-PDCCH CSS set.

The CSS set(s) may comprise a Type1A-PDCCH CSS set (configured by sdt-SearchSpace in PDCCH-ConfigCommon). The wireless device may monitor, for a DCI format with CRC scrambled by a C-RNTI or a CS-RNTI, PDCCH transmissions/receptions in the Type1A-PDCCH CSS set on/via/in the cell (e.g., the primary cell).

The CSS set(s) may comprise a Type2-PDCCH CSS set (configured by pagingSearchSpace in PDCCH-ConfigCommon). The wireless device may monitor, for a DCI format with CRC scrambled by a P-RNTI, PDCCH transmissions/receptions in the Type2-PDCCH CSS set.

In an example, the CSS set(s) may comprise a Type3-PDCCH CSS set (configured by SearchSpace in PDCCH-Config with searchSpaceType=common). The wireless device may monitor, for a DCI format with CRC scrambled by an RNTI, PDCCH transmissions/receptions in the Type3-PDCCH CSS set. The RNTI may be, for example, INT-RNTI, SFI-RNTI, TPC-PUSCH-RNTI, TPC-PUCCH-RNTI, TPC-SRS-RNTI, or CI-RNTI. The RNTI may be, for example, C-RNTI, MCS-C-RNTI, CS-RNTI(s), or PS-RNTI. The RNTI may be C-RNTI, MCS-C-RNTI, CS-RNTI(s), or PS-RNTI, for example, when the cell is a primary cell.

In an example, one or more second search space sets of the plurality of search space sets may be user specific search space (USS) set(s). The one or more configuration parameters may comprise, for the one or more second search space sets, a search space type parameter (e.g., searchSpaceType) that is equal/set to ‘USS’ (or ‘ue-specific)’. The one or more configuration parameters may comprise, for each search space set of the one or more second search space sets, a search space type parameter that is equal/set to ‘USS. The one or more configuration parameters may comprise, for each search space set of the one or more second search space sets, a respective search space type parameter that is equal/set to ‘USS’. The wireless device may monitor, for a DCI format with CRC scrambled by an RNTI, PDCCH transmissions/receptions in a USS set. The USS set(s) may comprise the USS set. The RNTI may be, for example, C-RNTI, MCS-C-RNTI, SP-CSI-RNTI, CS-RNTI(s), SL-RNTI, SL-CS-RNTI, or SL Semi-Persistent Scheduling V-RNTI.

The one or more configuration parameters may indicate, for a search space set, a search space identifier/index (e.g., searchSpaceID, searchSpaceMCCH or searchSpaceMTCH). The plurality of search space sets may comprise the search space set. The plurality of search space set indexes/identifiers may comprise the search space identifier/index.

In an example, the search space identifier (e.g., searchSpaceMCCH) may be for multicast control channel (MCCH). In an example, the search space identifier (e.g., searchSpaceMTCH) may be for multicast traffic channel (MTCH).

The search space identifier may indicate/identify/configure the search space set.

In an example, the one or more configuration parameters may comprise one or more downlink control channel common configuration parameters (e.g., PDCCH-ConfigCommon) indicating/comprising the search space identifier/index for/of the search space set.

The search space set may be a CSS set (e.g., CSS set in FIG. 18). The one or more first search space sets of the plurality of search space sets may comprise the CSS set (or the search space set).

The CSS set may be, for example, a Type0-PDCCH CSS set. The CSS set may be, for example, a Type0A-PDCCH CSS set. The CSS set may be, for example, a Type1A-PDCCH CSS set. The CSS set may be, for example, a Type2-PDCCH CSS set.

The search space set may be associated with (or linked to) a coreset of the one or more coresets. In an example, the one or more configuration parameters may indicate the coreset (or a coreset index of the coreset) for the search space set (e.g., provided by a higher layer parameter controlResourceSetId in the higher layer parameter SearchSpace). The one or more coreset indexes/identifiers/indicators of the one or more coresets may comprise the coreset index of the coreset.

The search space identifier/index of the search space set may be, for example, equal to zero (e.g., Search space identifier=0 in FIG. 18).

The coreset identifier/index of the coreset may be, for example, equal to zero.

The search space set may be associated with (or linked) to the coreset with the coreset index equal to zero.

The wireless device may have (or may be provided/indicated) a cell radio network temporary identifier (C-RNTI).

In an example, the one or more configuration parameters may comprise a higher layer parameter followUnifiedTCI-State for the coreset. The wireless device may apply the first TCI state indicated by the control command (e.g., DCI, LTM Cell Switch Command MAC CE) to the coreset based on the one or more configuration parameters comprising the higher layer parameter followUnifiedTCI-State for the coreset. The wireless device may monitor, via the coreset, PDCCH candidates of the search space set based on the first TCI state. The wireless device may receive, via the coreset, PDCCH candidates of the search space set based on the first TCI state. The wireless device may receive, via the coreset, PDCCH receptions based on the first TCI state. At least one DM-RS port of the PDCCH receptions may be quasi co-located with the first reference signal indicated by the first TCI state. The at least one DM-RS port of the PDCCH receptions may be quasi co-located with the first reference signal with respect to the first quasi co-location type indicated by the first TCI state.

In an example, the one or more configuration parameters may comprise a higher layer parameter apply-IndicatedTCIState for the coreset.

The wireless device may apply the first TCI state of the at least two TCI states to the coreset based on the higher layer parameter apply-IndicatedTCIState being set/equal to ‘first’. The wireless device may monitor, via the coreset, PDCCH candidates of the search space set based on the first TCI state. The wireless device may receive, via the coreset, PDCCH candidates of the search space set based on the first TCI state. The wireless device may receive, via the coreset, PDCCH receptions based on the first TCI state. At least one DM-RS port of the PDCCH receptions may be quasi co-located with the first reference signal indicated by the first TCI state. The at least one DM-RS port of the PDCCH receptions may be quasi co-located with the first reference signal with respect to the first quasi co-location type indicated by the first TCI state.

The wireless device may apply the second TCI state of the at least two TCI states to the coreset based on the higher layer parameter apply-IndicatedTCIState being set/equal to ‘second’. The wireless device may monitor, via the coreset, PDCCH candidates of the search space set based on the second TCI state. The wireless device may receive, via the coreset, PDCCH candidates of the search space set based on the second TCI state. The wireless device may receive, via the coreset, PDCCH receptions based on the second TCI state. At least one DM-RS port of the PDCCH receptions may be quasi co-located with the second reference signal indicated by the second TCI state. The at least one DM-RS port of the PDCCH receptions may be quasi co-located with the second reference signal with respect to the second quasi co-location type indicated by the second TCI state.

The wireless device may determine monitoring occasions (e.g., PDCCH monitoring occasions) for the PDCCH candidates of the search space set, for example, based on (or using) a reference signal. The wireless device may determine the monitoring occasions for the PDCCH candidates of the search space set based on (or using) the reference signal, for example, in response to the one or more configuration parameters indicating, for the search space set, the search space identifier/index that is equal to zero. The wireless device may determine the monitoring occasions for the PDCCH candidates of the search space set based on (or using) the reference signal, for example, in response to the wireless device having (or being provided/indicated with) the C-RNTI.

In an example, the reference signal may be an SS/PBCH block.

The wireless device may determine, for the monitoring occasions, a number of consecutive resource blocks based on (or using) the reference signal. The wireless device may determine a number of consecutive resource blocks of the monitoring occasions based on (or using) the reference signal. The wireless device may determine, for the coreset of the search space set, the number of consecutive resource blocks based on (or using) the reference signal.

The wireless device may determine, for the monitoring occasions, a number of consecutive symbols based on (or using) the reference signal. The wireless device may determine a number of consecutive symbols of the monitoring occasions based on (or using) the reference signal. The wireless device may determine, for the coreset of the search space set, the number of consecutive symbols based on (or using) the reference signal.

The wireless device may determine the monitoring occasions for the PDCCH candidates of the search space set based on (or using) a reference signal index (e.g., SS/PBCH block with index i) of the reference signal. The reference signal index may indicate a row/entry in a table. The row/entry may comprise, for example, the number of consecutive resource blocks. The row/entry may comprise, for example, the number of consecutive symbols. The row/entry may comprise, for example, a multiplexing pattern (e.g., SS/PBCH block and CORESET multiplexing pattern).

The wireless device may monitor, in the monitoring occasions associated with the reference signal, the PDCCH candidates. The wireless device may monitor, via the coreset and in the monitoring occasions associated with the reference signal, the PDCCH candidates. The wireless device may not monitor, in second monitoring occasion(s) different from the monitoring occasions, PDCCH candidates. The wireless device may not monitor, via the coreset and in second monitoring occasion(s) different from the monitoring occasions, PDCCH candidates. The wireless device may not monitor, via the coreset and in second monitoring occasion(s) different from the monitoring occasions, PDCCH candidates, for example, based on the one or more configuration parameters indicating, for the search space set, the search space identifier/index that is equal to zero. The wireless device may monitor, via the coreset and in the monitoring occasions associated with the reference signal, the PDCCH candidates for detection/reception of DCI formats with CRC scrambled with the C-RNTI.

The wireless device may receive, in the monitoring occasions associated with the reference signal, a PDCCH reception. The wireless device may receive, via the coreset and in the monitoring occasions associated with the reference signal, the PDCCH reception. The PDCCH reception may comprise the DCI formats with CRC scrambled with the C-RNTI. The wireless device may not receive, in second monitoring occasion(s) different from the monitoring occasions, PDCCH receptions. The wireless device may not receive, via the coreset and in second monitoring occasion(s) different from the monitoring occasions, PDCCH receptions. The wireless device may not receive, via the coreset and in second monitoring occasion(s) different from the monitoring occasions, PDCCH receptions, for example, based on the one or more configuration parameters indicating, for the search space set, the search space identifier/index that is equal to zero.

In an example, the first TCI state applied to the coreset may indicate the reference signal. The first TCI state may be associated with (or may have) the reference signal. The first reference signal (e.g., CSI-RS) indicated by the first TCI state may be quasi co-located with the reference signal (e.g., SS/PBCH block).

The wireless device may determine/select the reference signal used to determine the monitoring occasions, for example, based on the most recent of:
an activation command (e.g., MAC-CE) indicating a TCI state of an active BWP that comprises/includes the coreset with the coreset index that is equal to zero. The TCI state may indicate/include/comprise a first reference signal that is quasi co-located with the reference signal,
the control command (e.g., at time T2 in FIG. 18) indicating the first TCI state for the coreset with the coreset index that is equal to zero. The first TCI state may indicate/include/comprise the first reference signal that is quasi co-located with the reference signal,
a random-access procedure. The random-access procedure may not be initiated by a PDCCH order that triggers a contention-free random-access procedure, and
a configured-grant based PUSCH transmission in an RRC inactive state (e.g., for small-data transmission).

The wireless device may determine/use/select the reference signal indicated by (or associated with) the first TCI state for determination of the monitoring occasions of the search space set associated with the coreset, for example, in response to the control command indicating the first TCI state for the coreset being the most recent among:
an activation command (e.g., MAC-CE) indicating a TCI state of an active BWP that comprises/includes the coreset with the coreset index that is equal to zero. The TCI state may indicate/include/comprise a first reference signal that is quasi co-located with the reference signal,
the control command (e.g., at time T2 in FIG. 18) indicating the first TCI state for the coreset with the coreset index that is equal to zero. The first TCI state may indicate/include/comprise the first reference signal that is quasi co-located with the reference signal, and
a random-access procedure. The random-access procedure may not be initiated by a PDCCH order that triggers a contention-free random-access procedure, and
a configured-grant based PUSCH transmission in an RRC inactive state (e.g., for small-data transmission).

The wireless device may determine/select the reference signal used to determine the monitoring occasions, for example, based on the most recent of:
an activation command (e.g., MAC-CE) or a DCI format indicating a TCI state of an active BWP that comprises/includes the coreset with the coreset index that is equal to zero. The TCI state may indicate/include/comprise a first reference signal that is quasi co-located with the reference signal,
a random-access procedure. The random-access procedure may not be initiated by a PDCCH order that triggers a contention-free random-access procedure,
a configured-grant based PUSCH transmission in an RRC inactive state (e.g., for small-data transmission), and
the control command (e.g., at time T2 in FIG. 18, LTM Cell Switch Command MAC CE, a cell switch command) indicating the first TCI state for the coreset with the coreset index that is equal to zero. The first TCI state may indicate/include/comprise the first reference signal that is quasi co-located with the reference signal,

The wireless device may determine/use/select the reference signal indicated by (or associated with) the first TCI state for determination of the monitoring occasions of the search space set associated with the coreset, for example, in response to the control command indicating the first TCI state for the coreset being the most recent among:
an activation command (e.g., MAC-CE) indicating a TCI state of an active BWP that comprises/includes the coreset with the coreset index that is equal to zero. The TCI state may indicate/include/comprise a first reference signal that is quasi co-located with the reference signal,
a random-access procedure. The random-access procedure may not be initiated by a PDCCH order that triggers a contention-free random-access procedure,
a configured-grant based PUSCH transmission in an RRC inactive state (e.g., for small-data transmission), and
the control command (e.g., at time T2 in FIG. 18, LTM Cell Switch Command MAC CE, a cell switch command) indicating the first TCI state for the coreset with the coreset index that is equal to zero. The first TCI state may indicate/include/comprise the first reference signal that is quasi co-located with the reference signal, and

The wireless device may determine/use/select the reference signal indicated by (or associated with) the first TCI state for determination of the monitoring occasions of the search space set associated with the coreset, for example, in response to the one or more configuration parameters comprising the higher layer parameter followUnifiedTCI-State for the coreset.

The wireless device may not determine/use/select the reference signal indicated by (or associated with) the first TCI state for determination of monitoring occasions of a second search space set associated with a second coreset, for example, in response to the one or more configuration parameters not comprising a higher layer parameter followUnifiedTCI-State for the second coreset. The one or more coresets may comprise the second coreset.

The wireless device may determine/use/select the reference signal indicated by (or associated with) the first TCI state for determination of the monitoring occasions of the search space set associated with the coreset, for example, in response to the one or more configuration parameters comprising the higher layer parameter apply-IndicatedTCIState set to ‘first’ or ‘second’ for the coreset. The wireless device may determine/use/select the reference signal indicated by (or associated with) the first TCI state for determination of the monitoring occasions of the search space set associated with the coreset, for example, in response to the one or more configuration parameters comprising the higher layer parameter apply-IndicatedTCIState not set to ‘none’ for the coreset.

The wireless device may not determine/use/select the reference signal indicated by (or associated with) the first TCI state for determination of monitoring occasions of a second search space set associated with a second coreset, for example, in response to the one or more configuration parameters comprising the higher layer parameter apply-IndicatedTCIState set to ‘none’ for the second coreset.

The wireless device may determine/use/select the reference signal indicated by (or associated with) the first TCI state for determination of the monitoring occasions of the search space set associated with the coreset, for example, until receiving a second control command (e.g., MAC-CE, DCI) indicating a new TCI state for the coreset. The wireless device may determine/use/select a new reference signal indicated by (or associated with) the new TCI state for determination of monitoring occasions of the search space set associated with the coreset, for example, after receiving the second control command (or after the new TCI state is applied).

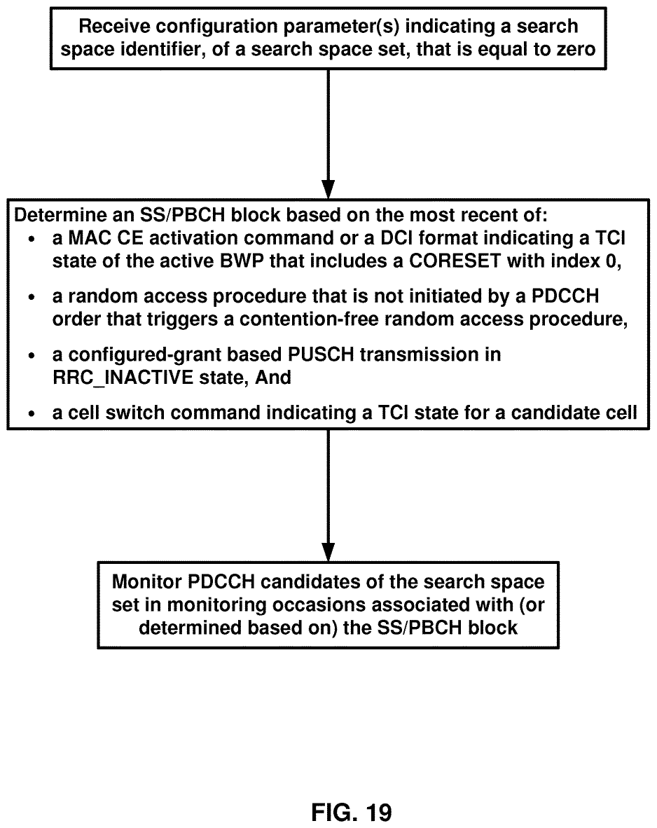

FIG. 19 illustrates an example flow chart of downlink control channel monitoring as per an aspect of an embodiment of the present disclosure.

If a wireless device is provided/configured/indicated a zero value for a higher layer parameter searchSpaceID in a higher layer parameter PDCCH-ConfigCommon for a Type0/0A/1A/2-PDCCH CSS set, or is provided a zero value for a higher layer parameter searchSpaceMCCH or a higher layer parameter searchSpaceMTCH, the wireless device may determine monitoring occasions for PDCCH candidates of the Type0/0A/1A/2-PDCCH CSS set, and if the wireless device is provided/indicated a C-RNTI, the wireless device may monitor PDCCH candidates only at the monitoring occasions associated with a SS/PBCH block, where the SS/PBCH block may be determined by the most recent of:
a MAC CE activation command or a DCI format (e.g., DCI format 1_1/1_2/1_3) indicating a TCI state of the active BWP that includes/comprises a CORESET with index 0, where the TCI state may include/comprise a CSI-RS which is quasi-co-located with the SS/PBCH block,
a random access procedure that is not initiated by a PDCCH order that triggers a contention-free random access procedure, and
a configured-grant based PUSCH transmission in RRC_INACTIVE state.

If a wireless device is provided/configured/indicated, by a base station, a zero value for a higher layer parameter searchSpaceID in a higher layer parameter PDCCH-ConfigCommon for a Type0/0A/1A/2-PDCCH CSS set, or is provided a zero value for a higher layer parameter searchSpaceMCCH or a higher layer parameter searchSpaceMTCH, the wireless device may determine monitoring occasions for PDCCH candidates of the Type0/0A/1A/2-PDCCH CSS set based on a SS/PBCH block. If the wireless device is provided/indicated a C-RNTI, the wireless device may monitor PDCCH candidates only at the monitoring occasions associated with the SS/PBCH block. The SS/PBCH block may be determined by the most recent of:
a MAC CE activation command or a DCI format (e.g., DCI format 1_1/1_2/1_3) indicating a TCI state of the active BWP that includes/comprises a CORESET with index 0, where the TCI state may include/comprise a CSI-RS which is quasi-co-located with the SS/PBCH block,
a random access procedure that is not initiated by a PDCCH order that triggers a contention-free random access procedure, where the wireless device may select/determine the SS/PBCH block for the random-access procedure, and
a configured-grant based PUSCH transmission in RRC_INACTIVE state, where the wireless device use/apply the SS/PBCH block for the configured-grant based PUSCH transmission. The SS/PBCH block may be associated with (or may be mapped/linked to) a configured grant of the configured-grant based PUSCH transmission.

If a wireless device is provided/configured/indicated, by a base station, a zero value for a higher layer parameter searchSpaceID in a higher layer parameter PDCCH-ConfigCommon for a Type0/0A/1A/2-PDCCH CSS set, or is provided a zero value for a higher layer parameter searchSpaceMCCH or a higher layer parameter searchSpaceMTCH, the wireless device may determine monitoring occasions for PDCCH candidates of the Type0/0A/1A/2-PDCCH CSS set based on a SS/PBCH block. If the wireless device is provided/indicated a C-RNTI, the wireless device may monitor PDCCH candidates only at the monitoring occasions associated with the SS/PBCH block. The SS/PBCH block may be determined by the most recent of:
a MAC CE activation command or a DCI format (e.g., DCI format 1_1/1_2/1_3) indicating a TCI state for a CORESET, of the active BWP, with index 0, where the TCI state may include/comprise a CSI-RS which is quasi-co-located with the SS/PBCH block,
a random access procedure that is not initiated by a PDCCH order that triggers a contention-free random access procedure, where the wireless device may select/determine the SS/PBCH block for the random-access procedure, and
a configured-grant based PUSCH transmission in RRC_INACTIVE state, where the wireless device use/apply the SS/PBCH block for the configured-grant based PUSCH transmission. The SS/PBCH block may be associated with (or may be mapped/linked to) a configured grant of the configured-grant based PUSCH transmission.

If a wireless device is provided/configured/indicated, by a base station, a zero value for a higher layer parameter searchSpaceID in a higher layer parameter PDCCH-ConfigCommon for a Type0/0A/1A/2-PDCCH CSS set, or is provided a zero value for a higher layer parameter searchSpaceMCCH or a higher layer parameter search SpaceMTCH, the wireless device may determine monitoring occasions for PDCCH candidates of the Type0/0A/1A/2-PDCCH CSS set based on a SS/PBCH block. If the wireless device is provided/indicated a C-RNTI, the wireless device may monitor PDCCH candidates only at the monitoring occasions associated with the SS/PBCH block. The SS/PBCH block may be determined by the most recent of:
a MAC CE activation command or a DCI format (e.g., DCI format 1_1/1_2/1_3) indicating a TCI state of the active BWP that includes/comprises a CORESET with index 0, where the TCI state may include/comprise a CSI-RS which is quasi-co-located with the SS/PBCH block,
a random access procedure that is not initiated by a PDCCH order that triggers a contention-free random access procedure, where the wireless device may select/determine the SS/PBCH block for the random-access procedure,
a configured-grant based PUSCH transmission in RRC_INACTIVE state, where the wireless device use/apply the SS/PBCH block for the configured-grant based PUSCH transmission. The SS/PBCH block may be associated with (or may be mapped/linked to) a configured grant of the configured-grant based PUSCH transmission, and
a cell switch command (e.g., LTM Cell Switch Command MAC CE) indicating a TCI state of/for the first active downlink BWP of a candidate cell, where the TCI state may include/comprise the SS/PBCH block or a CSI-RS which is quasi-co-located with the SS/PBCH block.

If a wireless device is provided/configured/indicated, by a base station, a zero value for a higher layer parameter searchSpaceID in a higher layer parameter PDCCH-ConfigCommon for a Type0/0A/1A/2-PDCCH CSS set, or is provided a zero value for a higher layer parameter searchSpaceMCCH or a higher layer parameter search SpaceMTCH, the wireless device may determine monitoring occasions for PDCCH candidates of the Type0/0A/1A/2-PDCCH CSS set based on a SS/PBCH block. If the wireless device is provided/indicated a C-RNTI, the wireless device may monitor PDCCH candidates only at the monitoring occasions associated with the SS/PBCH block. The SS/PBCH block may be determined by the most recent of:
a MAC CE activation command or a DCI format (e.g., DCI format 1_1/1_2/1_3) indicating a TCI state of the active BWP that includes/comprises a CORESET with index 0, where the TCI state may include/comprise a CSI-RS which is quasi-co-located with the SS/PBCH block,
a random access procedure that is not initiated by a PDCCH order that triggers a contention-free random access procedure, where the wireless device may select/determine the SS/PBCH block for the random-access procedure,
a configured-grant based PUSCH transmission in RRC_INACTIVE state, where the wireless device use/apply the SS/PBCH block for the configured-grant based PUSCH transmission. The SS/PBCH block may be associated with (or may be mapped/linked to) a configured grant of the configured-grant based PUSCH transmission, and
a cell switch command (e.g., LTM Cell Switch Command MAC CE) indicating a TCI state of/for the first active downlink BWP, of a candidate cell, that includes/comprises a CORESET with index 0. The TCI state may include/comprise the SS/PBCH block or a CSI-RS which is quasi-co-located with the SS/PBCH block.

If a wireless device is provided/configured/indicated, by a base station, a zero value for a higher layer parameter searchSpaceID in a higher layer parameter PDCCH-ConfigCommon for a Type0/0A/1A/2-PDCCH CSS set, or is provided a zero value for a higher layer parameter searchSpaceMCCH or a higher layer parameter searchSpaceMTCH, the wireless device may determine monitoring occasions for PDCCH candidates of the Type0/0A/1A/2-PDCCH CSS set based on a SS/PBCH block. If the wireless device is provided/indicated a C-RNTI, the wireless device may monitor PDCCH candidates only at the monitoring occasions associated with the SS/PBCH block. The SS/PBCH block may be determined by the most recent of:
a MAC CE activation command or a DCI format (e.g., DCI format 1_1/1_2/1_3) indicating a TCI state of the active BWP that includes/comprises a CORESET with index 0, where the TCI state may include/comprise a CSI-RS which is quasi-co-located with the SS/PBCH block,
a random access procedure that is not initiated by a PDCCH order that triggers a contention-free random access procedure, where the wireless device may select/determine the SS/PBCH block for the random-access procedure,
a configured-grant based PUSCH transmission in RRC_INACTIVE state, where the wireless device use/apply the SS/PBCH block for the configured-grant based PUSCH transmission. The SS/PBCH block may be associated with (or may be mapped/linked to) a configured grant of the configured-grant based PUSCH transmission, and
a cell switch command (e.g., LTM Cell Switch Command MAC CE) indicating a TCI state of/for the first active downlink BWP, of a candidate cell, that includes/comprises a CORESET with index 0, where the wireless device is provided with a higher layer parameter followUnifiedTCI-State for the CORESET. The TCI state may include/comprise the SS/PBCH block or a CSI-RS which is quasi-co-located with the SS/PBCH block.

If a wireless device is provided/configured/indicated, by a base station, a zero value for a higher layer parameter searchSpaceID in a higher layer parameter PDCCH-ConfigCommon for a Type0/0A/1A/2-PDCCH CSS set, or is provided a zero value for a higher layer parameter searchSpaceMCCH or a higher layer parameter searchSpaceMTCH, the wireless device may determine monitoring occasions for PDCCH candidates of the Type0/0A/1A/2-PDCCH CSS set based on a SS/PBCH block. If the wireless device is provided/indicated a C-RNTI, the wireless device may monitor PDCCH candidates only at the monitoring occasions associated with the SS/PBCH block. The SS/PBCH block may be determined by the most recent of:
a MAC CE activation command or a DCI format (e.g., DCI format 1_1/1_2/1_3) indicating a TCI state of the active BWP that includes/comprises a CORESET with index 0, where the TCI state may include/comprise a CSI-RS which is quasi-co-located with the SS/PBCH block,
a random access procedure that is not initiated by a PDCCH order that triggers a contention-free random access procedure, where the wireless device may select/determine the SS/PBCH block for the random-access procedure,
a configured-grant based PUSCH transmission in RRC_INACTIVE state, where the wireless device use/apply the SS/PBCH block for the configured-grant based PUSCH transmission. The SS/PBCH block may be associated with (or may be mapped/linked to) a configured grant of the configured-grant based PUSCH transmission, and
a cell switch command (e.g., LTM Cell Switch Command MAC CE) indicating a TCI state of/for the first active downlink BWP, of a candidate cell, that includes/comprises a CORESET with index 0, where the wireless device is provided with a higher layer parameter apply-IndicatedTCIState set to ‘first’ or ‘second’ (or not set to ‘none’) for the CORESET. The TCI state may include/comprise the SS/PBCH block or a CSI-RS which is quasi-co-located with the SS/PBCH block.

A wireless device may receive, e.g., from a base station, one or more messages comprising one or more configuration parameters. The base station may transmit the one or more messages.

The wireless device may have (or may be provided with) a cell radio network temporary identifier (C-RNTI).

The one or more configuration parameters may comprise a search space identifier of a search space set. The search space identifier may be equal/set to zero.

The search space set may be a Type0/0A/1A/2-PDCCH common search space (CSS) set.

The search space set may be associated with a coreset.

In an example, the one or more configuration parameters may indicate, for the coreset, a coreset index that is equal to zero.

Based on the search space identifier of the search space set being set to zero, the wireless device may monitor PDCCH candidates of the search space set in/at monitoring occasions associated with a first reference signal (e.g., SS/PBCH block). Based on the search space identifier of the search space set being set to zero, the base station may transmit, via the coreset of the search space set, PDCCH transmissions (e.g., DCI formats) in/at the monitoring occasions associated with the first reference signal.

The wireless device may determine the first reference signal based on a cell switch command indicating a first TCI state. The base station may determine the first reference signal based on the cell switch command indicating the first TCI state. The base station may transmit the cell switch command to the wireless device. The wireless device may receive, from the base station, the cell switch command. The first TCI state may include/indicate/comprise a second reference signal (e.g., CSI-RS) that is quasi co-located with the first reference signal.

The cell switch command may indicate the first TCI state of/for a first active downlink BWP of a candidate cell.

The first active downlink BWP of the candidate cell may comprise/include the coreset with the coreset index that is equal to zero.

The wireless device (and/or the base station) may determine the first reference signal based on the most recent of:
a MAC-CE or a DCI format indicating a second TCI state of an active bandwidth part (BWP) that comprises/includes the coreset with index zero. The second TCI state may indicate/include/comprise the second reference signal that is quasi co-located with the first reference signal,
a random-access procedure that is not initiated by a PDCCH order that triggers a contention-free random-access procedure,
a configured-grant based physical uplink shared channel (PUSCH) transmission in an radio resource control (RRC) inactive state; and
the cell switch command indicating the first TCI state.

The wireless device may determine the monitoring occasions for the PDCCH candidates of the Type0/0A/1A/2-PDCCH CSS set. The base station may determine the monitoring occasions for the PDCCH candidates of the Type0/0A/1A/2-PDCCH CSS set.

Based on the search space identifier of the search space set being set to zero, the wireless device may not monitor PDCCH candidates of the search space set in/at second monitoring occasions different from the monitoring occasions associated with the first reference signal. Based on the search space identifier of the search space set being set to zero, the base station may not transmit, via the coreset associated with the search space set, PDCCH transmissions (e.g., DCI formats) in/at second monitoring occasions different from the monitoring occasions associated with the first reference signal.

The wireless device may monitor the PDCCH candidates is for detecting/receiving DCI formats with CRC scrambled with the C-RNTI. The base station may transmit the DCI formats with CRC scrambled with the C-RNTI.

The wireless device may receive, e.g., from the base station, one or more second messages. The base station may transmit the one or more second messages. The one or more second messages may comprise one or more second configuration parameters. The one or more second configuration parameters may comprise a second search space identifier of a second search space set. The second search space identifier may be equal/set to a non-zero value.

The second search space set may be associated with a second coreset.

Based on the second search space identifier of the second search space set being set to the non-zero value, the wireless device may monitor PDCCH candidates of the second search space set in/at second monitoring occasions determined based on search space configuration parameters (e.g., monitoringSlotPeriodicityAndOffset, monitoringSymbolsWithinSlot, duration, and the like) of the second search space set. Based on the second search space identifier of the second search space set being set to the non-zero value, the base station may transmit, via the second coreset of the second search space set, PDCCH transmissions (e.g., DCI formats) in/at the second monitoring occasions determined based on the search space configuration parameters (e.g., monitoringSlotPeriodicityAndOffset, monitoringSymbolsWithinSlot, duration, and the like) of the second search space set.

The one or more second configuration parameters may be, for example, one or more second PDCCH common configuration parameters (e.g., PDCCH-ConfigCommon). The second search space set may be, for example, a Type0/0A/1A/2-PDCCH CSS set. The second search space set may be, for example, a Type0/0B-PDCCH CSS set.

For a CORESET other than a CORESET with index 0,
if a wireless device not configured with a higher layer parameter di-OrJointTCI-StateList has not been provided/configured/indicated a configuration of TCI state(s) by a higher layer parameter tci-StatesPDCCH-ToAddList and a higher layer parameter tci-StatesPDCCH-ToReleaseList for the CORESET, or
if a wireless device configured with a higher layer parameter di-OrJointTCI-StateList has not been provided/indicated/configured a configuration of TCI state(s) by a higher layer parameter tci-StatesPDCCH-ToAddList and a higher layer parameter tci-StatesPDCCH-ToReleaseList for the CORESET associated at least with CSS sets other than Type3-PDCCH CSS sets and not been provided/indicated/configured a higher layer parameter followUnifiedTCI-State for the CORESET or has been provided/indicated/configured a higher layer parameter apply-IndicatedTCIState=‘none’ for the CORESET, or
if a wireless device has been provided/indicated/configured an initial configuration of more than one TCI states for the CORESET by a higher layer parameter tci-StatesPDCCH-ToAddList and a higher layer parameter tci-StatesPDCCH-ToReleaseList and has not received a MAC CE activation command for one of the more than one TCI states,
the wireless device may assume that a DM-RS antenna port associated with PDCCH receptions in/via the CORESET is quasi co-located with an SS/PBCH block the wireless device identified during an initial access procedure, or for a most recent configured grant PUSCH transmission in an RRC inactive state.

For a CORESET other than a CORESET with index 0,
if a base station does not provide/configure/transmit/indicate, to a wireless device, a higher layer parameter di-OrJointTCI-StateList and does not provide/configure/indicate/transmit a configuration of TCI state(s) by a higher layer parameter tci-StatesPDCCH-ToAddList and a higher layer parameter tci-StatesPDCCH-ToReleaseList for the CORESET, or
if a base station provides/configures/transmits/indicates, to a wireless device, a higher layer parameter di-OrJointTCI-StateList and does not provide/indicate/configure/transmit a configuration of TCI state(s) by a higher layer parameter tci-StatesPDCCH-ToAddList and a higher layer parameter tci-StatesPDCCH-ToReleaseList for the CORESET associated at least with CSS sets other than Type3-PDCCH CSS sets and does not provide/indicate/configure/transmit a higher layer parameter followUnifiedTCI-State for the CORESET or provides/indicates/configures/transmits a higher layer parameter apply-IndicatedTCIState=‘none’ for the CORESET, or
if a base station provides/configures/transmits/indicates, to a wireless device, an initial configuration of more than one TCI states for the CORESET by a higher layer parameter tci-StatesPDCCH-ToAddList and a higher layer parameter tci-StatesPDCCH-ToReleaseList and has not transmitted a MAC CE activation command for one of the more than one TCI states,
the base station may assume that a DM-RS antenna port associated with PDCCH transmissions in/via the CORESET is quasi co-located with an SS/PBCH block the wireless device identified during an initial access procedure, or for a most recent configured grant PUSCH transmission in an RRC inactive state.

In an example, the one or more configuration parameters may indicate at least two TAGs for the cell. The at least two TAGs may comprise a first TAG and a second TAG.

The one or more configuration parameters may comprise a first tag identifier/index parameter (e.g., tag-Id) indicating/identifying the first TAG of/for the cell. The one or more configuration parameters may comprise a second tag identifier/index parameter (e.g., tag2-Id) indicating/identifying the second TAG of/for the cell.

The at least two TAGs may be associated with the at least two TCI states. Each TAG of the at least two TAGs may be associated with a respective TCI state of the at least two TCI states.

For example, the first TAG of the at least two TAGs may be associated with the first TCI state of the at least two TCI states. The one or more configuration parameters may indicate, for the first TCI state, a first TAG identifier pointer (e.g., tag-Id-ptr) with a first value (e.g., 0) indicating the first TAG.

The second TAG of the at least two TAGs may be associated with the second TCI state of the at least two TCI states. The one or more configuration parameters may indicate, for the second TCI state, a second TAG identifier pointer (e.g., tag-Id-ptr) with a second value (e.g., 1) indicating the second TAG.

The first TAG of the at least two TAGs may be associated with a first timing advance value (or a first timing advance). The wireless device may determine/calculate/compute the first timing advance value, for example, based on receiving a first timing advance command (e.g., in a random-access response or in an absolute timing advance command MAC CE or in a timing advance command MAC CE). The wireless device may receive a first control command (e.g., a random-access response or an absolute timing advance command MAC CE or a timing advance command MAC CE) comprising/indicating the first timing advance command.

For example, the first control command may comprise a field indicating the first TAG. The first TAG of the at least two TAGs may be associated with the first timing advance value, for example, in response to calculating/computing the first timing advance value based on the first control command indicating the first TAG. The field may comprise, for example, the first TAG index indicating/identifying the first TAG. The field may comprise, for example, a first TAG index pointer indicating the first TAG.

The wireless device may maintain/adjust the first timing advance value for the first TAG. The wireless device may maintain/adjust the first timing advance value for the cell in (or associated with) the first TAG. The wireless device may apply/use the first timing advance value to/for first uplink transmissions (e.g., PUSCH/PUCC/SRS transmissions) via the cell in the first TAG. The wireless device may apply/use the first timing advance value of the first TAG to/for the first uplink transmissions associated with the first TCI state. The wireless device may adjust, based on the first timing advance value of the first TAG, uplink timings of the first uplink transmissions. The wireless device may apply/use the first timing advance value to/for the first uplink transmissions, for example, after the application time of the at least two TCI states. The wireless device may apply/use the first timing advance value to/for the first uplink transmissions, for example, starting from the application time of the at least two TCI states. The wireless device may perform/transmit, based on the first TAG, the first uplink transmissions associated with the first TCI state. The wireless device may perform/transmit, based on the first TAG, the first uplink transmissions associated with the first TCI state, for example, in response to the first TCI state being associated with the first TAG. The wireless device may perform/transmit, based on the first TAG, the first uplink transmissions associated with the first TCI state, for example, in response to the first TAG identifier pointer of the first TCI state indicating the first TAG.

Performing/transmitting the first uplink transmissions associated with the first TCI state based on the first TAG may comprise, for example, applying/using the first timing advance value of the first TAG to/for the first uplink transmissions associated with the first TCI state. Performing/transmitting the first uplink transmissions associated with the first TCI state based on the first TAG may comprise, for example, adjusting, based on the first timing advance value of the first TAG, uplink timings of the first uplink transmissions associated with the first TCI state. Performing/transmitting the first uplink transmissions associated with the first TCI state based on the first TAG may comprise, for example, transmitting, based on the first timing advance value of the first TAG, the first uplink transmissions associated with the first TCI state. The wireless device may determine, based on the first timing advance value of the first TAG, transmission timings of the first uplink transmissions associated with the first TCI state. For example, the wireless device may transmit a first uplink transmission of the first uplink transmissions in/at a first time determined based on the first timing advance value associated with the first TAG.

The second TAG of the at least two TAGs may be associated with a second timing advance value (or a second timing advance). The wireless device may determine/calculate/compute the second timing advance value, for example, based on receiving a second timing advance command (e.g., in a random-access response or in an absolute timing advance command MAC CE or in a timing advance command MAC CE). The wireless device may receive a second control command (e.g., a random-access response or an absolute timing advance command MAC CE or a timing advance command MAC CE) comprising/indicating the second timing advance command.

For example, the second control command may comprise a field indicating the second TAG. The second TAG of the at least two TAGs may be associated with the second timing advance value, for example, in response to calculating/computing the second timing advance value based on the second control command indicating the second TAG. The field may comprise, for example, the second TAG index indicating/identifying the second TAG. The field may comprise, for example, a second TAG index pointer indicating the second TAG.

The wireless device may maintain/adjust the second timing advance value for the second TAG. The wireless device may maintain/adjust the second timing advance value for the cell in (or associated with) the second TAG. The wireless device may apply/use the second timing advance value to/for second uplink transmissions (e.g., PUSCH/PUCC/SRS transmissions) via the cell in the second TAG. The wireless device may apply/use the second timing advance value of the second TAG to/for the second uplink transmissions associated with the second TCI state. The wireless device may adjust, based on the second timing advance value of the second TAG, uplink timings of the second uplink transmissions. The wireless device may apply/use the second timing advance value to/for the second uplink transmissions, for example, after the application time of the at least two TCI states. The wireless device may apply/use the second timing advance value to/for the second uplink transmissions, for example, starting from the application time of the at least two TCI states. The wireless device may perform/transmit, based on (or using) the second TAG, the second uplink transmissions associated with the second TCI state. The wireless device may perform/transmit, based on the second TAG, the second uplink transmissions associated with the second TCI state, for example, in response to the second TCI state being associated with the second TAG. The wireless device may perform/transmit, based on the second TAG, the second uplink transmissions associated with the second TCI state, for example, in response to the second TAG identifier pointer of the second TCI state indicating the second TAG.

Performing/transmitting the second uplink transmissions associated with the second TCI state based on the second TAG may comprise, for example, applying/using the second timing advance value of the second TAG to/for the second uplink transmissions associated with the second TCI state. Performing/transmitting the second uplink transmissions associated with the second TCI state based on the second TAG may comprise, for example, adjusting, based on the second timing advance value of the second TAG, uplink timings of the second uplink transmissions associated with the second TCI state. Performing/transmitting the second uplink transmissions associated with the second TCI state based on the second TAG may comprise, for example, transmitting, based on the second timing advance value of the second TAG, the second uplink transmissions associated with the second TCI state. The wireless device may determine, based on the second timing advance value of the second TAG, transmission timings of the second uplink transmissions associated with the second TCI state. For example, the wireless device may transmit a second uplink transmission of the second uplink transmissions in/at a second time determined based on the second timing advance value associated with the second TAG.

The wireless device may transmit, via the cell, a PUSCH transmission (e.g., PUSCH transmission in FIG. 20).

The wireless device may transmit, via the cell, the PUSCH transmission, for example, for/during an SDT procedure. The wireless device may transmit, via the cell, the PUSCH transmission, for example, in an RRC inactive state. The PUSCH transmission may be, for example, a most recent configured grant PUSCH transmission in an RRC inactive state. The PUSCH transmission may be, for example, the most recent configured grant PUSCH transmission in the RRC inactive state during the SDT procedure.

The wireless device may transmit, via the cell, the PUSCH transmission, for example, for/during a random-access procedure.

The PUSCH transmission may be, for example, a Msg3 PUSCH transmission of the random-access procedure. The random-access procedure may be, for example, a four-step random-access procedure.

The PUSCH transmission may be, for example, a MsgA PUSCH transmission of the random-access procedure. The random-access procedure may be, for example, a two-step random-access procedure.

The random-access procedure may be, for example, for an initial access procedure. The wireless device may transmit, via the cell, the PUSCH transmission during/in/within the initial access procedure. The wireless device may initiate the random-access procedure for the initial access procedure.

The random-access procedure may be, for example, for a reconfiguration-with-synch procedure (e.g., handover). The wireless device may transmit, via the cell, the PUSCH transmission during/in/within the reconfiguration-with-synch procedure. The wireless device may initiate the random-access procedure for the reconfiguration-with-synch procedure.

The wireless device may transmit the PUSCH transmission, for example, before (or prior to) receiving the one or more messages comprising the one or more configuration parameters.

The wireless device may transmit, for the random-access procedure, a random-access preamble (e.g., a PRACH transmission). The wireless device may receive a random-access response, for example, based on (or after) transmitting the random-access preamble. The wireless device may receive the random-access response corresponding to the random-access preamble. The random-access response may comprise a timing advance command. The random-access response may comprise an uplink grant (e.g., RAR uplink grant) scheduling the PUSCH transmission. The random-access response may comprise the uplink grant (e.g., RAR uplink grant) scheduling the PUSCH transmission during/for the random-access procedure.

The wireless device may transmit/perform the PUSCH transmission based on (or using) the timing advance command. The wireless device may apply/use the timing advance command for the PUSCH transmission via the cell. The wireless device may adjust, based on the timing advance command, an uplink timing of the PUSCH transmission.

The wireless device may determine/calculate/compute a timing advance value, for example, based on the timing advance command. The wireless device may transmit/perform the PUSCH transmission based on (or using) the timing advance value. The wireless device may apply/use the timing advance value for the PUSCH transmission via the cell. The wireless device may adjust, based on the timing advance value, an uplink timing of the PUSCH transmission.

The wireless device may maintain/adjust the timing advance value for the first TAG. The wireless device may maintain/adjust the timing advance value for the cell in (or associated with) the first TAG. The wireless device may apply/use the timing advance value for the PUSCH transmission via the cell in the first TAG. The wireless device may adjust, based on the timing advance value of the first TAG, an uplink timing of the PUSCH transmission via the cell.

The wireless device may receive an absolute timing advance command MAC-CE, for example, after transmitting the PUSCH transmission (e.g., the MsgA PUSCH transmission). The wireless device may receive the absolute timing advance command MAC-CE in a MsgB, for example, based on transmitting the MsgA PUSCH transmission. The absolute timing advance command MAC-CE may comprise a timing advance command.

The timing advance command may comprise/indicate a timing advance index used to control the amount of timing adjustment (or time alignment). The timing advance command may comprise/indicate the timing advance index used to control the amount of timing adjustment (or time alignment), for example, for the first TAG of the at least two TAGS.

After receiving the one or more configuration parameters indicating the plurality of TCI states for the cell (e.g., by a higher layer parameter di-OrJoint-TCIStateList or by a higher layer parameter ul-TCI-StateList) and before the application time of the at least two TCI states from/among the plurality of TCI states, the wireless device may transmit, via the cell, uplink transmissions using the timing advance command.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may apply/use the timing advance command for the uplink transmissions via the cell.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may adjust uplink timings of the uplink transmissions using (or based on) the timing advance command.

After receiving the one or more configuration parameters indicating the plurality of TCI states for the cell (e.g., by a higher layer parameter di-OrJoint-TCIStateList or by a higher layer parameter ul-TCI-StateList) and before the application time of the at least two TCI states from/among the plurality of TCI states, the wireless device may transmit, via the cell, uplink transmissions using the timing advance command, for example, in response to the one or more configuration parameters indicating the at least two TAGs for the cell.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may apply/use the timing advance command to/for the uplink transmissions via the cell, for example, in response to the one or more configuration parameters indicating the at least two TAGs for the cell.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may adjust uplink timings of the uplink transmissions using (or based on) the timing advance command, for example, in response to the one or more configuration parameters indicating the at least two TAGs for the cell.

After receiving the one or more configuration parameters indicating the plurality of TCI states for the cell (e.g., by a higher layer parameter di-OrJoint-TCIStateList or by a higher layer parameter ul-TCI-StateList) and before the application time of the at least two TCI states from/among the plurality of TCI states, the wireless device may transmit, via the cell, uplink transmissions using the timing advance command in the random-access response or in the absolute timing advance command MAC-CE.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may apply/use the timing advance command, in the random-access response or in the absolute timing advance command MAC-CE, to/for the uplink transmissions via the cell.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may adjust uplink timings of the uplink transmissions using (or based on) the timing advance command in the random-access response or in the absolute timing advance command MAC-CE.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may transmit, via the cell, uplink transmissions using the timing advance value used/applied for/to the PUSCH transmission.

After receiving the one or more configuration parameters indicating the plurality of TCI states for the cell (e.g., by a higher layer parameter di-OrJoint-TCIStateList or by a higher layer parameter ul-TCI-StateList) and before the application time of the at least two TCI states from/among the plurality of TCI states, the wireless device may transmit, via the cell, uplink transmissions using the timing advance command used/applied for/to the PUSCH transmission.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may apply/use the timing advance command used/applied for/to the PUSCH transmission to/for the uplink transmissions via the cell.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may adjust uplink timings of the uplink transmissions using (or based on) the timing advance command used/applied for/to the PUSCH transmission.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may transmit, via the cell, uplink transmissions using the timing advance command (or the timing advance value) used/applied for/to the PUSCH transmission (or the most recent configured grant PUSCH transmission in the RRC inactive state).

After receiving the one or more configuration parameters indicating the plurality of TCI states for the cell (e.g., by a higher layer parameter di-OrJoint-TCIStateList or by a higher layer parameter ul-TCI-StateList) and before the application time of the at least two TCI states from/among the plurality of TCI states, the wireless device may apply/use the timing advance command (or the timing advance value) used/applied for/to the PUSCH transmission (or the most recent configured grant PUSCH transmission in the RRC inactive state) to/for the uplink transmissions via the cell.

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may adjust uplink timings of the uplink transmissions using (or based on) the timing advance command (or the timing advance value) used/applied for/to the PUSCH transmission (or the most recent configured grant PUSCH transmission in the RRC inactive state).

The wireless device may determine, using the timing advance command, a timing adjustment (or a time alignment) for the uplink transmissions via the cell.

The uplink transmissions may comprise, for example, PUSCH transmissions scheduled/activated by a DCI (e.g., dynamic-grant PUSCH transmissions).

The uplink transmissions may comprise, for example, PUSCH transmissions for a configured uplink grant (e.g., Type 1 configured uplink grant, Type 2 configured uplink grant).

The uplink transmissions may comprise, for example, PUCCH transmissions.

The uplink transmissions may comprise, for example, SRS transmissions applying the first (indicated) TCI state. In an example, the one or more configuration parameters may comprise, for an SRS resource set, a higher layer parameter followUnifiedTCI-StateSRS indicating to apply the first TCI state to SRS transmissions of the SRS resource set (or via an SRS resource of the SRS resource set).

The uplink transmissions may comprise, for example, SRS transmissions applying one of the at least two (indicated) TCI states. In an example, the one or more configuration parameters may comprise, for an SRS resource set, a higher layer parameter applyIndicatedTCIState indicating to apply the first TCI state or the second TCI state to SRS transmissions of the SRS resource set (or via an SRS resource of the SRS resource set).

The uplink transmissions may not comprise, for example, SRS transmissions not applying the first (indicated) TCI state or the second (indicated) TCI state. For example, the uplink transmissions may not comprise SRS transmissions for/of a periodic or a semi-persistent SRS resource set with a higher layer parameter usage set to ‘beamManagement’

For example, the uplink transmissions may not comprise SRS transmissions for/of a periodic, or a semi-persistent, or an aperiodic SRS resource set with a higher layer parameter usage set to ‘codebook’, ‘nonCodebook’ or ‘antennaSwitching’ and not configured/provided/indicated with the higher layer parameter followUnifiedTCI-StateSRS or the higher layer parameter applyIndicatedTCIState.

The wireless device may transmit the PUSCH transmission with/using a spatial domain transmission filter (or an uplink transmission filter/beam or a spatial filter, and the like).

After receiving the one or more configuration parameters indicating the plurality of TCI states for the cell (e.g., by a higher layer parameter dl-OrJoint-TCIStateList or by a higher layer parameter ul-TCI-StateList) and before the application time of the at least two TCI states from/among the plurality of TCI states, the wireless device may transmit, via the cell, the uplink transmissions with/using the spatial domain transmission filter of the PUSCH transmission.

After receiving the one or more configuration parameters indicating the plurality of TCI states for the cell (e.g., by a higher layer parameter di-OrJoint-TCIStateList or by a higher layer parameter ul-TCI-StateList) and before the application time of the at least two TCI states from/among the plurality of TCI states, the wireless device may transmit, via the cell, the uplink transmissions with/using a spatial domain transmission filter that is the same as the spatial domain transmission filter used to transmit the PUSCH transmission.

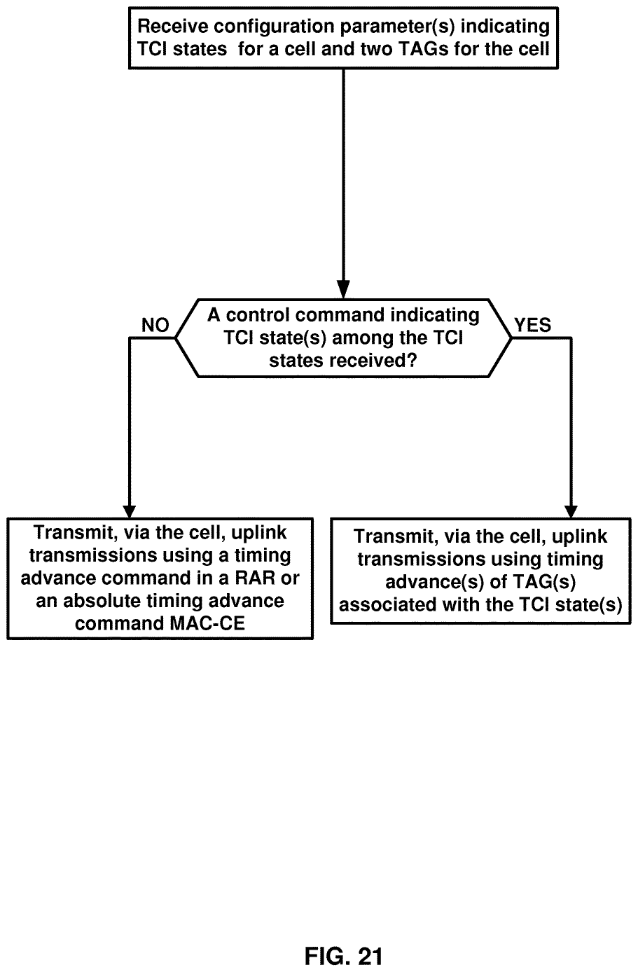

FIG. 21 illustrates an example flow chart of timing advance as per an aspect of an embodiment of the present disclosure.

A wireless device may receive, from a base station, one or more messages comprising one or more configuration parameters of/for a cell. The base station may transmit the one or more messages.

The one or more configuration parameters may indicate a plurality of transmission configuration indication (TCI) states for the cell.

The one or more configuration parameters may indicate at least two timing advance groups (TAGs) for the cell. The at least two TAGs may comprise a first TAG and a second TAG.

The wireless device may receive a control command/message (e.g., MAC-CE, DCI) indicating one or more TCI states from/among/of the plurality of TCI states for the cell. The base station may transmit the control command/message.

In an example, the one or more TCI states may be a first TCI state. The first TCI state may be associated with the first TAG (e.g., by a higher layer parameter tag-Id-ptr).

In an example, the one or more TCI states may be at least two TCI states comprising a first TCI state and a second TCI state. The first TCI state may be associated with the first TAG (e.g., by a higher layer parameter tag-Id-ptr). The second TCI state may be associated with the second TAG (e.g., by a higher layer parameter tag-Id-ptr).

After receiving the one or more configuration parameters indicating the plurality of TCI states and before an application of the one or more TCI states (or an application time of the one or more TCI states), the wireless device may transmit, via the cell, uplink transmissions using a timing advance command (or a timing advance value). After transmitting the one or more configuration parameters indicating the plurality of TCI states and before an application of the one or more TCI states (or an application time of the one or more TCI states), the base station may receive, via the cell and from the wireless device, the uplink transmissions.

The wireless device may transmit, via the cell, a PUSCH transmission. The wireless device may transmit, via the cell, the PUSCH transmission with/using a spatial domain transmission filter. The wireless device may transmit, via the cell, the uplink transmissions with/using a spatial domain transmission filter that is the same as the spatial domain transmission filter of the PUSCH transmission. After receiving the one or more configuration parameters indicating the plurality of TCI states and before an application of the one or more TCI states (or an application time of the one or more TCI states), the wireless device may transmit, via the cell, the uplink transmission with/using a spatial domain transmission filter that is the same as the spatial domain transmission filter of the PUSCH transmission.

The base station may receive, via the cell, the PUSCH transmission with/using a spatial domain reception/receiving filter. The base station may receive, via the cell, the uplink transmissions with/using a spatial domain reception/receiving filter that is the same as the spatial domain reception/receiving filter used to receive the PUSCH transmission by the wireless device.

In an example, the wireless device may receive a random-access response for/during a random-access procedure. The base station may transmit the random-access response. The random-access response may comprise the timing advance command. The random-access response may comprise an uplink grant (e.g., RAR uplink grant) scheduling the PUSCH transmission for/during the random-access procedure. In an example, the wireless device may apply/use a first TAG to the PUSCH transmission. For example, the at least two TAGs may comprise the first TAG.

After receiving the one or more configuration parameters indicating the plurality of TCI states and before an application of the one or more TCI states (or an application time of the one or more TCI states), the wireless device may transmit, via the cell, the uplink transmissions using the timing advance command (or the timing advance value) in the random-access response.

After receiving the one or more configuration parameters indicating the plurality of TCI states and before an application of the one or more TCI states (or an application time of the one or more TCI states), the wireless device may transmit, via the cell, the uplink transmissions using the timing advance command (or the timing advance value) used/applied for/to in the PUSCH transmission scheduled by the uplink grant (e.g., RAR uplink grant). After receiving the one or more configuration parameters indicating the plurality of TCI states and before an application of the one or more TCI states (or an application time of the one or more TCI states), the wireless device may determine timing adjustment for the uplink transmissions using the timing advance command (or the timing advance value or the first TAG) of the PUSCH transmission scheduled by the uplink grant (e.g., RAR uplink grant).

In an example, the PUSCH transmission may be a message A (MsgA) PUSCH transmission of a random-access procedure. The wireless device may receive an absolute timing advance command MAC-CE in a message B (MsgB). The base station may transmit the absolute timing advance command MAC-CE. The wireless device may receive the absolute timing advance command MAC-CE in the MsgB, for example, based on transmitting the MsgA PUSCH transmission for/of the random-access procedure. The base station may transmit the absolute timing advance command MAC-CE in the MsgB, for example, based on receiving the MsgA PUSCH transmission The absolute timing advance command MAC-CE may comprise the timing advance command.

After receiving the one or more configuration parameters indicating the plurality of TCI states and before an application of the one or more TCI states (or an application time of the one or more TCI states), the wireless device may transmit, via the cell, the uplink transmissions using the timing advance command (or the timing advance value) in the absolute timing advance command MAC-CE. After receiving the one or more configuration parameters indicating the plurality of TCI states and before an application of the one or more TCI states (or an application time of the one or more TCI states), the wireless device may determine timing adjustment for the uplink transmissions using the timing advance command (or the timing advance value) in the absolute timing advance command MAC-CE.

The random-access procedure may be (or initiated by the wireless device), for example, for an initial access procedure. The random-access procedure may be (or initiated by the wireless device), for example, for a reconfiguration with synchronization (e.g., handover) procedure.

In an example, the PUSCH transmission may be the most recent configured grant PUSCH transmission in an RRC inactive state. The PUSCH transmission may be the most recent configured grant PUSCH transmission for an SDT procedure in the RRC inactive state. The wireless device may receive an activation command (e.g., RAR, absolute timing advance command MAC-CE, Timing Advance Command MAC CE) indicating the timing advance command. In an example, the wireless device may apply/use a first TAG to the most recent configured grant PUSCH transmission. The wireless device may transmit the most recent configured grant PUSCH transmission, for example, based on (or using) the timing advance value of the first TAG. For example, the at least two TAGs may comprise the first TAG.

After receiving the one or more configuration parameters indicating the plurality of TCI states and before an application of the one or more TCI states (or an application time of the one or more TCI states), the wireless device may transmit, via the cell, the uplink transmissions using the timing advance command (or the timing advance value) used/applied for/to in the most recent configured grant PUSCH transmission in the RRC inactive state.

After receiving the one or more configuration parameters indicating the plurality of TCI states and before an application of the one or more TCI states (or an application time of the one or more TCI states), the wireless device may transmit, via the cell, the uplink transmissions using the first TAG used/applied for/to in the most recent configured grant PUSCH transmission in the RRC inactive state.

After receiving the one or more configuration parameters indicating the plurality of TCI states and before an application of the one or more TCI states (or an application time of the one or more TCI states), the wireless device may determine timing adjustment for the uplink transmissions using the timing advance command (or the timing advance value or the first TAG) of the most recent configured grant PUSCH transmission in the RRC inactive state.

The wireless device may determine/calculate/compute the timing advance value, for example, based on (or using) the timing advance command.

The timing advance command may comprise/indicate a timing advance index value used to control the amount of timing adjustment (or time alignment), for example, for the first TAG.

The wireless device may transmit, via the cell, the uplink transmissions using the timing advance command, for example, based on the one or more configuration parameters indicating the at least two TAGs for the cell.

The wireless device may determine, using the timing advance command, a timing adjustment (or a time alignment) for the uplink transmissions.

The uplink transmissions may comprise, for example, dynamic-grant physical uplink shared channel (PUSCH) transmissions. The uplink transmissions may comprise, for example, configured-grant PUSCH transmissions. The uplink transmissions may comprise, for example, physical uplink control channel (PUCCH) transmissions. The uplink transmissions may comprise, for example, SRS transmissions applying the (indicated) one or more TCI states (or at least one of the one or more TCI states).

In an example, after the application of the one or more TCI states (or the application time of the one or more TCI states), the wireless device may transmit, via the cell, uplink transmissions using at least two timing advance values of the at least two TAGs associated with the one or more TCI states. For example, after the application of the one or more TCI states (or the application time of the one or more TCI states), the wireless device may transmit, via the cell, first uplink transmissions using a first timing advance value of the first TAG associated with the first TCI state. The wireless device may receive, via the cell, second uplink transmissions using a second timing advance value of the second TAG associated with the second TCI state.

After a wireless device receives, from a base station, an initial higher layer configuration of a higher layer parameter di-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State):
The wireless device may assume that an uplink transmission (UL TX) spatial filter, for dynamic-grant PUSCH, configured-grant based PUSCH, PUCCH and SRS applying the indicated TCI state, is the same as that for a PUSCH transmission scheduled by a RAR uplink grant or for a MsgA PUSCH transmission during an initial access procedure or during a random-access procedure initiated by a reconfiguration with sync procedure. If the wireless device is configured with two TAGs for the serving cell, the wireless device may determine timing adjustment (or time alignment), for the dynamic-grant PUSCH, configured-grant based PUSCH, PUCCH and SRS applying the indicated TCI state, using a timing advance command in the RAR uplink grant or in an absolute timing advance command MAC CE.

After a wireless device receives, from a base station, an initial higher layer configuration of a higher layer parameter dl-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State):
The wireless device may transmit uplink transmissions (e.g., dynamic-grant PUSCH, configured-grant based PUSCH, PUCCH and SRS applying the indicated TCI state) with/using an uplink transmission (UL TX) spatial filter that is the same as that for a PUSCH transmission scheduled by a RAR uplink grant or for a MsgA PUSCH transmission during an initial access procedure or during a random-access procedure initiated by a reconfiguration with sync procedure. If the wireless device is configured with two TAGs for the serving cell, the wireless device may determine timing adjustment (or time alignment), for the uplink transmissions, using a timing advance command in the RAR uplink grant or in an absolute timing advance command MAC CE.

After a wireless device receives, from a base station, an initial higher layer configuration of a higher layer parameter dl-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State):
The wireless device may transmit uplink transmissions (e.g., dynamic-grant PUSCH, configured-grant based PUSCH, PUCCH and SRS applying the indicated TCI state) with/using an uplink transmission (UL TX) spatial filter that is the same as that for a PUSCH transmission scheduled by a RAR uplink grant or for a MsgA PUSCH transmission during a random-access procedure (e.g., during/for an initial access procedure or a reconfiguration with sync procedure) or for a most recent configured grant PUSCH transmission in an RRC inactive state. If the wireless device is configured with two TAGs for the serving cell, the wireless device may determine timing adjustment (or time alignment), for the uplink transmissions, using a timing advance command in the RAR uplink grant or in an absolute timing advance command MAC CE, or a timing advance command (or TAG) used/applied for/to the most recent configured grant PUSCH transmission in the RRC inactive state.

After a wireless device receives, from a base station, an initial higher layer configuration of a higher layer parameter dl-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State):
The wireless device may transmit uplink transmissions (e.g., dynamic-grant PUSCH, configured-grant based PUSCH, PUCCH and SRS applying the indicated TCI state) with/using an uplink transmission (UL TX) spatial filter that is the same as that for:
a PUSCH transmission scheduled by an RAR uplink grant during a random-access procedure (e.g., during/for an initial access procedure or a reconfiguration with sync procedure), or
a MsgA PUSCH transmission during a random-access procedure (e.g., during/for an initial access procedure or a reconfiguration with sync procedure), or
a most recent configured grant PUSCH transmission in an RRC inactive state.
If the wireless device is configured with two TAGs for the serving cell, the wireless device may determine timing adjustment (or time alignment), for the uplink transmissions, using:
a timing advance command in the RAR uplink grant, or
a timing advance command in an absolute timing advance command MAC CE, or
a timing advance command (or a TAG) used/applied for/to the most recent configured grant PUSCH transmission in the RRC inactive state.

After a wireless device receives, from a base station, an initial higher layer configuration of a higher layer parameter dl-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State), for determining timing adjustment for uplink transmissions (e.g., dynamic-grant PUSCH, configured-grant based PUSCH, PUCCH and SRS applying the indicated TCI state), same TAG as that for a PUSCH transmission scheduled by a RAR uplink grant during the initial access procedure (or during random access procedure initiated by the Reconfiguration with sync procedure) may be applied by the wireless device.

After a wireless device receives, from a base station, an initial higher layer configuration of a higher layer parameter di-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State), for determining timing adjustment for uplink transmissions (e.g., dynamic-grant PUSCH, configured-grant based PUSCH, PUCCH and SRS applying the indicated TCI state), same timing advance (or same timing advance value) as that for a PUSCH transmission scheduled by a RAR uplink grant during the initial access procedure (or during random access procedure initiated by the Reconfiguration with sync procedure) may be applied by the wireless device.

After a wireless device receives, from a base station, an initial higher layer configuration of a higher layer parameter dl-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State), for determining timing adjustment for uplink transmissions (e.g., dynamic-grant PUSCH, configured-grant based PUSCH, PUCCH and SRS applying the indicated TCI state), same TAG as that for the most recent configured grant PUSCH transmission in the RRC inactive state may be applied by the wireless device.

After a wireless device receives, from a base station, an initial higher layer configuration of a higher layer parameter dl-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State), for determining timing adjustment for uplink transmissions (e.g., dynamic-grant PUSCH, configured-grant based PUSCH, PUCCH and SRS applying the indicated TCI state), same timing advance (or same timing advance value) as that for the most recent configured grant PUSCH transmission in the RRC inactive state may be applied by the wireless device.

After a wireless device receives, from a base station, an initial higher layer configuration of a higher layer parameter dl-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State), for determining timing adjustment for uplink transmissions (e.g., dynamic-grant PUSCH, configured-grant based PUSCH, PUCCH and SRS applying the indicated TCI state), same TAG as that for a PUCCH transmission for an absolute timing advance command MAC CE during the initial access procedure (or during random access procedure initiated by the Reconfiguration with sync procedure) may be applied by the wireless device.

After a wireless device receives, from a base station, an initial higher layer configuration of a higher layer parameter dl-OrJointTCI-StateList with more than one TCI-State or a higher layer parameter ul-TCI-StateList with more than one TCI-UL-State for a serving cell and before application of an indicated TCI state from the configured TCI states (or from the more than one TCI-State or the more than one TCI-UL-State), for determining timing adjustment for uplink transmissions (e.g., dynamic-grant PUSCH, configured-grant based PUSCH, PUCCH and SRS applying the indicated TCI state), a timing advance (or a timing advance value) indicated by an absolute timing advance command MAC CE during the initial access procedure (or during random access procedure initiated by the Reconfiguration with sync procedure) may be applied by the wireless device.

What is claimed is:

1. A wireless device comprising:
one or more processors; and
memory storing instructions that, when executed by the one or more processors, cause the wireless device to:
monitor physical downlink control channel (PDCCH) candidates, of a search space set with a search space identifier set to zero, at monitoring occasions associated with a first reference signal, wherein:
the first reference signal is determined based on a downlink control information (DCI) indicating a transmission configuration indication (TCI) state for a control resource set (coreset) with index zero; and
the TCI state indicates a second reference signal that is quasi co-located with the first reference signal.

2. The wireless device of claim 1, wherein the instructions further cause the wireless device to monitor the PDCCH candidates based on the search space identifier being set to zero.

3. The wireless device of claim 1, wherein the TCI state is a TCI state of an active bandwidth part (BWP) comprising the coreset with index zero.

4. The wireless device of claim 1, wherein the instructions further cause the wireless device to receive one or more messages comprising one or more configuration parameters, wherein the one or more configuration parameters comprise the search space identifier.

5. The wireless device of claim 1, wherein:
the wireless device has a cell radio network temporary identifier (C-RNTI); and
the instructions further cause the wireless device to monitor the PDCCH candidates to detect DCI formats with a cyclic redundancy check (CRC) scrambled with the C-RNTI.

6. The wireless device of claim 1, wherein the first reference signal is a synchronization signal physical broadcast channel (SS/PBCH) block.

7. The wireless device of claim 1, wherein the second reference signal is a channel state information reference signal (CSI-RS).

8. A method comprising:
monitoring, by a wireless device, physical downlink control channel (PDCCH) candidates, of a search space set with a search space identifier set to zero, at monitoring occasions associated with a first reference signal, wherein:
the first reference signal is determined based on a downlink control information (DCI) indicating a transmission configuration indication (TCI) state for a control resource set (coreset) with index zero; and
the TCI state indicates a second reference signal that is quasi co-located with the first reference signal.

9. The method of claim 8, wherein the monitoring is based on the search space identifier being set to zero.

10. The method of claim 8, wherein the TCI state is a TCI state of an active bandwidth part (BWP) comprising the coreset with index zero.

11. The method of claim 8, further comprising receiving one or more messages comprising one or more configuration parameters, wherein the one or more configuration parameters comprise the search space identifier.

12. The method of claim 8, wherein:
the wireless device has a cell radio network temporary identifier (C-RNTI); and
the monitoring the PDCCH candidates is to detect DCI formats with a cyclic redundancy check (CRC) scrambled with the C-RNTI.

13. The method of claim 8, wherein the first reference signal is a synchronization signal physical broadcast channel (SS/PBCH) block.

14. The method of claim 8, wherein the second reference signal is a channel state information reference signal (CSI-RS).

15. A non-transitory computer-readable medium comprising instructions that, when executed by one or more processors of a wireless device, cause the wireless device to:
monitor physical downlink control channel (PDCCH) candidates, of a search space set with a search space identifier set to zero, at monitoring occasions associated with a first reference signal, wherein:
the first reference signal is determined based on a downlink control information (DCI) indicating a transmission configuration indication (TCI) state for a control resource set (coreset) with index zero; and
the TCI state indicates a second reference signal that is quasi co-located with the first reference signal.

16. The non-transitory computer-readable medium of claim 15, wherein the instructions further cause the wireless device to monitor the PDCCH candidates based on the search space identifier being set to zero.

17. The non-transitory computer-readable medium of claim 15, wherein the TCI state is a TCI state of an active bandwidth part (BWP) comprising the coreset with index zero.

18. The non-transitory computer-readable medium of claim 15, wherein the instructions further cause the wireless device to receive one or more messages comprising one or more configuration parameters, wherein the one or more configuration parameters comprise the search space identifier.

19. The non-transitory computer-readable medium of claim 15, wherein:
the wireless device has a cell radio network temporary identifier (C-RNTI); and
the instructions further cause the wireless device to monitor the PDCCH candidates to detect DCI formats with a cyclic redundancy check (CRC) scrambled with the C-RNTI.

20. The non-transitory computer-readable medium of claim 15, wherein the first reference signal is a synchronization signal physical broadcast channel (SS/PBCH) block.
